(19) United States
(12) Patent Application Publication
(10) Pub. No.: US 2018/0219423 A1
(43) Pub. Date: Aug. 2, 2018

(54) METHOD AND SYSTEM FOR WIRELESS AND SINGLE CONDUCTOR POWER TRANSMISSION

(71) Applicant: The Governors of the University of Alberta, Edmonton (CA)

(72) Inventors: Adam Mitchell Maunder, Edmonton (CA); Telnaz Zarifidizaji, Edmonton (CA); Pedram Mousavi, Edmonton (CA)

(21) Appl. No.: 15/745,692

(22) PCT Filed: Jul. 18, 2016
(86) PCT No.: PCT/CA2016/050842

§ 371 Date: Jan. 17, 2018

Related U.S. Application Data
(60) Provisional application No. 62/194,094, filed on Jul. 17, 2015.

(51) Int. Cl. H02J 50/12; H01F 38/14; H02J 50/50; G06K 19/07; H04B 5/00

(52) U.S. Cl. CPC H02J 50/12; H01F 38/14; H02J 50/50; H01F 27/24; H04B 5/0037; H04B 5/0062; H04B 5/0081; G06K 19/0723

(57) ABSTRACT

Methods, systems, and techniques for wireless and single-conductor power transfer. A single-ended resonator receives power from an alternating current power source and inductively transfers this power to a receiving coil, which may be double ended. A reactive tuning network may be coupled in series, parallel, or a hybrid series-parallel configuration to the resonator and used to tune the resonant frequency of the resonator. Additionally or alternatively, matching between the receiving coil and a load connected to the receiving coil may be done adaptively and in real-time in response to changes in operating conditions. An arbitrarily shaped conducting structure, such as an oil rig, a table, or a shelf, may be used for single ended power transfer to the resonator.

### TECHNICAL FIELD

The present disclosure is directed at methods, systems, and techniques for wireless and single conductor power transmission.

### BACKGROUND

Near field wireless transmission of electric power refers to transmitting power using inductive coupling. A power source outputs an alternating current, which is applied to a transmitting coil; the current in the coil generates a magnetic field. That magnetic field induces an electric current in a nearby receiving coil, and that induced electric current can be used to power a load. While wirelessly transmitting power in this manner can be useful and has some commercial applications, one problem faced when trying to practically deploy this technology is that transmission efficiency decreases significantly with the distance between the transmitting and receiving coils.

### SUMMARY

According to a first aspect, there is provided a system for wireless and single conductor power transmission, the system comprising a receive side single-ended resonator for receiving power from an alternating current power source via a single conductor, wherein the power source is operable to emit power at an operating frequency; a receive side resonator tuning network, the tuning network comprising at least one reactive lumped component connected in series with the receive side single-ended resonator or in parallel across two locations along the receive side single-ended resonator; and a receive side receiving coil for transferring power to a load, wherein the receive side receiving coil inductively is coupled to the receive side single-ended resonator when the power source is operating, the at least one reactive lumped component is selected such that the receive side single-ended resonator is substantially at resonance when inductively coupled to the receive side receiving coil at the operating frequency, and the receive side receiving coil is substantially at resonance when inductively coupled to the receive side single-ended resonator at the operating frequency.

The receive side single-ended resonator may comprise first and second ends and the system may further comprise the single conductor, the single conductor comprising a conducting structure electrically coupled to the receive side single-ended resonator via the first end.

The conducting structure may comprise a non-wire conducting structure.

The conducting structure may comprise a non-constant cross-section.

The first and second ends may be electrically connected in parallel to the conducting structure.

At least one reactive lumped component may comprise a first and a second capacitor, the first end of the receive side single-ended resonator may be electrically coupled to the conducting structure via the first capacitor, and the second end of the receive side single-ended resonator may be electrically coupled to the conducting structure via the second capacitor.

The second end may be floating.

One or more additional receive side single-ended resonators may each be electrically coupled to the conducting structure.

One or more additional receive side receiving coils may each be inductively coupled to the receive side single-ended resonator.

The system may further comprise the power source, wherein the power source comprises a floating ground terminal and a power output terminal electrically and physically coupled to the conducting structure.

The system may further comprise a transmit side single-ended resonator electrically coupled to the conducting structure; and a transmit side resonator tuning network comprising at least one reactive lumped component connected in series with the transmit side single-ended resonator or in parallel across two locations along the transmit side single-ended resonator, wherein the at least one reactive lumped component of the transmit side resonator tuning network is selected such that the transmit side single-ended resonator is substantially at resonance at the operating frequency, and wherein the power output terminal of the power source is physically coupled to the transmit side single-ended resonator.

The power output and ground terminals of the power source may be physically coupled to two locations on the transmit side single-ended resonator.

The system may further comprise a transmit side transmitting coil for receiving power from the power source; a transmit side single-ended resonator electrically coupled to the conducting structure, wherein the transmit side transmitting coil and single-ended resonator are inductively coupled when the power source is operating; and a transmit side resonator tuning network comprising at least one reactive lumped component connected in series with the transmit side single-ended resonator or in parallel across two locations along the transmit side single-ended resonator, wherein the at least one reactive lumped component of the transmit side resonator tuning network is selected such that the transmit side single-ended resonator is substantially at resonance at the operating frequency. The transmit side transmitting coil is substantially at resonance when inductively coupled to the transmit side single-ended resonator at the operating frequency.

The system may further comprise a transmit side transmitting coil tuning network electrically coupled to the transmit side transmitting coil to cause the transmit side transmitting coil to be substantially at resonance at the operating frequency of the power source.

The system may further comprise a transmit side matching network electrically coupled between the transmit side transmitting coil and the power source.

The system may further comprise a transmitter modulator electrically coupled to the transmit side transmitting coil, the transmitter modulator comprising a switch operable to modulate the power conducted to the transmit side transmitting coil from the power source.

The system may further comprise a receiver modulator electrically coupled to the receive side receiving coil, the receive modulation portion comprising a switch operable to modulate a signal transmitted to the transmit side transmitting coil via the receive side receiving coil.

The receive side single-ended resonator may comprise a helix with a resonant length approximately a quarter wavelength of the power source plus an integer multiple of a half wavelength.

The receive side single-ended resonator may have a diameter significantly less than one tenth of the wavelength of the power source.

The receive side single-ended resonator may comprise a helix wrapped around a core.

The core may comprise an air core.

The receive side transmitting coil may comprise a toroid.

The core may comprise a ferrite core.

The system may further comprise a receive side receiving coil tuning network electrically coupled to the receive side receiving coil to cause the receive side receiving coil to be substantially at resonance at the operating frequency of the power source.

The system may further comprise a receive side matching network electrically coupled between the receive side receiving coil and the load.

The receive side resonator tuning network may comprise a reactive component bank and the system may further comprise control circuitry configured to read a feedback parameter of the system; and in response to the feedback parameter, adjust the reactance of the reactive component bank such that the feedback parameter approaches a target value.

The transmit side resonator tuning network may comprise a reactive component bank and the system may further comprise control circuitry configured to read a feedback parameter of the system; and in response to the feedback parameter, adjust the reactance of the reactive component bank such that the feedback parameter approaches a target value.

The transmit side transmitting coil tuning network may comprise a reactive component bank and the system may further comprise control circuitry configured to read a feedback parameter of the system; and in response to the feedback parameter, adjust the reactance of the reactive component bank such that the feedback parameter approaches a target value.

The transmit side matching network may comprise a reactive component bank and the system may further comprise control circuitry configured to read a feedback parameter of the system; and in response to the feedback parameter, adjust the reactance of the reactive component bank such that the feedback parameter approaches a target value.

The receive side receiving coil tuning network may comprise a reactive component bank and the system may further comprise control circuitry configured to read a feedback parameter of the system; and in response to the feedback parameter, adjust the reactance of the reactive component bank such that the feedback parameter approaches a target value.

The receive side matching network may comprise a reactive component bank and the system may further comprise control circuitry configured to read a feedback parameter of the system; and in response to the feedback parameter, adjust the reactance of the reactive component bank such that the feedback parameter approaches a target value.

The control circuitry may comprise a processor and a computer readable medium communicatively coupled to the processor, wherein the computer readable medium has stored thereon computer program code that is executable by the processor and that, when executed by the processor, causes the processor to read the feedback parameter of the system; and in response to the feedback parameter, iteratively adjust the reactance of the reactive component bank such that the feedback parameter approaches a target value and until a stop condition is satisfied.

Iteratively adjusting the reactance of the reactive component bank may comprise, for each iteration creating a generation of genomes, wherein each of the genomes corresponds to a different reactance of the reactive component bank; and, for each of the genomes, adjusting the reactance of the reactive component bank to the reactance corresponding to the genome; and reading the feedback parameter corresponding to the reactance of the genome.

The feedback parameter may be selected from the group consisting of voltage measured across two nodes in the system, current measured through a node in the system, S-parameters of any component in the system, power delivered to any component in the system, signal-to-noise ratio, and bit error rate.

The reactive component bank may comprise multiple switches each of which is connected in series to a capacitor, and adjusting the reactance of the reactive component bank may comprise actuating the switches to different states.

The system may further comprise the load, wherein the load comprises an RFID tag.

According to another aspect, there is provided a method for wireless and single conductor power transmission, the method comprising receiving alternating current power via a single conductor at a receive side single-ended resonator, wherein the power oscillates at an operating frequency; inductively transferring the power from the receive side single-ended resonator to a receive side receiving coil, wherein inductive transfer of the power occurs when the receive side single-ended resonator and the receive side receiving coil are both substantially at resonance; and powering a load using the power transferred from the receive side single-ended resonator to the receive side receiving coil, wherein a receive side resonator tuning network comprising at least one reactive lumped component is connected in series with the receive side single-ended resonator or in parallel across two locations along the receive side single-ended resonator.

The receive side single-ended resonator may comprise first and second ends and the single conductor may comprise a conducting structure electrically coupled to the receive side single-ended resonator via the first end.

The conducting structure may comprise a non-wire conducting structure.

The conducting structure may comprise a non-constant cross-section.

The first and second ends may be electrically connected in parallel to the conducting structure.

The at least one reactive lumped component may comprise a first and a second capacitor, the first end of the receive side single-ended resonator may be electrically coupled to the conducting structure via the first capacitor, and the second end of the receive side single-ended resonator may be electrically coupled to the conducting structure via the second capacitor.

The second end may be floating.

Power may be received at one or more additional receive side single-ended resonators each electrically coupled to the conducting structure.

Power may be inductively transferred to one or more additional receive side receiving coils inductively coupled to the receive side single-ended resonator.

The power may be output by a power source that comprises a floating ground terminal and a power output terminal electrically and physically coupled to the conducting structure.

The method may further comprise transmitting the power to the conducting structure via a transmit side single-ended resonator electrically coupled to the conducting structure prior to the power being received by the receive side single-ended resonator, wherein a transmit side resonator tuning network comprising at least one reactive lumped component may be connected in series with the transmit side single-ended resonator or in parallel across two locations along the transmit side single-ended resonator, wherein the at least one reactive lumped component of the transmit side resonator tuning network may be selected such that the transmit side single-ended resonator is substantially at resonance at the operating frequency, and wherein the power output terminal of the power source may be physically coupled to the transmit side single-ended resonator.

The power output and ground terminals of the power source may be physically coupled to two locations on the transmit side single-ended resonator.

The method may further comprise receiving the power at a transmit side transmitting coil; and inductively transferring the power from the transmit side transmitting coil to a transmit side single-ended resonator electrically coupled to the conducting structure, wherein the transmit side transmitting coil and single-ended resonator are both substantially at resonance, and wherein a transmit side resonator tuning network comprising at least one reactive lumped component may be connected in series with the transmit side single-ended resonator or in parallel across two locations along the transmit side single-ended resonator.

A transmit side transmitting coil tuning network may be electrically coupled to the transmit side transmitting coil to cause the transmit side transmitting coil to be substantially at resonance at the operating frequency.

A transmit side matching network may be electrically coupled between the transmit side transmitting coil and a power source that outputs the power.

The method may further comprise transmitting data between the transmit side transmitting coil and the receive side receiving coil by modulating a signal at the transmit side transmitting coil and the receive side receiving coil.

The receive side single-ended resonator may comprise a helix with a resonant length approximately a quarter wavelength of the power source plus an integer multiple of a half wavelength.

The receive side single-ended resonator may have a diameter significantly less than one tenth of the wavelength of the power source.

The receive side single-ended resonator may comprise a helix wrapped around a core.

The core may comprise an air core.

The receive side transmitting coil may comprise a toroid.

The core may comprise a ferrite core.

A receive side receiving coil tuning network may be electrically coupled to the receive side receiving coil to cause the receive side receiving coil to be substantially at resonance at the operating frequency of the power source.

A receive side matching network may be electrically coupled between the receive side receiving coil and the load.

The receive side resonator tuning network may comprise a reactive component bank and the method may further comprise reading a feedback parameter; and in response to the feedback parameter, adjusting the reactance of the reactive component bank such that the feedback parameter approaches a target value.

The transmit side resonator tuning network may comprise a reactive component bank and the method may further comprise reading a feedback parameter; and in response to the feedback parameter, adjusting the reactance of the reactive component bank such that the feedback parameter approaches a target value.

The transmit side transmitting coil tuning network may comprise a reactive component bank and the method may further comprise reading a feedback parameter; and in response to the feedback parameter, adjusting the reactance of the reactive component bank such that the feedback parameter approaches a target value.

The transmit side matching network may comprise a reactive component bank and the method may further comprise reading a feedback parameter; and in response to the feedback parameter, adjusting the reactance of the reactive component bank such that the feedback parameter approaches a target value.

The receive side receiving coil tuning network may comprise a reactive component bank and the method may further comprise reading a feedback parameter; and in response to the feedback parameter, adjusting the reactance of the reactive component bank such that the feedback parameter approaches a target value.

The receive side matching network may comprise a reactive component bank and the method may further comprise reading a feedback parameter; and in response to the feedback parameter, adjusting the reactance of the reactive component bank such that the feedback parameter approaches a target value.

The reactance of the reactive component bank may be iteratively adjusted such that the feedback parameter approaches the target value and until a stop condition is satisfied.

Iteratively adjusting the reactance of the reactive component bank may comprise, for each iteration creating a generation of genomes, wherein each of the genomes corresponds to a different reactance of the reactive component bank; and, for each of the genomes, adjusting the reactance of the reactive component bank to the reactance corresponding to the genome; and reading the feedback parameter corresponding to the reactance of the genome.

The feedback parameter may be selected from the group consisting of voltage measured across two nodes in the system, current measured through a node in the system, S-parameters of any component in the system, power delivered to any component in the system, signal-to-noise ratio, and bit error rate.

The reactive component bank may comprise multiple switches each of which is connected in series to a capacitor, and adjusting the reactance of the reactive component bank may comprise actuating the switches to different states.

The load may comprise an RFID tag.

The method may further comprise adaptively matching the receive side receiving coil to the load in response to changes in operating conditions.

Changes in operating conditions may comprise at least one of a change in distance between the receive side single-ended resonator and the receive side receiving coil, a change in inductance of the load, a change in inductance of the load, and a change in alignment between the receive side single-ended resonator and the receive side receiving coil.

According to another aspect, there is provided a system for wireless and single conductor power transmission, the system comprising a receive side single-ended resonator for receiving power from an alternating current power source, wherein the power source is operable to emit power at an operating frequency and wherein the receive side single-ended resonator comprises first and second ends; a receive side receiving coil for transferring power to a load, wherein the receive side receiving coil inductively is coupled to the receive side single-ended resonator when the power source is operating, the receive side single-ended resonator and the receive side receiving coil being substantially at resonance when inductively coupled to each other; and a single conductor comprising a conducting structure having a non-constant cross-section, the single conductor being the only conductor transferring power from the power source to the receive side single-ended resonator and electrically coupled to the receive side single-ended resonator to transfer power to the resonator via the first end.

The system may further comprise a receive side receiving coil matching network electrically coupled between the receive side receiving coil and the load when the receive side receiving coil is transferring power to the load.

The second end of the receive side single-ended resonator may be floating.

The second end of the receive side single-ended resonator may also be connected to the single conductor such that the receive side single-ended resonator is electrically coupled to the single conductor via the first and second ends of the receive side single-ended resonator.

The system may further comprise a transmit side transmitting coil electrically coupled to the power source; a transmit side transmitting coil matching network electrically coupled between the power source and the transmit side transmitting coil; and a transmit side single-ended resonator inductively coupled to the transmit side transmitting coil, wherein the transmit side single-ended resonator comprises a first end and a second end and is electrically coupled to the single conductor to transfer power to the single conductor via the first end of the transmit side single-ended resonator, and wherein the transmit side single-ended resonator and transmit receive side transmitting coil are substantially at resonance when inductively coupled to each other.

The second end of the transmit side single-ended resonator may be floating.

The second end of the transmit side single-ended resonator may also be connected to the single conductor such that the transmit side single-ended resonator is electrically connected to the single conductor via the first and second ends of the transmit side single-ended resonator.

The system may further comprise a receive side resonator tuning network electrically coupled between the single conductor and the receive side single-ended resonator.

The system may further comprise a transmit side resonator tuning network electrically coupled between the single conductor and the transmit side single-ended resonator.

The system may further comprise a receive side receiving coil tuning network electrically coupled between the receive side receiving coil and the receive side matching network.

The system may further comprise a transmit side transmitting coil tuning network electrically coupled between the transmit side transmitting coil and the transmit side matching network.

At least one of the transmit side transmitting coil matching network, the receive side receiving coil tuning network, the transmit side resonator tuning network, the receive side resonator tuning network, the transmit side transmitting coil matching network, and the receive side receiving coil matching network may comprise a reactive component bank, and the system further may comprise control circuitry configured to read a feedback parameter of the system; and in response to the feedback parameter, adjust the reactance of the reactive component bank such that the feedback parameter approaches a target value.

The control circuitry may comprise a processor and a computer readable medium communicatively coupled to the processor, wherein the computer readable medium has stored thereon computer program code that is executable by the processor and that, when executed by the processor, causes the processor to read the feedback parameter of the system; and in response to the feedback parameter, iteratively adjust the reactance of the reactive component bank such that the feedback parameter approaches a target value and until a stop condition is satisfied.

Iteratively adjusting the reactance of the reactive component bank may comprise, for each iteration creating a generation of genomes, wherein each of the genomes corresponds to a different reactance of the reactive component bank; and, for each of the genomes, adjusting the reactance of the reactive component bank to the reactance corresponding to the genome; and reading the feedback parameter corresponding to the reactance of the genome.

The feedback parameter may be selected from the group consisting of voltage measured across two nodes in the system, current measured through a node in the system, S-parameters of any component in the system, power delivered to any component in the system, signal-to-noise ratio, and bit error rate.

The reactive component bank may comprise multiple switches each of which is connected in series to a capacitor, and adjusting the reactance of the reactive component bank may comprise actuating the switches to different states.

The system may further comprise a transmitter modulator electrically coupled to the transmit side transmitting coil, the transmitter modulator comprising a switch operable to modulate a signal transmitted to the receive side receiving coil.

The system may further comprise a receiver modulator electrically coupled to the receive side receiving coil, the receiver modulator comprising a switch operable to modulate a signal transmitted to the transmit side transmitting coil via the receive side receiving coil.

According to another aspect, there is provided a method for wireless and single conductor power transmission, the method comprising receiving alternating current power via a single conductor at a receive side single-ended resonator, wherein the power oscillates at an operating frequency; inductively transferring the power from the receive side single-ended resonator to a receive side receiving coil, wherein inductive transfer of the power occurs when the receive side single-ended resonator and the receive side receiving coil are both substantially at resonance; and powering a load using the power transferred from the receive side single-ended resonator to the receive side receiving coil, wherein the single conductor comprises a conducting structure having a non-constant cross-section.

A receive side receiving coil matching network may be electrically coupled between the receive side receiving coil and the load.

The receive side single-ended resonator may comprise a first end via which the receive side single-ended resonator receives power from the single conductor and a second end that is floating.

The receive side single-ended resonator may comprise a first end and a second end through which the receive side single-ended resonator receives power from the single conductor.

The method may further comprise transmitting power from a power source that outputs the power to a transmit side transmitting coil; inductively transferring the power from the transmit side transmitting coil to a transmit side single-ended resonator, wherein inductive transfer of the power occurs when the transmit side single-ended resonator and the transmit side transmitting coil are both substantially at resonance; and transferring power to the single conductor from the transmit side single-ended resonator.

The transmit side single-ended resonator may comprise a first end via which the single conductor receives power from the transmit side single-ended resonator and a second end that is floating.

The transmit side single-ended resonator may comprise a first end and a second end and wherein the single conductor receives power from both the first and second ends.

The method may further comprise tuning the resonance frequency of the receive side single-ended resonator using a receive side resonator tuning network electrically coupled between the single conductor and the receive side single-ended resonator.

The method may further comprise tuning the resonance frequency of the transmit side single-ended resonator using a transmit side resonator tuning network electrically coupled between the single conductor and the transmit side single-ended resonator.

The method may further comprise tuning the resonance frequency of the receive side receiving coil using a receive side receiving coil tuning network electrically coupled between the receive side receiving coil and the receive side matching network.

The method may further comprise tuning the resonance frequency of the transmit side transmitting coil using a transmit side transmitting coil tuning network electrically coupled between the transmit side transmitting coil and the transmit side matching network.

At least one of the transmit side transmitting coil matching network, the receive side receiving coil tuning network, the transmit side resonator tuning network, the receive side resonator tuning network, the transmit side transmitting coil matching network, and the receive side receiving coil matching network may a reactive component bank, and the method may further comprise reading a feedback parameter; and in response to the feedback parameter, adjusting the reactance of the reactive component bank such that the feedback parameter approaches a target value.

The method may further comprise in response to the feedback parameter, iteratively adjusting the reactance of the reactive component bank such that the feedback parameter approaches a target value and until a stop condition is satisfied.

Iteratively adjusting the reactance of the reactive component bank may comprise, for each iteration, creating a generation of genomes, wherein each of the genomes corresponds to a different reactance of the reactive component bank; and, for each of the genomes, adjusting the reactance of the reactive component bank to the reactance corresponding to the genome; and reading the feedback parameter corresponding to the reactance of the genome.

The feedback parameter may be selected from the group consisting of voltage measured across two nodes in the system, current measured through a node in the system, S-parameters of any component in the system, power delivered to any component in the system, signal-to-noise ratio, and bit error rate.

The reactive component bank may comprise multiple switches each of which is connected in series to a capacitor, and adjusting the reactance of the reactive component bank may comprise actuating the switches to different states.

The method may further comprise transmitting data between the transmit side transmitting coil and the receive side receiving coil.

The method may further comprise adaptively matching the receive side receiving coil to the load in response to changes in operating conditions.

Changes in operating conditions may comprise at least one of a change in distance between the receive side single-ended resonator and the receive side receiving coil, a change in inductance of the load, a change in inductance of the load, and a change in alignment between the receive side single-ended resonator and the receive side receiving coil.

According to another aspect, there is provided a system for wireless and single conductor power transmission, the system comprising a transmit side transmitting coil electrically coupled to a power source; a transmit side matching network electrically coupled between the power source and the transmit side transmitting coil; a transmit side single-ended resonator inductively coupled to the transmit side transmitting coil, wherein the transmit side single-ended resonator comprises a first end and a second end; a conducting structure connected to the transmit side single-ended resonator via the first end of the transmit side single-ended resonator; a receive side single-ended resonator comprising a first end and a second end, wherein the receive side single-ended resonator is connected to the conducting structure at the first end of the receive side single-ended resonator; a receive side receiving coil for transferring power to a load, wherein the receive side receiving coil is inductively coupled to the receive side single-ended resonator when the power source is operating; and a receive side matching network electrically coupled between the receive side receiving coil and the load when the receive side receiving coil is transferring power to the load, wherein each of coils and resonators is substantially at resonance power is transferred from the power source to the load.

The second end of the transmit side single-ended resonator may be floating.

The second end of the transmit side single-ended resonator may also be connected to the conducting structure such that the transmit side single-ended resonator is electrically connected to the conducting structure via the first and second ends of the transmit side single-ended resonator.

The second end of the receive side single-ended resonator may be floating.

The second end of the receive side single-ended resonator may also be connected to the conducting structure such that the receive side single-ended resonator is electrically coupled to the conducting structure via the first and second ends of the receive side single-ended resonator.

The system may further comprise a receive side resonator tuning network electrically coupled between the conducting structure and the receive side single-ended resonator.

The system may further comprise a transmit side resonator tuning network electrically coupled between the conducting structure and the transmit side single-ended resonator.

The system may further comprise a receive side receiving coil tuning network electrically coupled between the receive side receiving coil and the receive side matching network.

The system may further comprise a transmit side transmitting coil tuning network electrically coupled between the transmit side transmitting coil and the transmit side matching network.

At least one of the transmit side matching network and the receive side matching network may comprise a reactive component bank and the system may further comprise control circuitry configured to read a feedback parameter of the system; and in response to the feedback parameter, adjust the reactance of the reactive component bank such that the feedback parameter approaches a target value.

The control circuitry may comprise a processor and a computer readable medium communicatively coupled to the processor, wherein the computer readable medium has stored thereon computer program code that is executable by the processor and that, when executed by the processor, causes the processor to read the feedback parameter of the system; and in response to the feedback parameter, iteratively adjust the reactance of the reactive component bank such that the feedback parameter approaches a target value and until a stop condition is satisfied.

Iteratively adjusting the reactance of the reactive component bank comprises, for each iteration, creating a generation of genomes, wherein each of the genomes corresponds to a different reactance of the reactive component bank; and, for each of the genomes, adjusting the reactance of the reactive component bank to the reactance corresponding to the genome; and reading the feedback parameter corresponding to the reactance of the genome.

The feedback parameter may be selected from the group consisting of voltage measured across two nodes in the system, current measured through a node in the system, S-parameters of any component in the system, power delivered to any component in the system, signal-to-noise ratio, and bit error rate.

The reactive component bank may comprise multiple switches each of which is connected in series to a capacitor, and wherein adjusting the reactance of the reactive component bank comprises actuating the switches to different states.

The system may further comprise a transmitter modulator electrically coupled to the transmit side transmitting coil, the transmitter modulator comprising a switch operable to modulate a signal transmitted to the receive side receiving coil.

The system may further comprise a receiver modulator electrically coupled to the receive side receiving coil, the receiver modulator comprising a switch operable to modulate a signal transmitted to the transmit side transmitting coil via the receive side receiving coil.

According to another aspect, there is provided the use of any of the foregoing aspects of the system for data transmission.

This summary does not necessarily describe the entire scope of all aspects. Other aspects, features and advantages will be apparent to those of ordinary skill in the art upon review of the following description of specific embodiments.

### BRIEF DESCRIPTION OF THE DRAWINGS

In the accompanying drawings, which illustrate one or more example embodiments:

FIG. 1 shows a system for combined single conductor and wireless power transfer, according to one embodiment.

FIG. 2 shows a circuit diagram of a model of the system of FIG. 1.

FIG. 3 shows a receive side single-ended resonator and a receive side receiving coil, comprising part of another embodiment of the system for combined single conductor and wireless power transfer.

FIG. 4 shows a method for determining component values for a transmit side matching network comprising part of another embodiment of the system for combined single conductor and wireless power transfer.

FIGS. 5A-5D show examples of a conducting structure comprising part of another embodiment of the system for combined single conductor and wireless power transfer.

FIG. 6 shows an example of the conducting structure connected to multiple receivers, the structure and receivers comprising part of another embodiment of the system for combined single conductor and wireless power transfer.

FIG. 7 shows an example receive side single-ended resonator and receive side receiving coil comprising part of another embodiment of the system for combined single conductor and wireless power transfer, in which the resonator comprise a ferrite toroid and the receiving coil comprises an air core solenoid.

FIGS. 8A-8C show example fitted vs. measured impedance parameters of another embodiment of the system for combined single conductor and wireless power transfer obtained using test ports shown on FIG. 2.

FIG. 9 shows a fitted mutual inductance between the receive side single-ended resonator and receive side receiving coil of another embodiment of the system for combined single conductor and wireless power transfer as the distance between them changes.

FIGS. 10A and 10B show graphs of input impedance vs. load resistance for another embodiment of the system for combined single conductor and wireless power transfer for various spacings between the receive side single-ended resonator and receiving coil.

FIGS. 11A and 11B show graphs of load resistance vs. frequency for another embodiment of the system for combined single conductor and wireless power transfer for various values of tuning capacitors used to tune the resonant frequency of the receive side single-ended resonator.

FIG. 12 shows various efficiency curves for example embodiments of the system for wireless and single conductor power transfer.

FIGS. 13A and 13B show graphs of output power and input impedance, respectively, of example embodiments of the system for combined single conductor and wireless power transfer for various spacings between the receive side single-ended resonator and receiving coil.

FIGS. 14A and 14B show graphs of efficiency and input impedance, respectively, of example embodiments of the system for combined single conductor and wireless power transfer for various operating frequencies.

FIGS. 15A-15C show graphs of reflection coefficient (FIGS. 15A and 15B) and efficiency (FIG. 15C) vs. frequency for example embodiments of the system for combined single conductor and wireless power transfer using boxes of different sizes as the conducting structure.

FIGS. 16A and 16B show graphs of impedance parameters vs. frequency for example embodiments of the system for combined single conductor and wireless power transfer.

FIGS. 17A and 17B show graphs of the reflection coefficient vs. frequency for various embodiments of the system for combined single conductor and wireless power transfer comprising a different number of receivers connected to the conducting structure.

FIGS. 18A and 18B show graphs of transmission coefficient and transferred power vs. frequency for various embodiments of the system for various embodiments of the system for combined single conductor and wireless power transfer comprising a different number of receivers connected to the conducting structure.

FIGS. 19A and 19B show graphs of efficiency, transferred power, and input impedance vs. frequency for various embodiments of the system for combined single conductor and wireless power transfer.

FIGS. 20A-20D show graphs of input impedance (FIGS. 20A-20C) and efficiency vs. frequency for various embodiments of the system for combined single conductor and wireless power transfer.

FIGS. 21A and 21B show a schematic of the receive side single-ended resonator and a lumped element model of the resonator, according to another embodiment of the system for combined single conductor and wireless power transfer.

FIG. 22 shows a graph of simulated reflection coefficient vs. frequency of the resonator of FIGS. 21A and 21B.

FIG. 23 shows a schematic of the resonator of FIGS. 21A and 21B.

FIGS. 24A and 24B show graphs of the reflection coefficient vs. frequency for various spacings between the receive side single-ended resonator and receiving coil.

FIGS. 25A-25C show embodiments of the receive side single-ended resonator and receiving coil comprising planar, spiral coils.

FIG. 26 shows measured S-parameters of the receive side single-ended resonator tuned to various resonant frequencies.

FIG. 27 shows graphs of power transferred by the receive side single-ended resonator at various degrees of tuning.

FIG. 28 shows a fabricated receive side single-ended resonator with a matching circuit, according to another embodiment.

FIG. 29 shows the effect of matching on the reflection coefficient of one example embodiment of the system for combined single conductor and wireless power transfer.

FIG. 30 shows the effect of tuning on DC voltage measured at the load for various spacings between the receive side single-ended resonator and the receive side receiving coil.

FIGS. 31A-31C shows graphs of voltage vs. distance for various embodiments of planar receive side receiving coils of different shapes.

FIGS. 32 and 33 show an example embodiment of a system for modifying impedance at various locations in the system for single conductor and wireless power transfer.

FIG. 34 shows a graph of output voltage vs. number of iterations contrasting applying an example method for modifying impedance at various locations in the system for single conductor and wireless power transfer to randomly modifying impedance.

FIG. 35 shows an example embodiment of a method for modifying impedance at various locations in the system for single conductor and wireless power transfer.

FIG. 36 shows a schematic of an example system for modifying impedance at various locations in the system for single conductor and wireless power transfer, according to another embodiment.

FIG. 37 shows a graph of DC voltage vs. distance between the receive side single-ended resonator and receive side receiving coil when the system for single conductor and wireless power transfer is tuned vs. not tuned.

FIGS. 38A and 38B depict an embodiment of the system for single-ended and wireless power transfer configured for RFID tag measurement.

### DETAILED DESCRIPTION

Directional terms such as “top”, “bottom”, “upwards”, “downwards”, “vertically”, and “laterally” are used in the following description for the purpose of providing relative reference only, and are not intended to suggest any limitations on how any article is to be positioned during use, or to be mounted in an assembly or relative to an environment. Additionally, the term “couple” and variants of it such as “coupled”, “couples”, and “coupling” as used in this description are intended to include indirect and direct connections unless otherwise indicated. For example, if a first device is coupled to a second device, that coupling may be through a direct connection or through an indirect connection via other devices and connections. Similarly, if the first device is communicatively coupled to the second device, communication may be through a direct connection or through an indirect connection via other devices and connections.

In inductive coupling, a transmitter is used to wirelessly transfer power to a receiver. The transmitter comprises a transmitting coil and the receiver comprises a receiving coil, and an alternating current (“AC”) signal applied to the transmitting coil generates a magnetic field that induces an electric current in the receiving coil. The commercial and practical utility of wirelessly transmitting power using conventional systems that rely on inductive coupling is limited by the significant decrease in transmission efficiency as the distance between the transmitter and receiver grows. One conventional way of increasing transmission efficiency is to transfer power when each of the transmitting and receiving coils is at or substantially at resonance; this is referred to as “resonant inductive coupling”. However, even when transferring power using resonant inductive coupling, the decrease in efficiency as the distance between the transmitter and receiver increases remains a practical problem that affects conventional systems, particularly for transfer distances on the order of meters and higher.

The embodiments described herein are directed at a method and system for wireless power transfer that combines single conductor or single wire power transfer with inductive coupling to wirelessly transfer power. In some of these embodiments, the inductive coupling is performed using a single-ended resonator coil inductively coupled to a conventional coil, with each of the coils being at or substantially at resonance while power is being transferred. In one embodiment, operating “substantially at” resonance refers to operating such that power transfer is within 3 dB of power transferred when exactly at resonance. In another embodiment, operating “substantially at” resonance refers to operating such that power transfer is within 1 dB, 2 dB, 3 dB, 4 dB, 5 dB, or 6 dB of power transferred when exactly at resonance. In some embodiments, one or both of the resonator and conventional coils may have multiple resonance frequencies, and operating “at or substantially at” resonance may refer to operating at any one of those resonance frequencies or such that power transferred is within, for example, 1 dB, 2 dB, 3 dB, 4 dB, 5 dB, or 6 dB of power transferred when operating exactly at any one of those resonance frequencies. Transferring power in this manner permits power to be transferred more efficiently over relatively long distances compared to the conventional techniques used for wirelessly transferring power, described above. As used herein, a reference to a resonator being “single-ended” refers to the resonator's electrical characteristics being in contrast to a differential signaling system.

Furthermore, in some of the embodiments described herein, power may be transferred to the transmitter via an arbitrarily shaped conducting structure. This conducting structure may be conventional, such as a wire, or may be non-conventional, such as an oil rig or a conductive/metallic table or shelf. More generally, conducting structures such as an oil rig, a shelf, and a table are referred to herein as “non-wire conducting structure”, which are electrical conductors that do not comprise any wires or that do comprise, but are not limited to, one or more wires. In different embodiments, as opposed to classifying the arbitrarily shaped conducting structure as either being a wire or a non-wire conducting structure, the conducting structure may be classified as either having a constant cross-section along its length (e.g., a wire, conductive rod, or a bus bar) or as having a non-constant cross-section along its length (e.g., an oil rig or a table). Suitable conducting structures comprise structures of conductivity sufficient to permit signal transfer between receiver(s) and transmitter(s) and may comprise metal, carbon, conductive polymers, ionic conductors such as saltwater, semiconductors, and in certain embodiments biological organisms such as human or animal bodies.

As discussed below, in the following example embodiments when the distance of power transfer is kept relatively short compared to the wavelength of operation (e.g., 22 m at 13.56 MHz) transmission line effects do not significantly affect power transfer or resonance. Accurate equivalent circuit models of the resonator coils and single conductor transmission lines are demonstrated and validated through circuit fitting of measured and simulated results. An example method of load matching is described and the relatively high efficiency of power transmission to single and multiple receivers is demonstrated.

In at least some of the following embodiments, single-conductor and wireless power transfer are combined to efficiently provide power to one or more receivers through an arbitrarily shaped conducting structure. An arbitrarily shaped conducting structure is selected in certain embodiments to have dimensions that render it electrically small and to consequently have a near uniform voltage distribution. Power is provided via the conducting structure to a transmitting single-ended resonator coil operating at or substantially at resonance and that has an electrical length expressed in wavelengths of the operating frequency of the alternating current (“AC”) power source greater than that of the conducting structure. For example, the transmitting single-ended resonator coil may have an electrical length of greater than or equal to λ/4, and in one example embodiment equal to

$$\frac{λ}{4} + n \cdot \frac{λ}{2} ,$$

where n is a positive integer, while the conducting structure has an electrical length of less than λ/4. For structures below this size the single conductor connection can be modeled more easily, since specific resonances of the structure do not interfere with transmission. This transmitting single-ended resonator coil is inductively coupled to a resonant, conventional receiving coil in close proximity to the transmitting coil, where “close proximity” in one embodiment refers to a separation distance less than the diameter of the smaller of the transmitting single-ended resonator and receiving coils, to deliver power. The single-ended resonating transmitting coil may, for example, comprise a conductor less than one-fourth of a wavelength; in a different embodiment, the coil may comprise a conductor less than one-fifth of a wavelength; in different embodiments, the coil may comprise a conductor having a length of a different fraction of a wavelength, with the length of the wavelength depending on the tuning. Additionally or alternatively, the single-ended resonating transmitting coil may be wound such that it is less than 1/150th of a wavelength in diameter. The transfer through electrically large conducting structures greater than one-fourth of a wavelength in size (primarily, transmission through surface waves) can be used with this method as well.

Certain embodiments are also directed at transmitting data using the same signal that transmits power. For example, the signal that is transferring power may be modulated such that data is encoded thereon, and data may be transferred while simultaneously transferring power. In these embodiments, a reference to transferring power is synonymous with a reference to transferring data.

The characterization and modular design of a wireless power transfer system at 13.56 MHz comprising a single-ended, matched series transmitting resonator coil operating at resonance with transmission through an arbitrarily shaped conducting structure is described below. A two-port network comprising the transmitter and receiver coils is evaluated with circuit-model fitting. Load impedance matching is determined using measured impedance parameters, balancing the requirements of efficiency and power transfer.

### System Outline

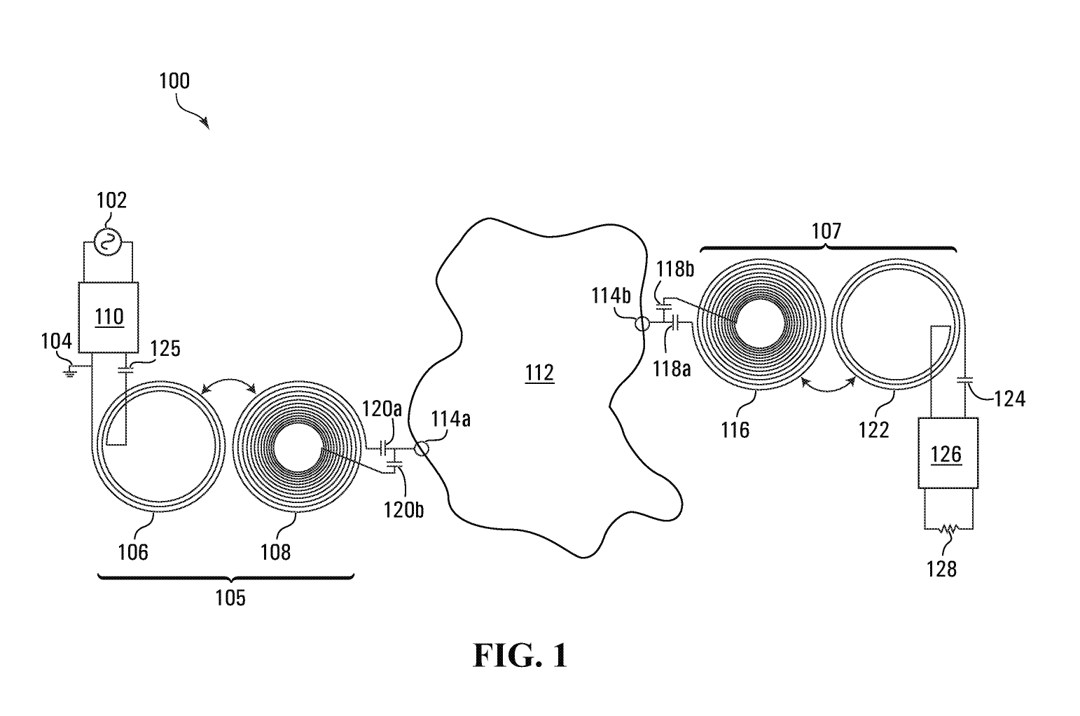

A diagram of a system 100 for combined single conductor and wireless power transfer is shown in FIG. 1 for transferring power from an AC power source 102 to a load 128 via an arbitrarily shaped conducting structure 112. The system 100 comprises two pairs of coils: a transmit side coil pair 105 electrically coupled between the power source 102 and the conducting structure 112 and a receive side coil pair 107 electrically coupled between the conducting structure 112 and the load 128. The transmit side coil pair 105 comprises a transmitting coil 106 (“transmit side transmitting coil 106”) inductively coupled to a receiving single-ended resonator coil 108 (“transmit side receiving coil 108”) when the system 100 is in operation. The receive side coil pair 107 analogously comprises another transmitting single-ended resonator coil (“receive side transmitting coil 116”) inductively coupled to another receiving coil 122 (“receive side receiving coil 122”) when the system 100 is in operation. The electrical connection between the transmit side receiving coil 108, the conducting structure 112, and the receive side transmitting coil 116 is a “single conductor” or “single ended” connection; that is, the receive side transmitting single-ended resonator coil 116 receives power from a power source using only a single electrical conductor as opposed to using a pair of electrical conductors as in a conventional system. A “single electrical conductor” may comprise multiple electrical conductors shorted together so that, electrically, they act as a single conductor. In the depicted example embodiment, the conducting structure 112 is connected to the transmit side receiving single-ended resonator coil 108 at only a first single connection point 114a and to the receive side transmitting single-ended resonator coil 116 at only a second single connection point 114b.

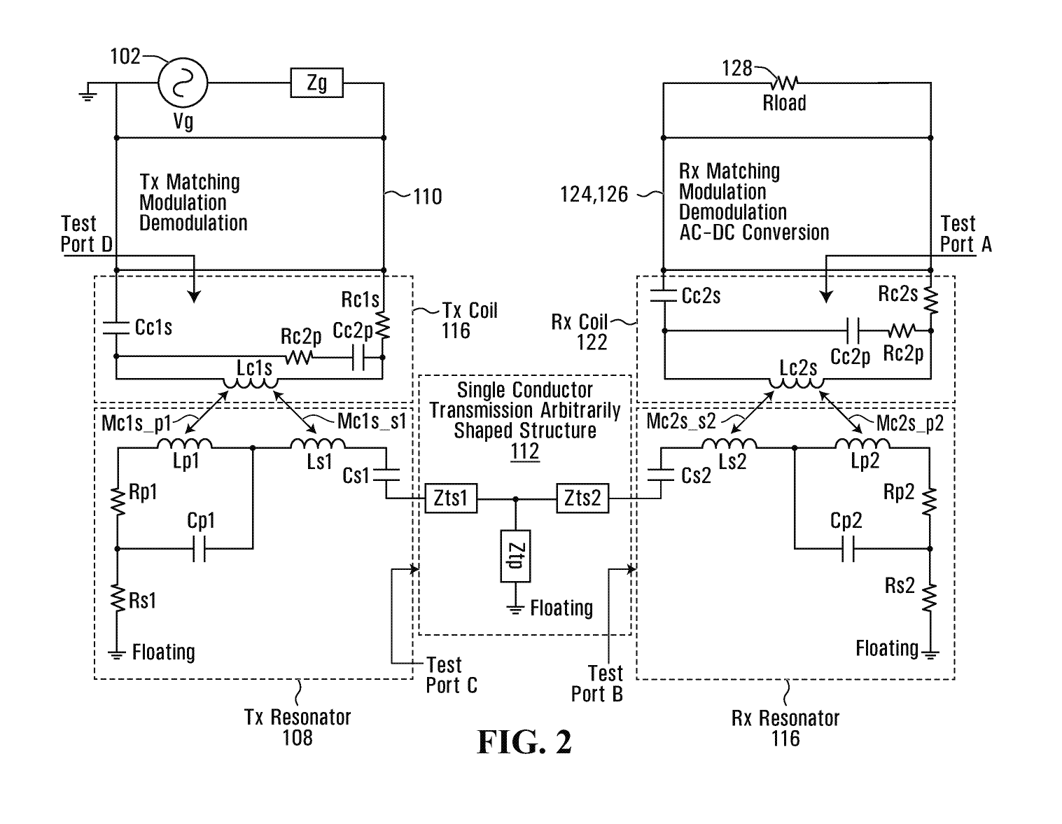

In the example embodiment of FIG. 1, the power source 102 is electrically coupled to a ground terminal 104 that is connected to a terminal of the transmit side transmitting coil 106, which is inductively coupled with the transmit side receiving single-ended resonator coil 108. A series capacitor 125 acts as a tuning network to tune the resonant frequency of the transmitting coil 106. The frequency of the power source 102 is selected so both of the coils 106, 108 are at or substantially at resonance when the system 100 is in operation. The power source's 102 terminals are electrically coupled to a two-port matching network 110 (“transmit side matching network 110”), designed to be low loss, and to transform the single conductor input impedance to the input impedance suitable for the desired output power to be achieved, as discussed in further detail below in respect of FIG. 2. Power is transferred to the transmit side receiving single-ended resonator coil 108 via the transmit side transmitting coil 106, and the conducting structure 112 is electrically coupled to the transmit side receiving single-ended resonator coil 108 at only the first single connection point 114a.

In different embodiments (not depicted), the ground terminal 104 may be a floating ground and may be electrically coupled directly to the conducting structure 112 at the connection point 114. Additionally or alternatively, the ground terminal 104 may comprise earth or a chassis ground.

The conducting structure 112 is electrically coupled at the second single connection point 114b in series to the receive side transmitting single-ended resonator coil 116, which acts as a single-ended resonator (the receive side transmitting single-ended resonator coil 116 is hereinafter interchangeably referred to as the “receive side single-ended resonator 116”). The receive side single-ended resonator 116 comprises a first end via which it receives power from the power source 102 and a second end. A first capacitor 118a is electrically coupled in series with the windings of the receive side single-ended resonator 116; while the first capacitor 118a is shown as a single lumped element in FIG. 1, in different embodiments (not depicted) the total capacitance may be distributed through multiple capacitances comprising a series, parallel, or hybrid series/parallel network (e.g., several capacitors may be placed in one or both of series and parallel between different points of the receive side single-ended resonator's 116 windings). A second capacitor 118b is electrically coupled in series between the second end of the receive side single-ended resonator 116 and the second single connection point 114b. In different embodiments (not depicted), as described in respect of the first capacitor 118a, the second capacitor 118b may similarly be distributed through multiple capacitances comprising a series, parallel, or hybrid series/parallel network. The first and second capacitors 118a,b collectively comprise a tuning network used to tune the resonant frequency of the receive side single-ended resonator 116 in a manner described in further detail below. Another set of first and second capacitors 120a,b also act as a tuning network for, and are analogously electrically connected to, the transmit side receiving single-ended resonator coil 108; the transmit side receiving single-ended resonator coil 108 also acts as a single-ended resonator and is hereinafter interchangeably referred to as the “transmit side single-ended resonator 116”. The capacitors 118a,b on the receive side single-ended resonator 116 and the capacitors 120a,b on the transmit side single-ended resonator 108 may have identical or different geometries or magnitudes. While the tuning networks for the transmit and receive side single-ended resonators 108, 116 are shown as being entirely capacitive, in different embodiments (not depicted) one or both of those tuning networks may additionally or alternatively comprise one or both of inductive and resistive elements in any suitable circuit configuration, such as π and T networks. In one embodiment, any one or more of the coils 108, 116 and resonators 106, 116 may comprise a lumped component such as a surface mount transformer.

Spaced from the receive side single-ended resonator 116 is the receive side receiving coil 122, which also comprises first and second ends. A series capacitor 124 acts as a tuning network to tune the resonant frequency of the receiving coil 122, and the ends of the coil 122 are electrically coupled to a receive side matching network 126 and load 128, with one end of the receiving coil 122 electrically coupled to the matching network 126 via the capacitor 124. While in the depicted embodiment the electrical load 128 is represented as being entirely resistive, alternatively the load 128 may comprise a non-zero reactance or include alternating current to direct current conversion circuitry such as a rectifier. In various embodiments the matching network 126 may comprise one or more of inductive, capacitive and resistive elements in any suitable circuit configuration, such as it and T networks. As used herein, the “transmitter” refers collectively to the power source 102, transmit side matching network 110, conducting structure 112, transmit side transmitting coil 106, the transmit side single-ended resonator 108, and all capacitors shown in FIG. 1 between the power source 102 and the conducting structure 112; and “receiver” refers collectively to the receive side receiving coil 122, the receive side single-ended resonator 116, receive side matching network 126, the load 128, and all capacitors shown in FIG. 1 between the conducting structure 112 and the load 128.

The receive side matching network 126 allows the load 128 to be transformed while the system 100 is in operation by using monitoring power transferred to the load 128 and by iteratively adjusting the capacitors (or other components) comprising the matching network 126; this type of real-time monitoring and tuning facilitates relatively high power efficiency and transfer. The resonance frequency of the resonators 108, 116 and coils 106, 122 does not dramatically shift if the load 128 varies. The receive side single-ended resonator 116 is able to be tuned through the use of the capacitors 118a,b. Variable tuning on both the receive side receiving coil 122 and receive side single-ended resonator 116 can be used to compensate for the effect of the conducting structure 112 on system performance, as described in further detail below. While in FIG. 1 the use of the transmit side coil pair 105 permits transformation between single and double ended transmission, in different embodiments and as discussed in more detail below, the ground terminal 104 may comprise a floating ground that allows direct connection to the conducting structure 112. In certain embodiments, with transmitter matching, the voltage of the power source 102 may be lowered and the input load impedance can be modified in order to obtain the desired power transfer to the load 128 as opposed to inefficiently increasing input power or voltage.

In different embodiments (not depicted), the single ended connection can be maintained even if one or both of the transmit side single-ended resonator 108 and the receive side single-ended resonator 116 is connected to the conducting structure 112 at more than one point. For example, on the receive side, each of the capacitors 118a,b may be physically coupled to two different, but electrically shorted or otherwise electrically connected, locations on the structure 112. Analogously, on the transmit side, each of the capacitors 118a,b may be physically coupled to two different, but electrically shorted or otherwise electrically connected, locations on the structure 112. Additionally, while the capacitors 118a,b and 120a,b are used for tuning in the depicted example embodiment, in different embodiments (not depicted), any type of reactive lumped component electrically connected to different parts of the resonators 108, 116 may be used for tuning. As used herein, a “lumped component” refers to a discrete electrical component, such as a surface mount component, and specifically contrasts with an inductance, capacitance, or resistance that is distributed throughout the system 100 or that is parasitic in nature. For example, in one alternative embodiment, inductors may be used instead of or in addition to the capacitors 118a,b and 120a,b for tuning. The reactive components may be connected, for example, in series between the first end of the resonator 116 and the conducting structure 112; in series between the second end of the resonator 116 and the conducting structure 112; between any two points along the resonator 116; with one end connected to the second end of the resonator 116 and the other end left floating; in series between the first end of the resonator 108 and the conducting structure 112; in series between the second end of the resonator 108 and the conducting structure 112; between any two points along the resonator 108; and with one end connected to the first end of the resonator 108 and the other end left floating. Additionally or alternatively, in some embodiments one end of one or both of the resonators 108, 116 may be floating regardless of the particular tuning circuitry used; for example, the second end of the receive side single-ended resonator 116 may be left floating (i.e., the second end of the resonator 116 may be physically connected to the structure 112 only via the first end of the resonator 116). In additional embodiments, tuning may be varied by controlling the length of the one or more of the resonators 108, 116 and coils 106, 122. In another example embodiment, the conducting structure 112 may be capacitively coupled to the transmit side single-ended resonator 108 using a capacitor that comprises a metal plate connected to the resonators 108 and that is separated from the conducting structure 112 by a dielectric, such as air; the conducting structure 112 may be analogously capacitively coupled to the receive side single-ended resonator 116.

### Circuit Model

FIG. 2 shows a circuit diagram of a model of the system 100 of FIG. 1. The model is divided into nine modules: the receiver comprises the load 128, receive side matching network 126 (which in FIG. 2 also comprises control electronics), receive side receiving coil 122, and receive side single-ended resonator 206. The transmitter comprises the conducting structure 112, which electrically acts as a transmission line, transmit side single-ended resonator 108, transmit side transmitting coil 106, transmit side matching network 110 (which in FIG. 2 also comprises control electronics), and power source 102. In FIG. 2, the functionality performed by the tuning capacitors for the transmit and receive side transmitting and receiving coils 106, 108, 116, 122 comprise part of the circuit representations for those coils 106, 108, 116, 122. The link between the resonators 108, 116 and coils 106, 122 characterizes the mutual impedance or coupling between them. The circuit model for each of the resonators 108, 116 comprises a parallel RLC circuit in series with a series RLC circuit; while the resistance is theoretically frequency dependent, in FIG. 2 a simple constant resistance is used for modeling.

When generating a circuit model for an antenna, the circuit model may be expanded in terms of the poles associated with it, but realizations for all but the lowest order poles is generally considered to be extremely complicated. To accurately model the first resonant and anti-resonant modes, a three or four element equivalent circuit is typically sufficient, while in the present disclosure a six element model is used. In FIG. 2, the capacitance of the transmit side single-ended resonator 108 is labeled Cₚ₁ and the capacitance of the receive side single-ended resonator 116 is labeled Cₚ₂, and these capacitances primarily represent inter-winding capacitance and lumped capacitors connected between different locations on the resonators' 108, 116 windings. The self-capacitance of the transmit side single-ended resonator 108 is represented as Cₛ₁ while that of the receive side single-ended resonator 116 is labeled Cₛ₂, and these capacitances are modified primarily by placing them in series with a reactance and by adjusting the lengths of the resonators 108, 116 themselves. Lₛ₁ and Lₚ₁ are the self-inductances of the transmit side single-ended resonator 108 while Lₛ₂ and Lₚ₂ are the self-inductances of the receive side single-ended resonator 116; these self-inductances are directly proportional to the number of windings comprising and the diameters of the resonators 108, 116. The series resistance of the inductor (a combination of Rₛ₁ and Rₚ₁ for the transmit side single-ended resonator 108 and of Rₛ₂ and Rₚ₂ for the receive side single-ended resonator 116) comprises dielectric, radiation and ohmic losses, with ohmic losses ideally dominating.

In order to validate the circuit model, characterize the receive side single-ended resonator 116, and predict changes that may result in increased performance of the system 100, the values of the circuit components in the circuit of FIG. 2 for the receive side receiving coil 122 and receive side single-ended resonator 116 are fit to the measured two-port impedance parameters. The fitted two-port parameters are those between test port A and test port B as shown in FIG. 2.

The self-impedance of the transmitter is given by

$${Z}_{11} = {R}_{s 2} + {XL}_{s 2} + {XC}_{s 2} + \frac{{XC}_{p 2} ( {XL}_{p 2} + {R}_{p 2} )}{{XC}_{p 2} + {XL}_{p 2} + {R}_{p 2}} , \qquad ( 1 )$$

where the specific lumped elements are shown in FIG. 2. Starting values of Lₚ₂ and Cₚ₂ are chosen to provide resonance at the observed frequency and Rₚ₂ is chosen to result in the maximum resistance measured at the anti-resonant frequency. The self-impedance of the receiver is given by

$${Z}_{22} = {XC}_{c 2 s} + {R}_{c 2 s} + \frac{{XC}_{c 2 p} ( \begin{matrix}{R}_{c 2 p} + {XL}_{c 2 s} - {XM}_{c 2 s\_p 2} + \\ {XM}_{c 2 s\_p 2} \frac{{R}_{p 2} + {XC}_{p 2} + {XL}_{p 2} - {XM}_{c 2 s\_p 2}}{{R}_{p 2} + {XC}_{p 2} + {XL}_{p 2}}\end{matrix} )}{\begin{matrix}{XC}_{c 2 p} + {R}_{c 2 p} + {XL}_{c 2 s} - {XM}_{c 2 s\_p 2} + {XM}_{c 2 s\_p 2} \\ \frac{{R}_{p 2} + {XC}_{p 2} + {XL}_{p 2} - {XM}_{c 2 s\_p 2}}{{R}_{p 2} + {XC}_{p 2} + {XL}_{p 2}}\end{matrix}} , \qquad ( 2 )$$

where R_{c2p} is the series resistance of the lumped series capacitors of the receive side receiving coil 122. The mutual inductance between the receive side single-ended resonator 116 and the receive side receiving coil 122 XM_{c2s}_{_}ₚ₂ is found both from fitting to the self-impedance of the receiver and also from fitting to the mutual impedance between the coil 122 and resonator 116 after finding all the other circuit parameters. The mutual inductance is split up into that between the receive side receiving coil 122 and the series inductance Lₛ₂, as well as with the parallel inductance Lₚ₂. There are two mutual inductances included because physically the receive side single-ended resonator 116 is similar to a distributed impedance transmission line and the single parallel resonant section model doesn't completely account for the coupling without also including a series mutual inductance. The mutual impedance is given by

$${Z}_{x 1} = {XC}_{c 2 p} + {R}_{c 2 p} + {XL}_{c 2 s} - {XM}_{c 2 s\_p 2} \\ {Z}_{x 2} = \frac{{XM}_{c 2 s\_p 2} {Z}_{x 1}}{{XM}_{c 2 s\_p 2} + {Z}_{x 1}} \\ {Z}_{12} = \frac{{XC}_{p 2} {XC}_{c 2 p}}{{XC}_{p 2} + {Z}_{x 2} + {R}_{p 2} + {XC}_{p 2} + {XL}_{p 2} - {XM}_{c 2 s\_p 2}} \frac{{XM}_{c 2 s\_p 2}}{{XM}_{c 2 s\_p 2} + {Z}_{x 1}} + {XM}_{c 2 s\_s 2} , \qquad ( 3 )$$

where XM_{c2s}_{_}ₛ₂ is the coupling between the receive side receiving coil 122 and the series inductance Lₛ of the receive side single-ended resonator 116.

### End-to-End Transmitter and Receiver

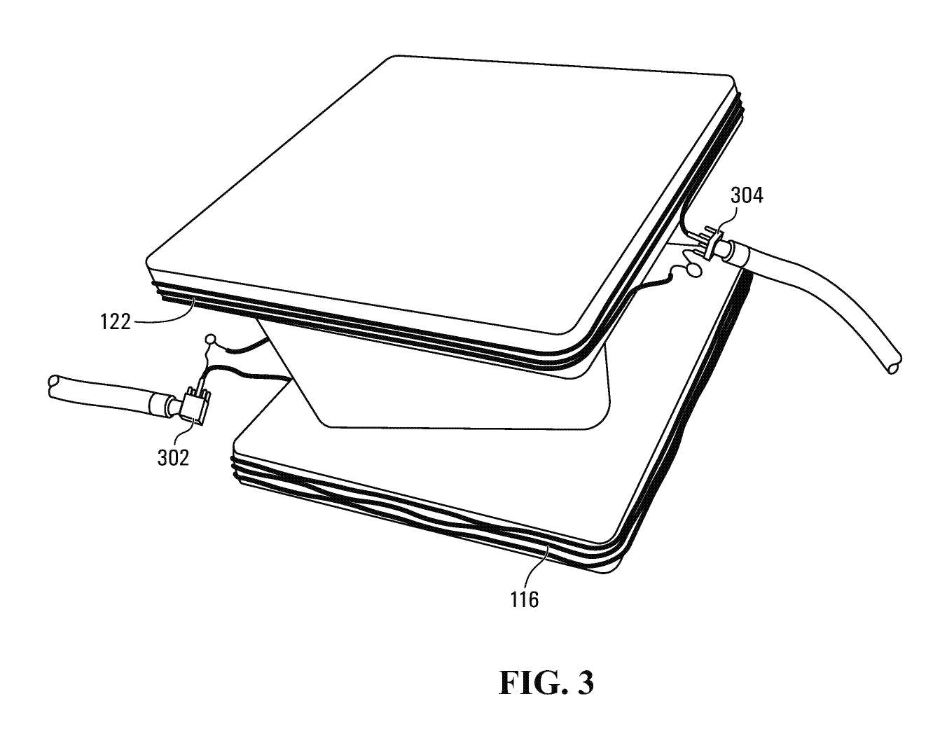

FIG. 3 shows the receive side single-ended resonator 116 and the receive side receiving coil 122 used to measure the two-port parameters of the system 100 between test port A and test port B of FIG. 2. The receive side receiving coil 122 and resonator 116 are each square-shaped with a side length of 15 cm. The self-resonance of the resonator 116 with 7 turns of 22 AWG wire on Styrofoam™ is lower than the selected transmission frequency of 13.56 MHz and the resonance frequency is tuned using the series and parallel capacitors 118a,b to be slightly higher than the transmission frequency. Three turns of 22 AWG wire on Styrofoam™ are used for the receiving coil 122 and the coil 122 is tuned with the series capacitor 124. Alternatively, more turns may be used for one or both of the receiving coil 122 as this increases the quality factor and therefore efficiency of transmission, but it is desired to keep the resulting reflected resistance low so input impedance of the transmitter may be kept relatively low as well. Alternatively or additionally, more turns may be added to the resonator 116 together with appropriate modifications to the tuning circuitry. The resonator 116 and coil 122 are separated by 7.62 cm of Styrofoam™. One end of the resonator 116 is connected to the center pin of an SMA connector 302 for single-ended connection, while the ends of the coil 122 are conventionally connected to center pin and ground of another SMA connector 304.

### Efficiency and Power Calculation

The transmit and receive side matching networks 110, 126 are designed to improve wireless power transfer efficiency,

$$η = \frac{{P}_{L}}{{P}_{S}} , \qquad ( 4 )$$

where P_{L} is the power delivered to the load 128 and Ps is the input power to the system 100 by the power source 102. For an n-port network the load impedances are represented in the matrix

$${Z}_{L} = [ \begin{matrix}0 & 0 & … & 0 \\ 0 & {Z}_{L 1} & … & 0 \\ ⋮ & ⋮ & ⋱ & 0 \\ 0 & 0 & 0 & {Z}_{Ln - 1}\end{matrix} ] , \qquad ( 5 )$$

where Z_{Ln-1} is the load 128 at each of the receivers in embodiments of the system 100 that comprise more than one of the receivers. The impedance of the power source 102 is represented by

$${Z}_{G} = [ \begin{matrix}{Z}_{G} & 0 & … & 0 \\ 0 & 0 & … & 0 \\ ⋮ & ⋮ & ⋱ & 0 \\ 0 & 0 & 0 & 0\end{matrix} ] . \qquad ( 6 )$$

The currents in each of the loads 128 are found with

$$I = {( {Z}_{nport} + {Z}_{L} + {Z}_{G} )}^{- 1} [ \begin{matrix}{V}_{g} \\ 0 \\ ⋮ \\ 0\end{matrix} ] , \qquad ( 7 )$$

where Zₙₚₒᵣₜ represents the impedance parameters of the system 100. The input impedance of the network is

$${Z}_{in} = \frac{{V}_{g}}{I ( 1 )} - {Z}_{G} , \qquad ( 8 )$$

and the input power is then found as

Pₛ=I(1) [symbol] (Zᵢₙ+Z_{G})I(1) [symbol] . (9)

The power delivered to the loads 128 is then

P_{L}=I [symbol] (Z_{L})I [symbol] (6) (10)

### System Simplifications

Efficiency is balanced with the requirements of providing the required power to the load 128 and of obtaining the desired input impedance. Common test measurement devices have an internal source resistance of 50Ω and it is common in the subject of microwave theory and techniques to match the load impedance to 50Ω for maximum power transfer and lowest reflected power. Therefore, in the example below the load 128 is presumed to have an impedance of 50Ω and the power delivered is given for this value, and impedance matching for highest efficiency is done for this value as well. The power delivered is also given assuming a 50Ω source impedance, while efficiency is given for both a 50Ω and an ideal source impedance of 0Ω. However, in different embodiments, the load 128 can have an impedance other than 50Ω, the source impedance may be other than 50Ω or 0Ω, and efficiency may vary and in some embodiments may not be optimal.

### Method

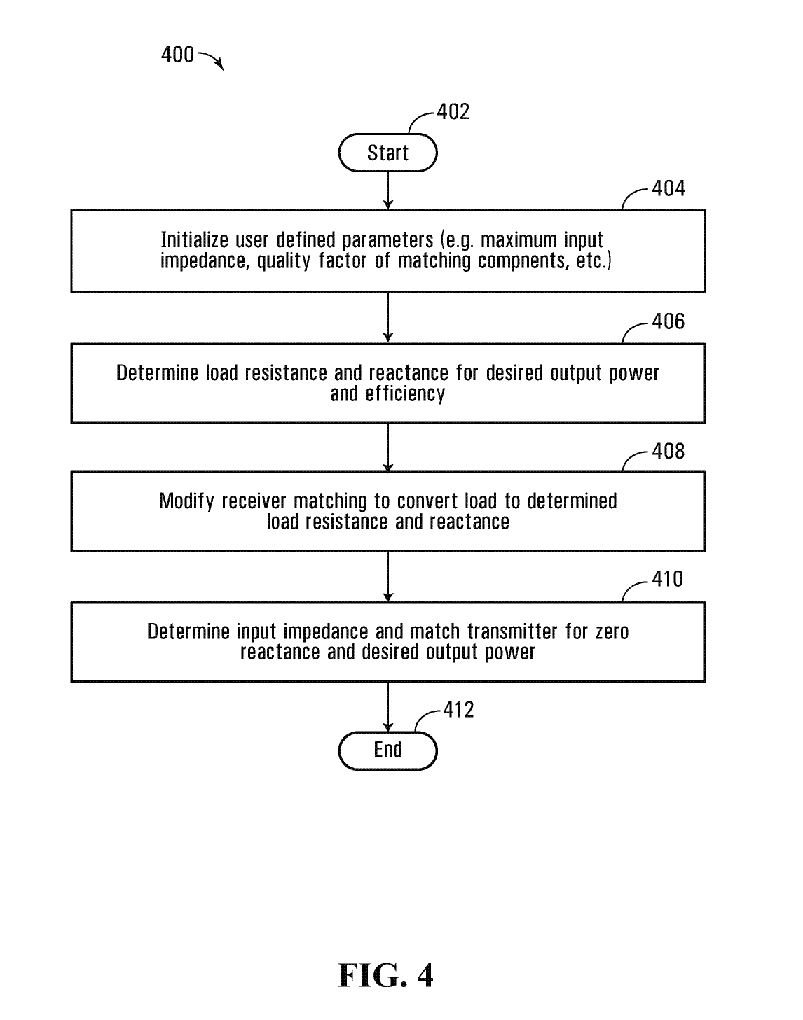

Referring now to FIG. 4, there is shown a method 400 for determining the component values for the transmit side matching network 110 based on desired power to be transferred to the load 128, according to another embodiment. If the input impedance looking into the receive side single-ended resonator 116 from the conducting structure 112 is very high, then there may be a parallel manner of power dissipation from the conducting structure 112 (e.g., radiation or connection to earth ground) that will decrease power transfer efficiency. Consequently, a sufficiently low input impedance is desired looking into the receive side single-ended resonator 116 from the conducting structure 112 and this constraint limits the choice of the impedance of the load 128 and the practically realizable efficiency. However, if the conducting structure 112 is electrically connected in parallel to multiple receivers, this constraint may be relaxed. The method 400 therefore chooses the impedance of the load 128 under the constraint that the input impedance remains below a certain value. In different embodiments (not depicted), the transmit side single-ended resonator 108 may be connected to the conducting structure 112 not just at the first single connection point 114a but at a pair of connection points (not depicted); that is, each of the ends of the resonator 108 may be connected to two different points on the conducting structure 112. In this way, the transmit side single-ended resonator 108 may transform from being connected to the conducting structure 112 via a single-ended connection (as depicted in FIGS. 1 and 2) to a double-ended connection (not depicted). Impedance matching is therefore left to be done at the feed point of the transmit side matching network 110 to the transmit side transmitting coil 106 and not on either of the single-ended resonators 108, 116. In a different embodiment (not depicted), impedance matching can also be done at the input of the receive side single-ended resonator 116.

The method 400 begins at block 402 and proceeds to block 404 where the initial parameters are defined, which include the required impedance of the load 128 to be driven, the output impedance of the power source 102, the receiver-transmitter-coupling link circuit parameters shown in FIG. 2 and the desired frequency of the power source 102. At block 406 the efficiency is determined for varying load impedance to find a selected, and in one embodiment the optimum, load impedance using Equations (4)-(11). At block 408 parameters for the receive side matching network 126 are determined to tune the load 128 to the selected load impedance determined at block 406 at the operating frequency. At block 410, the input impedance looking directly into the receive side single-ended resonator 116 is set to be 400Ω; in alternative embodiments, however, this impedance may be set to a different value (e.g., a value higher than 100Ω and less than 1 kΩ). Also at block 410, the values of the first and second capacitors 118a,b to tune the receive side single-ended resonator 116 to resonance are determined; i.e., the capacitors' 118a,b values are selected so that the receive side single-ended resonator 116 has zero or approximately zero input reactance; an analogous procedure may be performed on the capacitors 120a,b for the transmit side single-ended resonator 108.

In one example embodiment, choosing values for the capacitors 118a,b is performed as follows. The two-port parameters are measured for direct transmission between ports A and B, or A and C, with varying capacitor, or other reactive element, values. The values of the load impedance resulting in a relatively high, and in one embodiment highest, transmission efficiency are determined from these parameters plotted vs. frequency. The input impedance is also determined. The choice of capacitors is based on: (1) a resulting non-reactive input impedance at the frequency of interest with a relatively low resistive impedance, and in one embodiment a resistive impedance that is as low as possible; and (2) a load impedance that results in relatively high efficiency at the frequency of the power source and that is low enough to be easily matched to the required impedance of a realistic load. With a variation of a reasonable number of capacitors in a suitable range to achieve resonance near the operating frequency interpolation is used to optimize the capacitor choice based on these criteria.

Also at block 410, the components used for the transmit side matching network 110 are determined given the input impedance looking directly into the transmit side transmitting coil 106. The choice of matching follows the same procedures known in the field of wireless power transfer. After block 410, the method 400 ends at block 412.

While the method 400 of FIG. 4 is described above in respect of FIG. 1, which uses inductive coupling in both the transmitter and receiver, in different embodiments (not depicted) the method 400 may analogously be applied to embodiments in which inductive coupling is not used to transfer power from the power source 102 to the conducting structure 112.

### Measurement Methods

### Impedance Parameters

Measurements of the S-parameters of the system 100 are performed on a Rohde & Schwarz™ ZVL13 vector network analyzer (“VNA”) following a full two-port Short-Open-Load-Thru (“SOLT”) calibration that accounts for cable losses and phase shifts. The cables are attached to SMA-type RF connectors soldered across the port locations. In investigating the receive side single-ended resonator 116 and receive side receiving coil 122 link the connections are made between test port A and test port B in FIG. 2 with the conducting structure 112, transmit side single-ended resonator 108 and transmit side transmitting coil 106 disconnected. In different embodiments, to investigate the receive link and single conductor transmission together, the conducting structure 112 is re-connected to the receive side single-ended resonator 116 and testing is performed using test port A and test port C. In different embodiments that include the transmit side transmitting coil 106 and single-ended resonator 108, the entire system 100 can be investigated by making connections between test port A and test port D. For the transmit and receive side single-ended resonators 108, 116 and for the conducting structure 112, which in FIG. 2 are shown as each having a floating ground, the RF connector signal line is directly connected to the resonator 108, 116 or structure 112 and the ground is left unconnected, or “floating”. Two-port Z-matrices are determined from the measured S-parameters using conversion formulas known to a person of ordinary skill in the art.

### Efficiency

The output voltage to a 50Ω load is done with the use of a Tektronix™ DPO 710604C oscilloscope. Direct measurement of the input current and voltage are done with a Ct-2 current probe and P6248 differential voltage probe. The voltage signal is applied with a RIGOL DG4102 signal generator, which has a 50Ω source impedance.

### Single Conductor Transmission Modeling

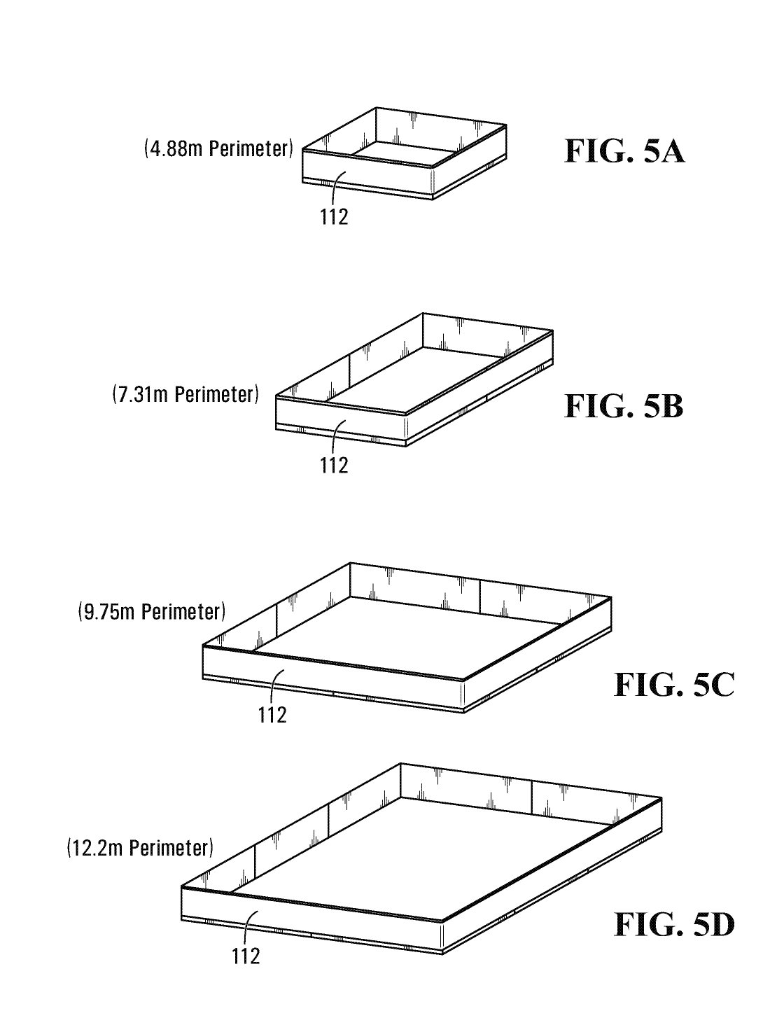

FIGS. 5A-5D show examples of the conducting structure 112 in the form of aluminum foil wrapped in the shape of a box. To increase the length of transmission the box is left open in the middle and the connection to test port C is made at one side of the box and the connection to test port A is made on an opposing side of the box. The perimeter of the box is varied to demonstrate the effect of varying transmission length on the predicted efficiency and input reflections and impedance seen at test port C. Relative to the wavelength of 22.1 m at 13.56 MHz all perimeters represent a significant electrical length. A box with a perimeter of 4.88 m is shown in FIG. 5A, which is close to a quarter wavelength. FIGS. 5B, 5C, and 5D show boxes having perimeters of 7.31 m, 9.75 m, and 12.2 m, respectively.

An equivalent circuit comprising RLC circuits on each of the branches of T-matching network used to model the conducting structure 112 of FIG. 2 is used to model power transmission over a small frequency range of the 4.88 m perimeter box of FIG. 5A. The equivalent circuit model is found from matching the network transmission parameters found for single conductor transmission. The network parameters are found by measuring the two-port parameters with and without the single conductor transmission line and then extracting the contribution of the transmission line to the total two-port parameters. The RLC parameters are found to substantially match the transmission line parameters at the system's 100 resonance frequency of 13.7 MHz and to provide a reasonable match at a slightly higher frequency of 15 MHz under the constraint that the inductor, resistor, and capacitor values cannot be negative.

### Transmission to Multiple Receivers

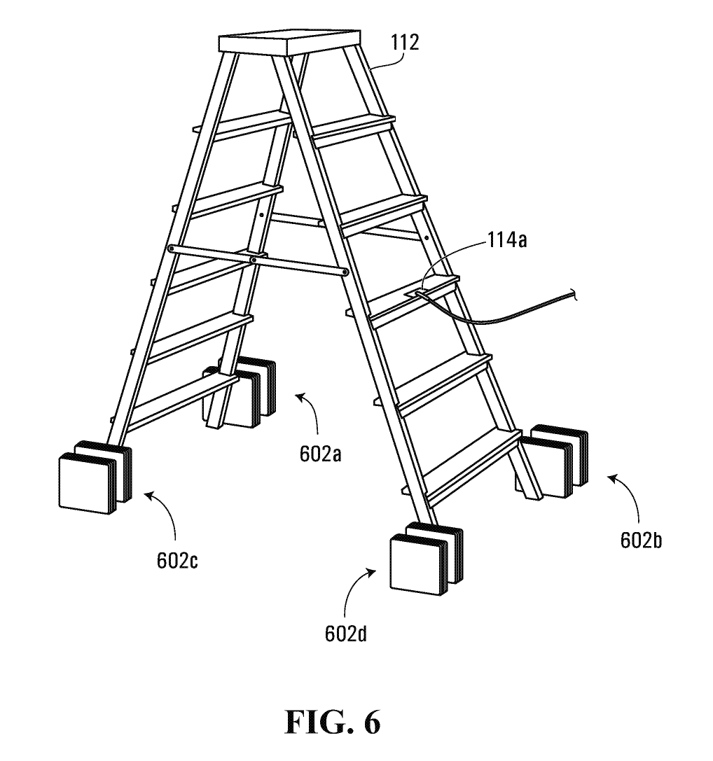

FIG. 6 shows an example of the conducting structure 112 in the form of a substantially metallic ladder; the ladder of FIG. 6 is used to demonstrate the use of the conducting structure 112 as a transmission medium to transmit power from the power source 102 to multiple receivers. Additionally, the use of multiple receivers on an electrically small structure is shown to provide relatively high efficiency. In FIG. 6, four pairs 602a-d of the receive side single-ended resonator 116 and receiving coil 122 are connected to the ladder; two of the pairs 602a,c are connected on either side of one leg of the ladder and the two other pairs 602b,d are connected on either side of the other leg of the ladder.

To study the use of an arbitrarily shaped conductor as the transmission medium for power to multiple receivers, the ladder receives power from the power source 102 via a single ended connection made at the first single ended connection point 114a. One of the four pairs 602a-d of coils is connected at each of the legs of the ladder, and the S-parameter matrix is found by terminating the ports not connected to the VNA with 50Ω loads and measuring the two-port parameters of each. Efficiency and power delivered is calculated as described above. The ladder is electrically small so its connection adds only a small amount of series inductance and resistance and voltage of the AC signal is generally uniformly distributed along it.

### Design Variations

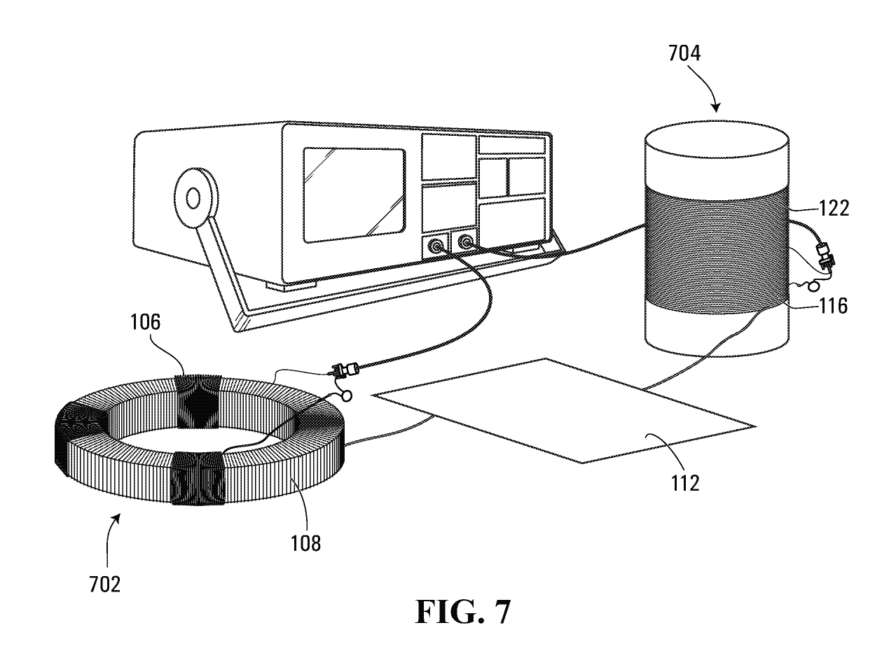

FIG. 7 demonstrates another embodiment of the system 100 in which a ferrite toroid 702 wrapped with 290 turns of wire comprises the transmit side single-ended resonator 108 (24 AWG Polyamide coated magnet wire is used in one embodiment); the toroid 702 wrapped with 142 turns of wire comprises the transmit side transmitting coil 106; an air core solenoid wrapped with 258 turns of wire comprises the receive side single-ended resonator 116; and an air core solenoid wrapped with 30 turns of wire comprises the receive side receiving coil 122. In FIG. 7 the conducting structure 112 is shown as a rectangular piece of foil; however, in different embodiments and as discussed above, the conducting structure 112 may be arbitrarily shaped and, in particular, need not be rectangular. The values of the components used to tune the coils 106, 122 and resonators 108, 116 is determined at an operating frequency of the power source 102 of 500 kHz. The length of both of the resonators 108, 116 is much less than a quarter wavelength, but the use of ferrite material and a large number of turns to increase the inductance per length and inter-winding capacitance reduces the resonance frequency of the resonator/coil pairs. More generally, any one or more of the coils 106, 122 and resonators 108, 116 may be printed on various types of cores, substrates, or boards. For example, in certain embodiments one or more of the coils 106, 122 and resonators 108, 116 may be printed on a dielectric or ferrite board.

### Results

### Fitted Parameters

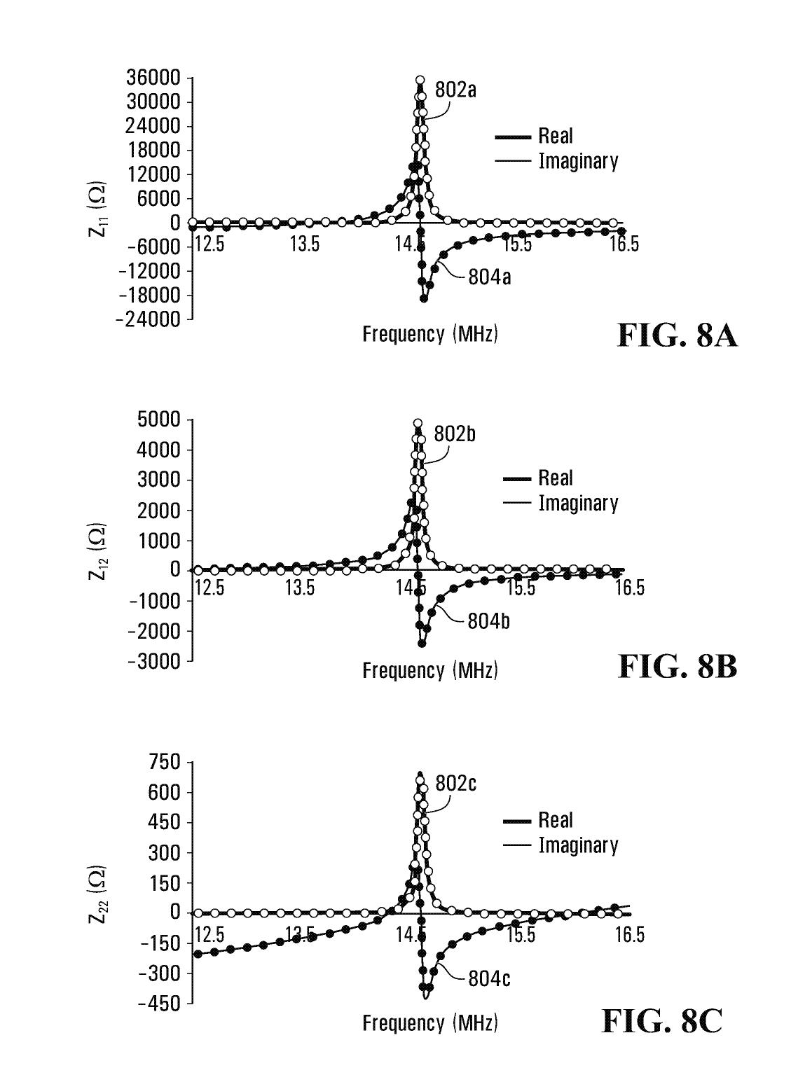

The circuit parameters between test port A and test port B from FIG. 2 measured using the receive side single-ended resonator 116 and receiving coil 122 of FIG. 3 are given in Table 1, below. The receiving coil 122 has two series capacitors (44 pF and 47 pF) that collectively are modeled using the capacitor 124 of FIG. 1, but the fitted equivalent series capacitance is slightly higher because of the influence of the parallel capacitance between windings of the coil 122. The impedance parameters found using the fitted parameters are compared to the measured parameters shown in FIGS. 8A-8C: FIG. 8A shows the measured real (curve 802a) and imaginary (curve 804a) parts of Z₁₁; FIG. 8B shows the measured real (curve 802b) and imaginary (curve 804b) parts of Z₁₂; and FIG. 8C shows the measured real (curve 802c) and imaginary (curve 804c) parts of Z₂₂. The close match between the two strongly indicates the validity of the circuit fitting method, especially for the receive side receiving coil 122, which is a simpler structure than the receive side single-ended resonator 116. The accurate prediction of the perturbation of the receive side receiving coil 122 self-impedance from the presence of the receive side single-ended resonator 116 allows an accurate prediction of the mutual impedance as well, which is predicted to be M_{c2s}_{_}ₚ₂=0.264 μH from the self-impedance fitting and M_{c2s}_{_}ₚ₂=0.233 μH, M_{c2s}_{_}ₛ₂=0.376 μH from the mutual impedance fitting.

TABLE 1
Fitted circuit parameters from measured two-port impedance parameters when the
resonator 116 and coil 122 are 7.62 cm apart.

| | Fitting | | | | | | | | | |
|---|---|---|---|---|---|---|---|---|---|---|
| | Z₁₁ | | | | | Z₂₂ | | | | |
| D | Lₛ₂ | Cₛ₂ | Cₚ₂ | Lₚ₂ | Rₚ₂ | L_{c2s} | C_{c2s} | C_{cp} | R_{c2p} | R_{c2p} |
| (cm) | (μH) | (pF) | (pF) | (μH) | (Ω) | (μH) | (pF) | (pF) | (Ω) | (Ω) |
| 7.62 | 3.69 | 6.40 | 55.0 | 2.16 | 1.10 | 3.04 | 25.8 | 8.45 | 0.25 | 1.09 |

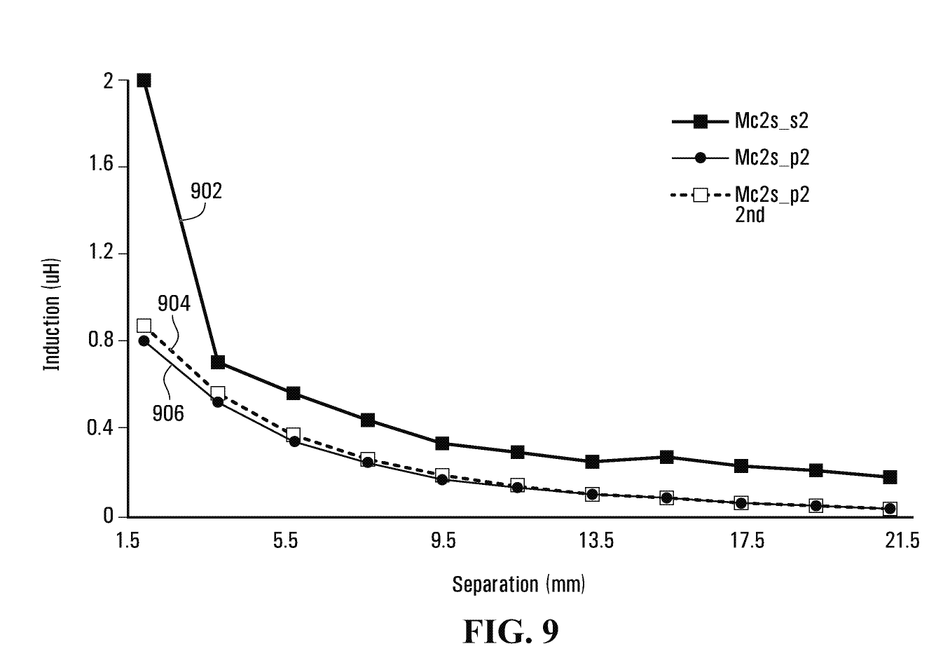

The fitted mutual inductance between the receive side resonator and coil 116, 122 as the distance between them changes is shown in FIG. 9. The mutual inductance is modeled in FIG. 2 and comprises the inductance between the coil inductance L_{c2s}, Lₛ₂ (curve 902) and Lₚ₂ (curve 906). M_{c2s}_{_}ₛ₂ (curve 906) is fitted from the receiver's self-impedance, while M_{c2s}_{_}ₚ₂ (curve 904) is fitted from the mutual impedance.

### Variation of Parameters

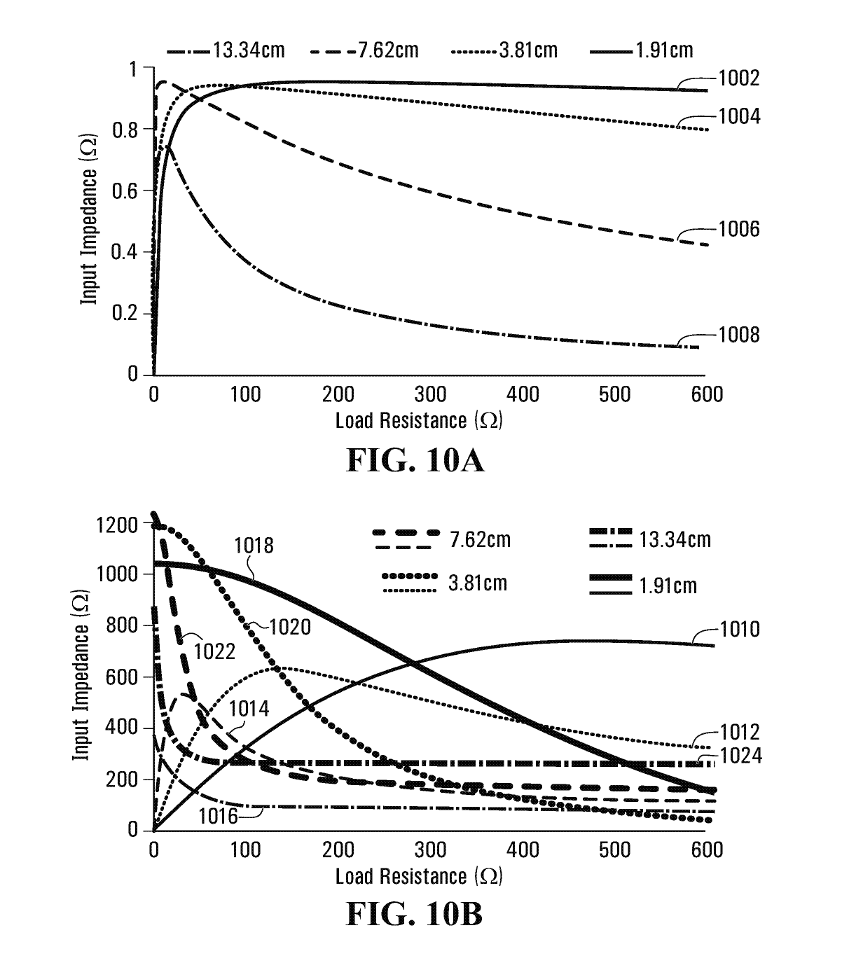

With the measured two-port parameters, the theoretical power efficiency with varying resistance of the load 128 and different spacing between the receive side single-ended resonator 116 and receiving coil 122, assuming zero source resistance, is shown in FIG. 10A (reactance of the load 128 is omitted): efficiency vs. load resistance is graphed for coil spacings of 1.91 cm (curve 1002), 3.81 cm (curve 1004), 13.34 cm (curve 1006), and 7.62 cm (curve 1008). The input resistances and associated series tuning reactance (represented by the capacitor 124 of FIG. 1, which in different embodiments may be combined with or replaced by one or more inductors) graphed against specific load resistances is also shown in FIG. 10B. In FIG. 10B, input impedance vs. load impedance is graphed for coil spacings of 1.91 cm (input resistance is curve 1010; input reactance is curve 1018), 3.81 cm (input resistance is curve 1012; input reactance is curve 1020), 7.62 cm (input resistance is curve 1014; input reactance is curve 1022), and 13.34 cm (input resistance is curve 1016; input reactance is curve 1024). As the spacing between the receive side single-ended resonator 116 and receiving coil 122 is decreased, the range of values for which power can be transferred with relatively high efficiency, the input resistance, and the associated tuning reactance of the receiving coil 122 used to obtain that relatively high efficiency all correspondingly increase as well.

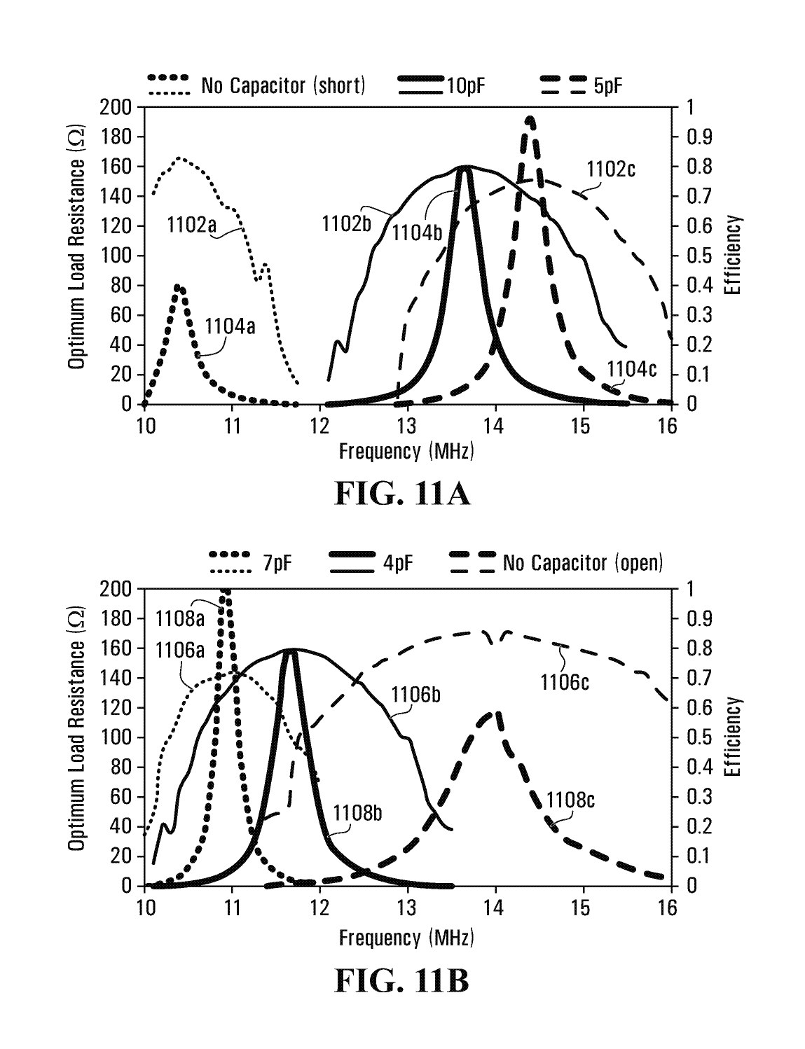

The tuning capacitors 118a,b used to tune the receive side single-ended resonator 116 have a different effect on the resonance frequency and the matching of the resonator 116 and coil 122. The specific change in the load resistance for relatively high efficiency and the efficiency with that load resistance is shown in FIGS. 11A and 11B. FIG. 11A shows the effect of the first capacitor 118a on the efficiency (shown as curves 1102a-c) and the higher, and more optimal, load resistance (shown as curves 1104a-c). FIG. 11B shows the effect of the second capacitor 118b on the efficiency and the more optimal load resistance; curves 1106a-c show the effect of the second capacitor 118b on the efficiency (shown as curves 1106a-c) and the higher, and more optimal, load resistance (shown as curves 1108a-c). In this example embodiment, the relatively optimal efficiency is found under the constraint that the input impedance is less than 400Ω. For this reason, the input impedance of the receive side single-ended resonator 116 ends up being 400Ω for all the values shown since higher efficiency is in fact achieved with higher input impedance. It is observed that in FIG. 11A a larger value for the first capacitor 118a results in a lower resonance frequency and a smaller relatively optimal load resistance. In FIG. 11B a larger value for the second capacitor 118b results in a lower resonance frequency and larger relatively optimal load resistance. Therefore, the modification of one or both of the capacitors 118a,b can be done to target a specific operating frequency, while also allowing some choice of the relatively optimal load impedance at a specific frequency. There is a tradeoff in efficiency that may be necessary to achieve a reasonable resistance of the load 128 that can be further optimized with matching. Additionally the loss present in the capacitors 118a,b means that it may be desirable to use capacitors with relatively low equivalent series resistances, and in some embodiments the lowest possible series resistances.

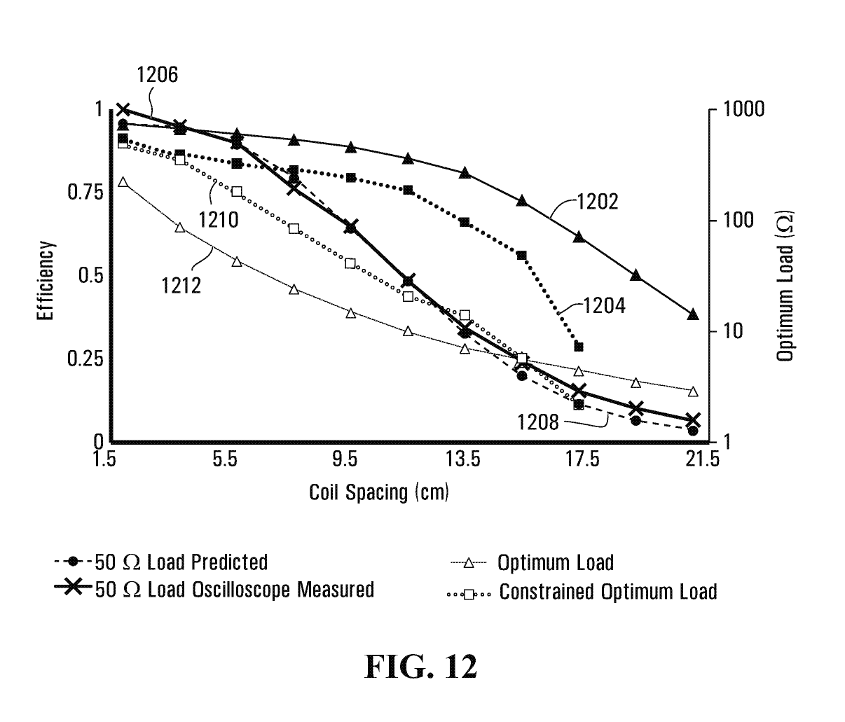

From FIGS. 10A and 10B it can be seen that if the input resistance and reactance are constrained to be below a certain value, in order to obtain a relatively high efficiency the resistance of the load 128 is increased. In the depicted example embodiment, the real input impedance is constrained to be less than 400Ω, and the tuning reactance is constrained to be less than 200Ω. FIG. 12 shows, for one particular example embodiment, a curve 1202 of efficiency derived from impedance parameters with an impedance of the load 128 selected to optimize efficiency and as a curve 1204 of efficiency derived from impedance parameters with a load impedance selected to optimize efficiency and with the input impedance constrained as described above. The efficiency with just a 50Ω load is also shown as curves 1206 (oscilloscope measured) and 1208 (S-parameter predicted). For that particular example embodiment, FIG. 12 also shows a curve 1210 of the optimal load 128 for maximum efficiency without any constraints on the input impedance, and another curve 1212 of the optimal load for maximum efficiency with the above constraints on the input impedance.

### Matching

Assuming that the impedance of the load 128 is matched to a particular, and in some cases optimal, value associated with a specific spacing or mutual impedance between the receive side single-ended resonator 116 and receiving coil 122, there is a significant variation in the efficiency and power transfer as this spacing is varied. Including the receive side matching network 126 to provide a relatively optimal load impedance at 7.62 cm spacing, (83.8+40 jΩ) is ideally achieved with −Zₛᵣ₁−40 jΩ=−Zₛᵣ₂=Zₚᵣ=64.7 jΩ at 13.56 MHz, assuming the load 128 is 50Ω, but typically there exists series resistance and inaccuracies in the capacitors and inductors of the receive side matching network 126 that make exact matching impractical.

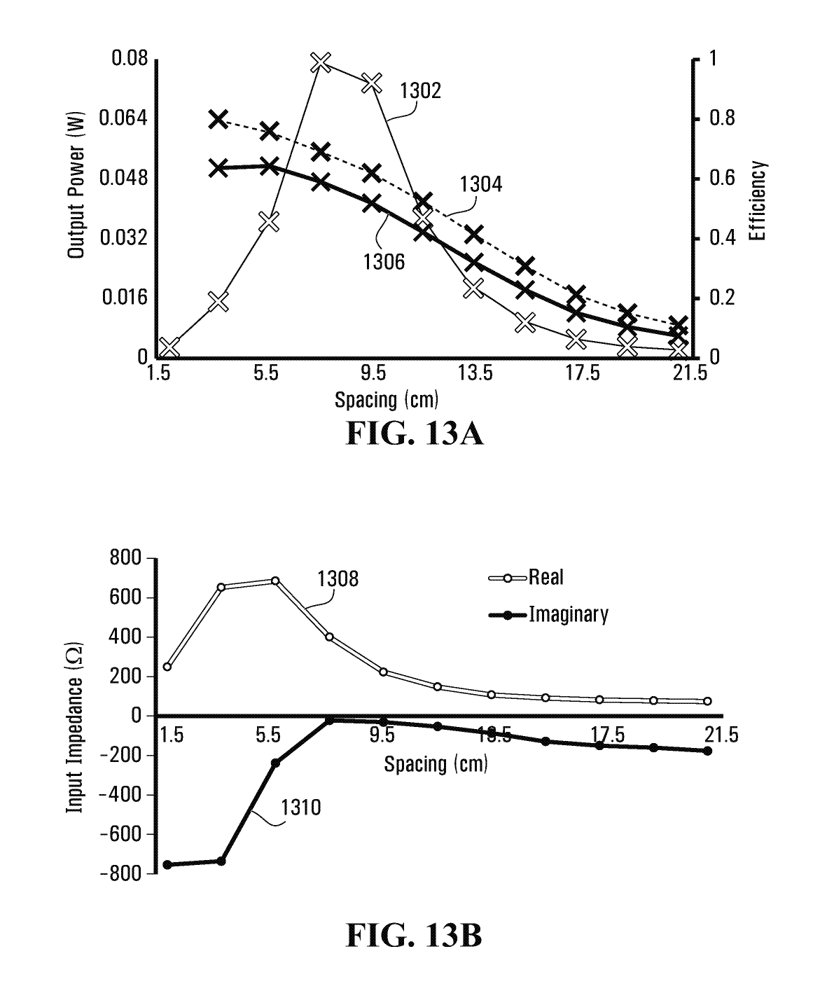

Referring now to FIG. 13A, there are shown graphs of measured efficiency and power delivered to the load 128 when the load impedance is 50Ω: one curve 1302 is of power, while the other curves 1304, 1306 are of efficiency. FIG. 13B shows the real (curve 1308) and imaginary (curve 1310) input impedances determined from the measured two-port parameters when the transmitter matching network 110 is added.

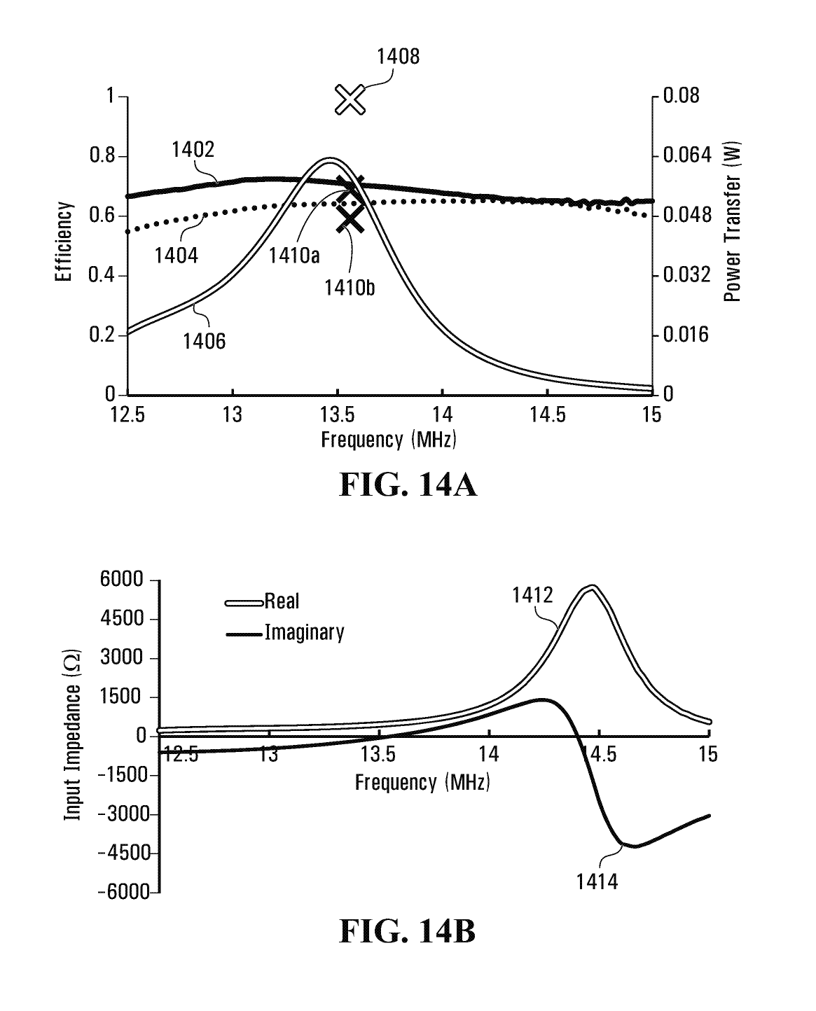

A transmitting tuning inductance of 2.7 μH (not depicted) is also included. The predicted efficiency and power delivered to the 50Ω load 128 is shown in FIG. 13A as spacing is varied. The input impedance as spacing is varied is shown in FIG. 13B. The efficiency and power delivered to the load 128 of 50Ω predicted from the measured two-port parameters with this receive side matching network 126 added is shown in FIG. 14A. In FIG. 14A, one curve 1404 represents efficiency vs. frequency with power lost in the 50Ω source impedance while another curve 1402 represents efficiency vs. frequency without power lost in that source impedance. A third curve 1406 represents power transferred vs. frequency, in Watts. Markers 1410a,b represent directly measured efficiency at a frequency of 13.56 MHz, while another marker 1408 represents directly measured power transfer at 13.56 MHz.

FIG. 14B shows the real (curve 1412) and imaginary (curve 1414) parts of the input impedance vs. frequency. Compared to the predicted values in FIGS. 13A and 13B the efficiency and power delivered is slightly lower, while the input resistance is higher (480Ω) due to losses and variations in inductances and capacitances in one or both of the receive side matching network 126 and capacitors 118a,b.

### Single Conductor Transmission Line

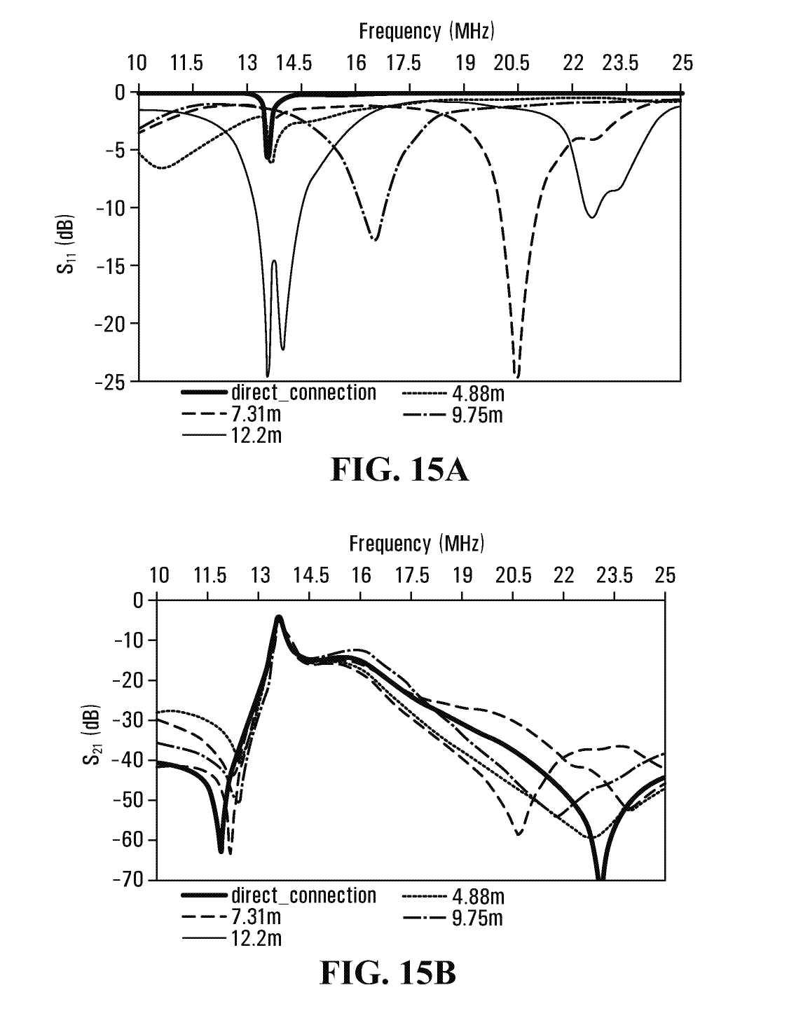

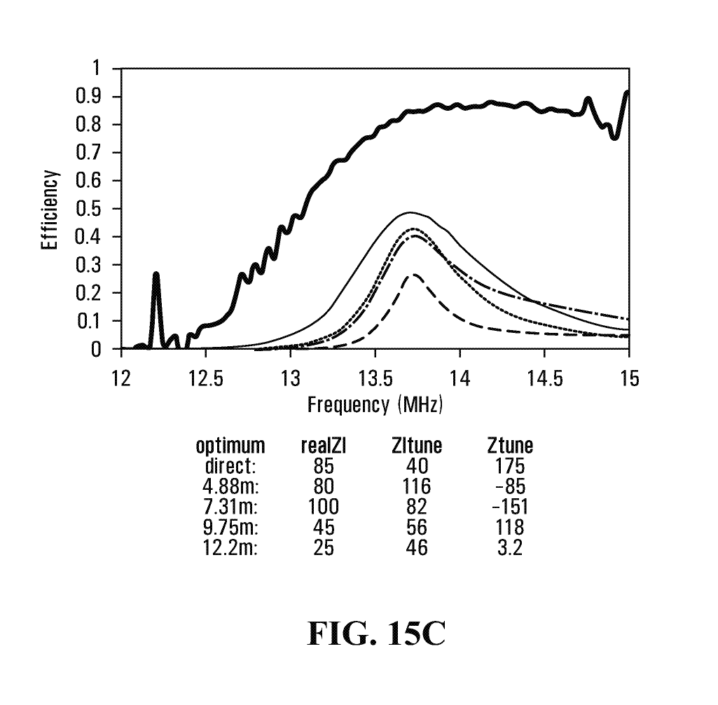

The boxes of FIG. 5 used in some example embodiments as the conducting structure 112 have multiple resonances in the frequency range around 13.56 MHz. The measured reflection coefficient with a single receiver on the end of the box is shown in FIG. 15A for various box perimeters. Dips in the reflection coefficient indicate resonances on the structure 112; from FIG. 15A it can be seen the dip/resonance due to the receiver remains at approximately the same frequency (13.7 MHz) even though the perimeter of the structure 112 connected to it changes. The transmission coefficient for the boxes is shown in FIG. 15B where the transmission coefficient can be seen to remain stable at the resonance frequency of the receiver despite changing box perimeters. This shows that the system of 100 can operate at the same frequency despite changes in the geometry of the conducting structure 112 used as the single conductor transmission line.

For one particular embodiment, the efficiency optimized for 13.72 MHz as the perimeter of the box is changed is shown in FIG. 15C. It is shown that the achievable efficiency is reduced as the conducting structure 112 increases in size. The optimized load 128 is also listed below FIG. 15C and it is shown that the real and imaginary parts of the load 128 change.

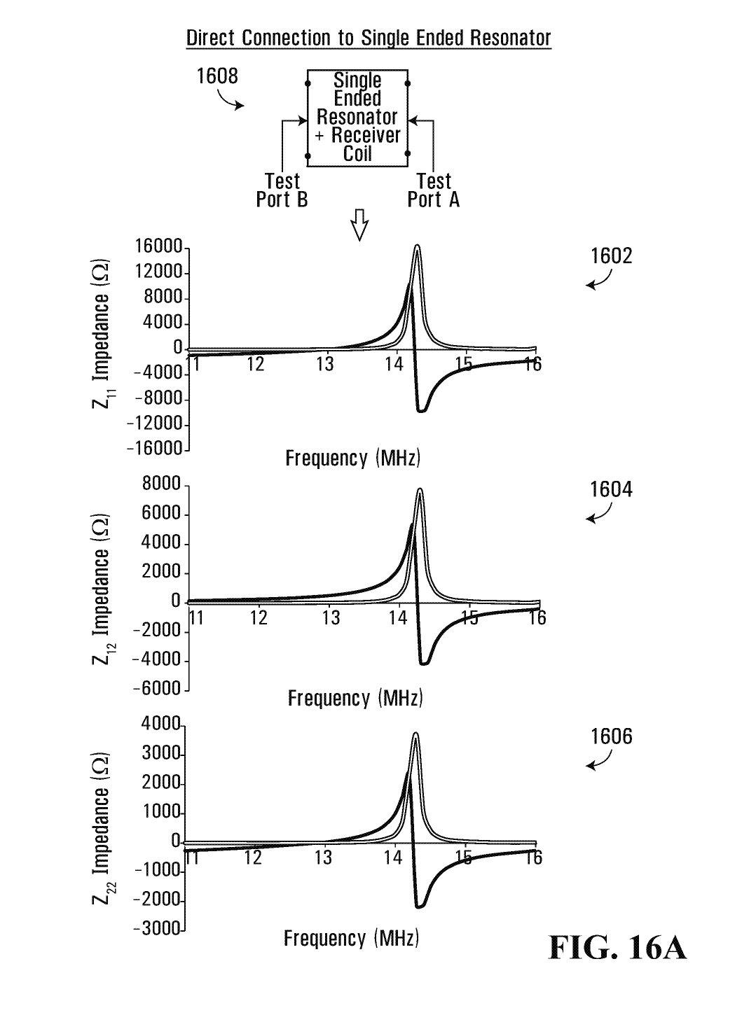

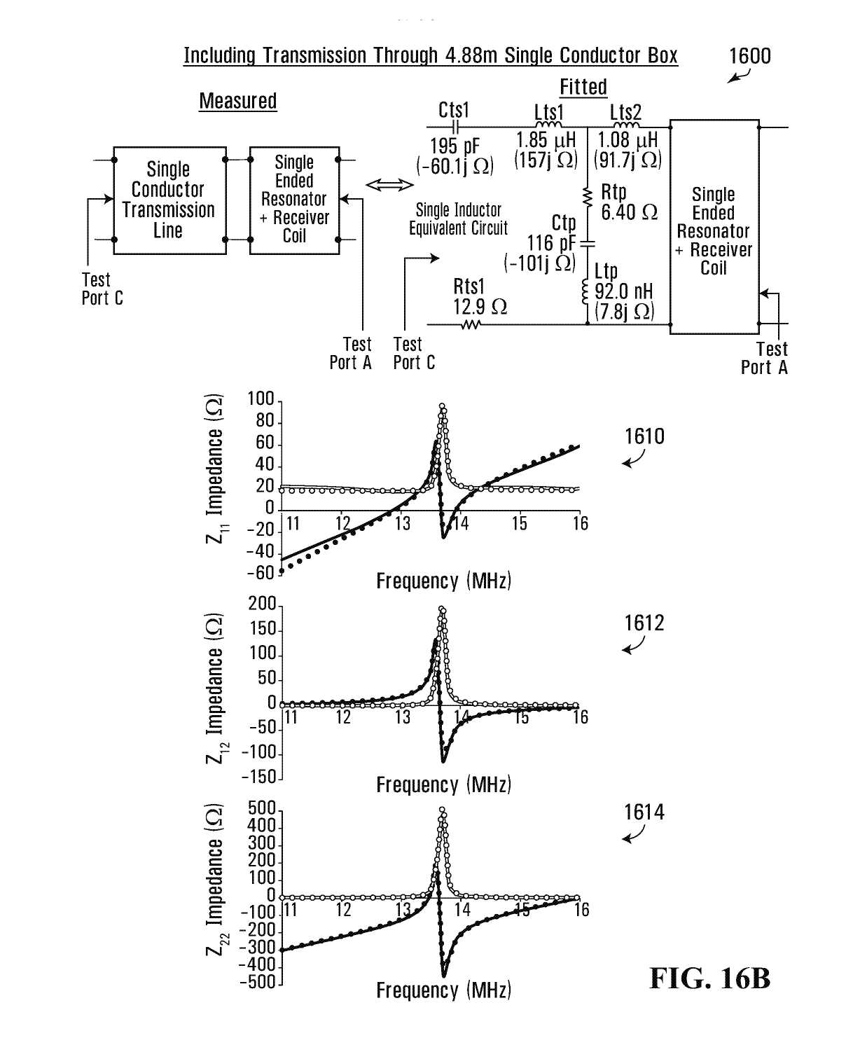

FIGS. 16A and 16B demonstrate the effect of the single conductor transmission line on the impedance parameters more clearly. The left column shows the measuring of impedance parameters directly between test port A and test port B as shown in one schematic 1608, while the right column shows the impedance parameters between test port A and test port C as shown in another schematic 1600 with a 4.88 m perimeter box of the type shown in FIGS. 5A-5D.

The impedance parameters predicted using the equivalent circuit model parameters shown in the schematic 1600 are shown with the dotted lines in graphs 1610, 1612, 1614 of FIGS. 16A and 16B, while the impedance parameters measured without the single conductor transmission line using test ports A and B of the schematic 1608 are shown in solid lines in graphs 1602, 1604, 1606. The mutual impedance and the self-impedance from test port A is almost exactly matched with the schematic 1600, while the input impedance seen at test port C is closely, but not exactly matched.

In the schematic 1600, loss along the single conductor transmission line, which comprises the conducting structure 112 but also includes, for example, cables and connectors electrically coupling the transmit side single-ended resonator 108 and receive side single-ended resonator 116 to the structure 112, is modeled by the resistors. The reactive portions of the schematic 1600 model the frequency dependence of the impedance parameters, which can be seen visibly to completely change the impedance parameters of the left column. The large resonance point is damped. Since the conducting structure is 4.88 m, close to a quarter of the 22.1 m wavelength, the single conductor structure has reactance values close to that of a quarter wavelength transmission line equivalent. The transmission line equivalent would have a characteristic impedance of near 92Ω in this particular case at the 13.7 MHz resonance frequency of the system 100.

### Transmission Through the Conducting Structure 112

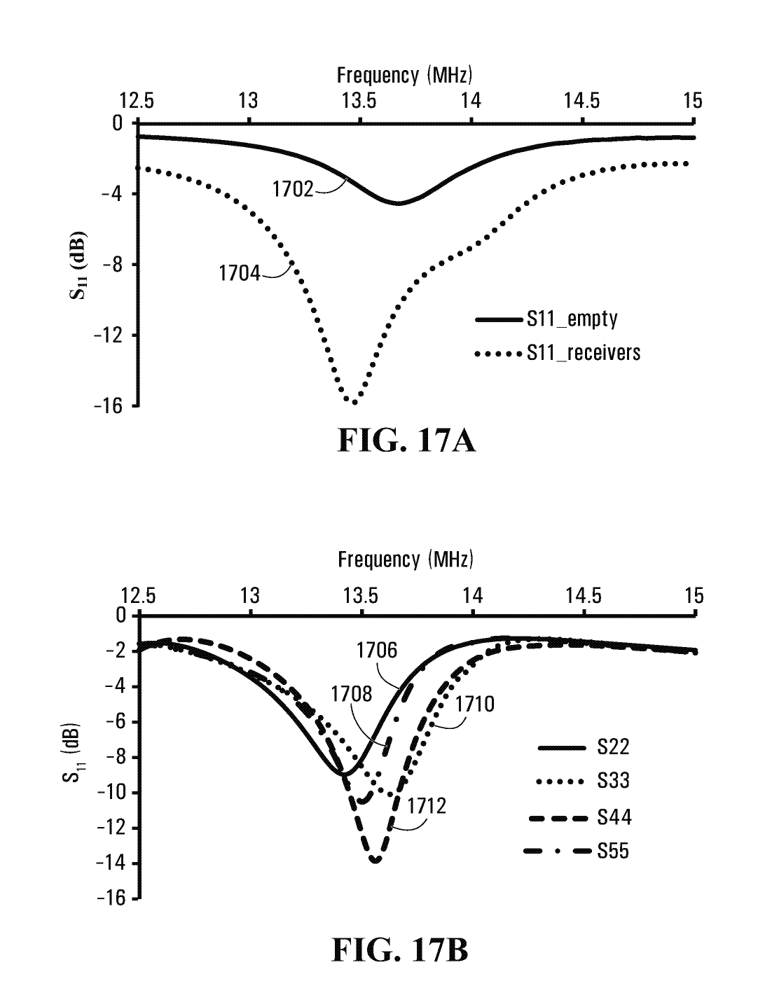

The ladder of FIG. 6 is electrically small at 13.56 MHz, provides multiple points of electrical contact, and represents the general shape of many larger sized metallic structures, such as oil rigs and bridges. The reflection coefficient of the ladder is given in FIGS. 17A and 17B when the ladder is connected with or without the receivers. In FIG. 17A, one curve 1704 is the measured reflection coefficient of transmission to the ladder with four of the receive side single-ended resonators 116 and receiving coils 122 attached and when operating at resonance, while another curve 1702 is the measured reflection coefficient without any of the resonators 116 and receiving coils 122 attached. In FIG. 17B, curves 1706, 1708, 1710, 1712 are measured reflection coefficients of the ladder with the receive side single-ended resonators 116 and receiving coils 122 at each of the four legs of the ladder. The network analyzer used to obtain the measurements is connected at the SMA connector 304 of the receiving coils 122.

The connection to the ladder does not represent an open circuit, or mainly capacitive load, as it would with a very electrically short dipole; this reinforces the desire to keep the receiver input impedances as low as possible to reduce the effect of power lost by other means, such as radiation or transmission to surface waves along the earth. Second, the addition of the receivers significantly changes the reflection coefficient and the combination of the transmission through the ladder and receivers results in a relatively low reflection loss, and one that is close to a 50Ω match. This is not necessary for the power transmission to occur efficiently, but is a result of combining the input impedances of the receive side single-ended resonators 116 and receiving coils 122 in parallel (≈400-500Ω each) with the transmission line of the ladder and tuning to achieve a completely resistive load. As the receivers are designed to be relatively highly efficient when terminated in a 50Ω load this is nearly equivalent to providing a match at the receiver end and their reflections are also low (≈−10 dB). Tuning of the coils 302 is provided with 2.7 μH series inductors.

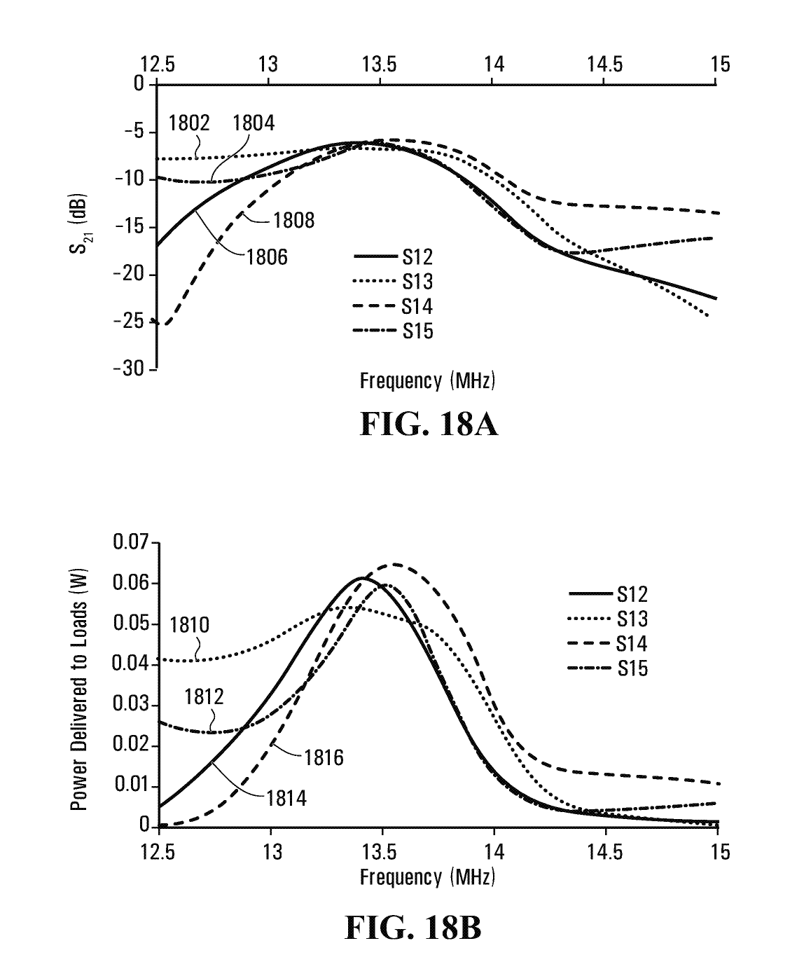

FIG. 18A shows curves 1802, 1804, 1806, 1808 of the transmission coefficient (S₂₁) from the receive side single-ended resonator 116 to each of the loads 128 when each of the loads 128 is 50Ω. At the resonance frequency they achieve approximately equal transmission that is also close to the maximally achievable S₂₁ for a one-to-four equal power divider of −6 dB, which reflects the relatively high power transfer efficiency.

The power that would be transmitted to the loads 128 with 20 V peak-to-peak power source (and 50Ω source impedance) based on the calculated impedance parameters and Equations (4)-(10) is shown using the curves 1810, 1812, 1814, 1816 of the transmission coefficients vs. frequency of FIG. 18B. Since the power delivered to the four receivers is nearly equal and they are mostly identical (except for standard variations in the lumped capacitor values and the windings), it is reasonable to assume a uniform voltage distribution on the ladder. Additionally, connection to different parts of the ladder does not empirically significantly alter the transmission to the receivers.

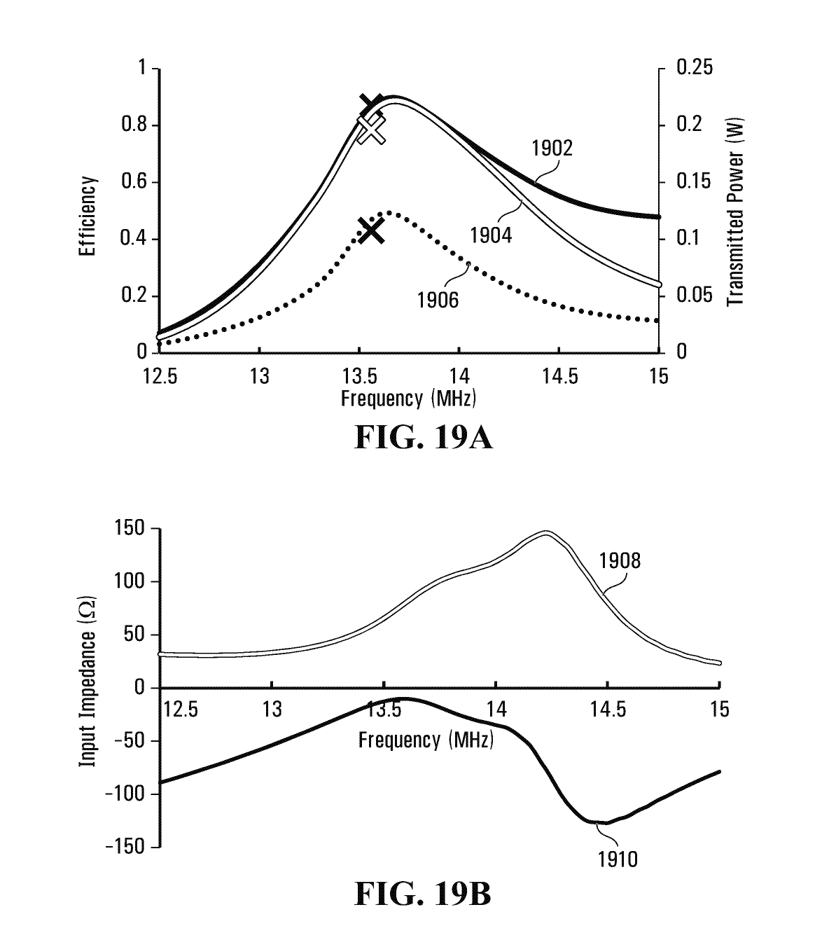

From the impedance parameters, the total efficiency and power delivered to all of the loads 128 is determined and shown in FIG. 19A: one curve 1906 shows efficiency vs. frequency with power lost in the 50Ω source impedance while another curve 1902 shows efficiency vs. frequency without power lost in the 50Ω source impedance. A third curve 1904 shows power transferred vs. frequency. The uppermost and lowermost “X” markers show efficiency directly measured at 13.56 MHz, while the middle “X” marker shows power delivered directly measured at 13.56 MHz.

The power delivered is the sum of all the power to all the loads 128 shown in FIG. 19B, but the determined efficiency is found to be relatively high, showing that there is relatively little power lost in the ladder; this would not be the case unless the parallel combined impedance of all the receivers were low enough that alternate power dissipation methods (e.g., radiation and alternate current paths to ground) are circumvented. The total determined input impedance is also shown in FIG. 19B, with one curve 1908 showing the real part of the impedance and another curve 1910 showing the imaginary part of the impedance, showing that resonance is nearly achieved at 13.56 MHz.

### Variations on Design

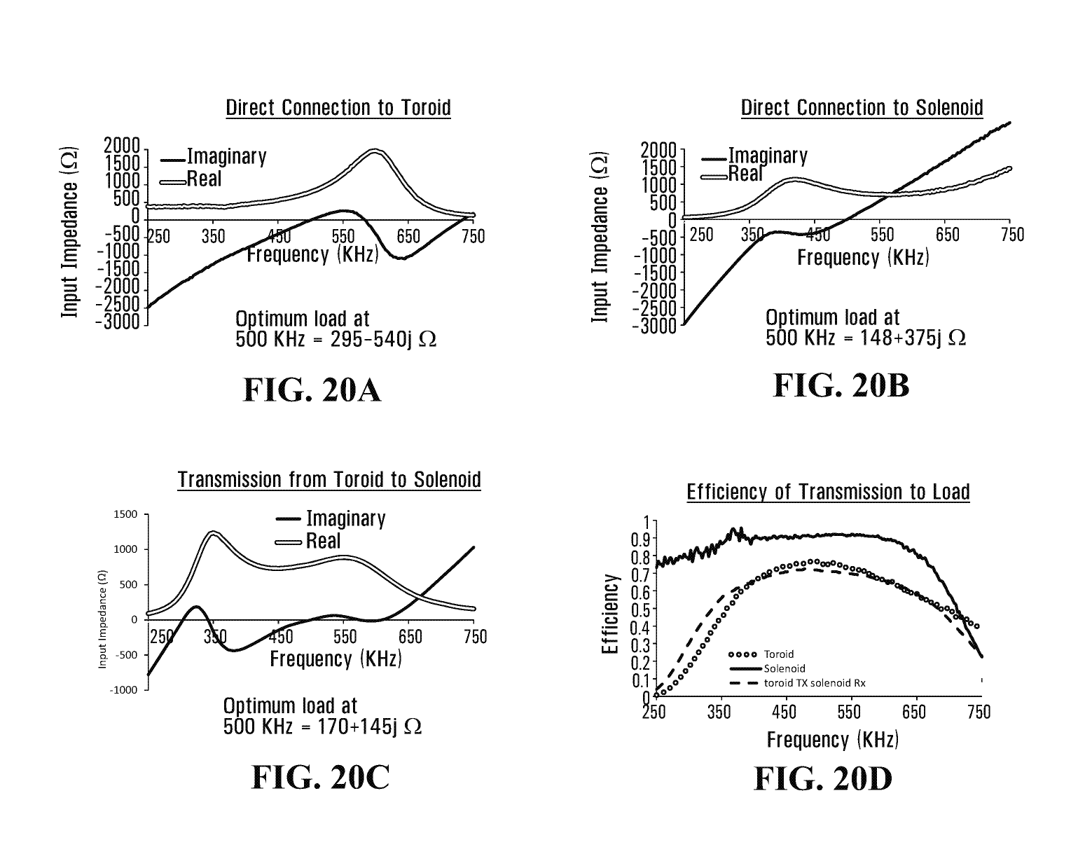

Some of the characteristics of transmission between two possible embodiments of the receive side single-ended resonator 116 and receive side receiving coil 122 are demonstrated in FIGS. 20A-20D. When the resonator 116 comprises the ferrite toroid 702, the input impedance when transmitting directly to the toroid 702 as if connecting between test port B and test port C in FIG. 2 is shown in FIG. 20A at an operating frequency of 500 kHz and load impedance of 295-540 jΩ. Likewise, the input impedance when transmitting directly to the air core solenoid of FIG. 7 is shown in FIG. 20B. The input impedance when connecting at test port A and test port D as shown in FIG. 7, where the transmission is over a small piece of aluminum foil, is shown in FIG. 20C.

FIG. 20D shows the predicted efficiency of the three different examples of FIGS. 20A-20C. Since the toroid 702 permits relatively high efficiency transmission, the overall efficiency of the system 100 comprising the transmit side single-ended resonator 108, transmit side transmitting coil 106, receive side single-ended resonator 116, and receive side receiving coil 122 remains close to that as if just the air core solenoid receiver of FIG. 7 were used. Using the transmit side single-ended resonator 108 and the transmit side transmitting coil 106 helps facilitate single-to-double ended conversion between the power source 102 and the conducting structure 112 on the transmit side and helps provide a relatively highly inductive output impedance for the conducting structure 112 to mitigate a potentially highly capacitive input impedance of the receiver side single-ended resonator 116.

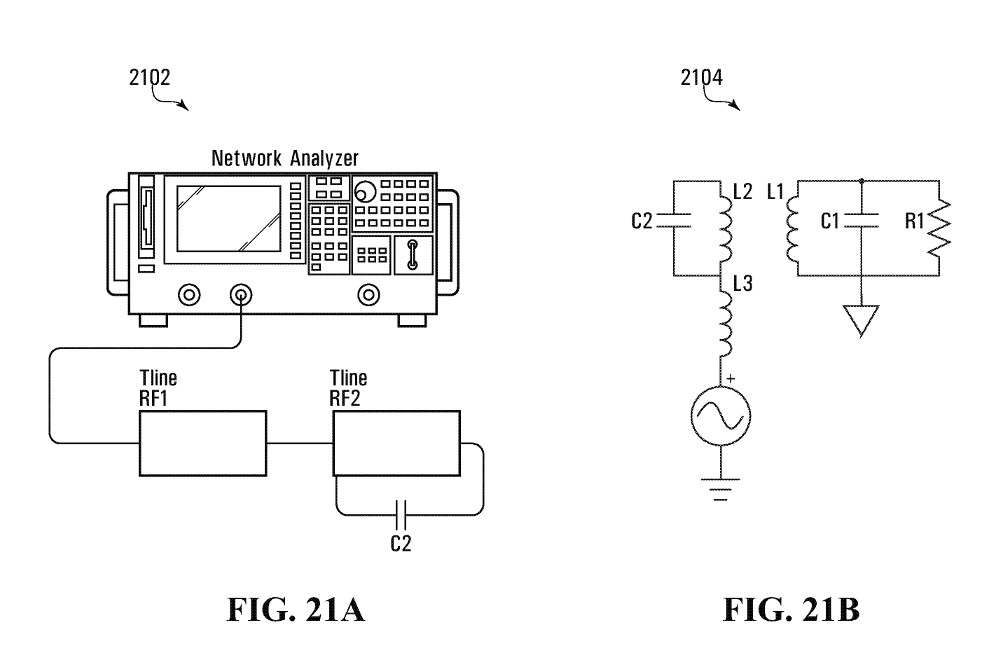

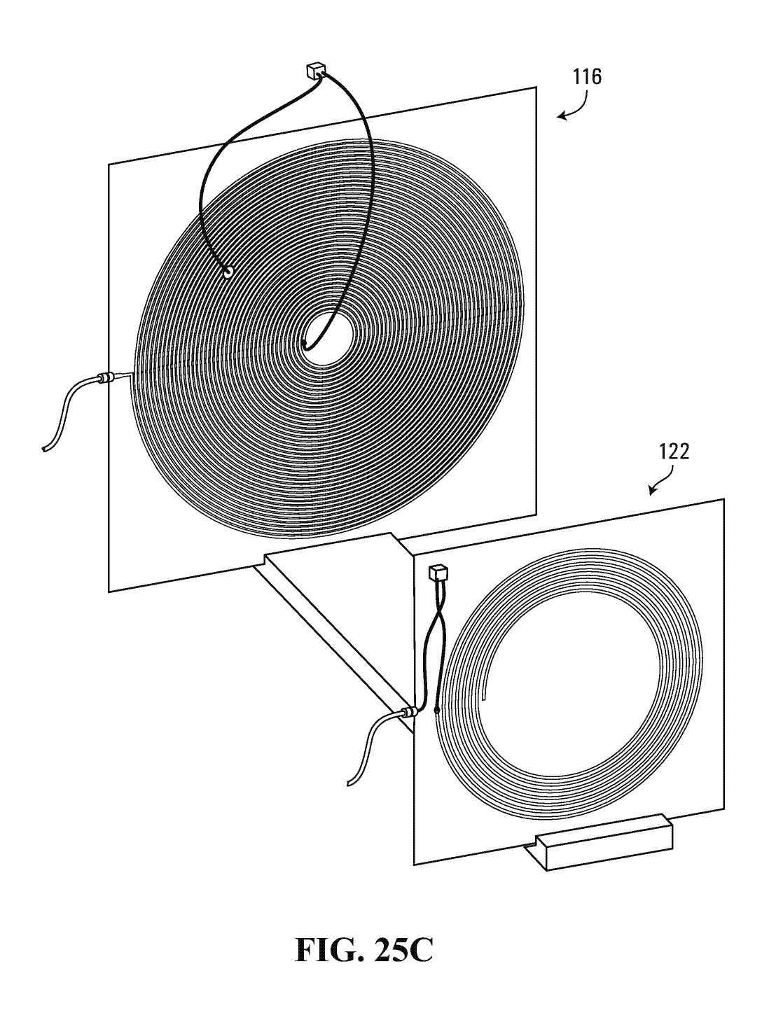

In one example embodiment, one or more of the transmit side transmitting coil 106, transmit side single-ended resonator 108, receive side single-ended resonator 116, and receive side receiving coil 122 comprise a spiral structure and, more particularly, a substantially planar spiral structure as shown in FIGS. 25A-25C. In FIGS. 25A-25C, the receive side single-ended resonator 116 comprises the substantially planar spiral. The spiral is electrically shortened by the second capacitor 118b connected in parallel between the second end of the resonator 116 and another location along the length of the resonator 116. The length of the receive side single-ended resonator 116 is related to the operating frequency of the power source using Equation (11):

$$\frac{λ}{2} = \frac{c}{{f}_{r} \times 2 \times \sqrt{{ɛ}_{eff}}} , \qquad ( 11 )$$

where ε_{eff} is the effective permittivity, c and fᵣ are the speed of light and the resonance frequency respectively. FIGS. 21A and 21B show the schematic 2102 of the receive side single-ended resonator and the lumped element model 2104 for the system 100 with a single wire adjustable operational frequency. Transmission line RF1 in the schematic 2102 is represented by lumped components L1, C1, and R1 in the model 2104, while transmission line RF2 and capacitor C2 in the schematic are represented by components L2, L3 and C2 in the model 2104.

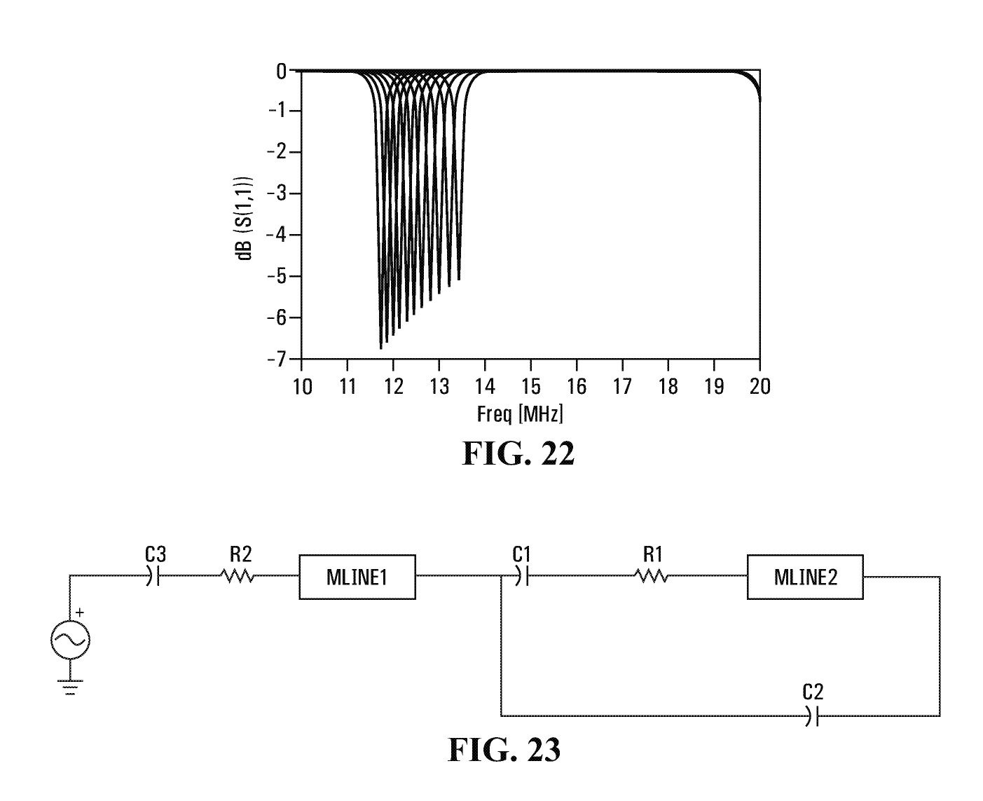

L2 and L3 of the model 2104 represent the receive side single-ended resonator 116, which has a physical length of 7.9 m resulting in a phase shift of 180° between its two ends. A standing wave is imposed along the single-ended resonator 116 at 13.5 MHz. In conventional structures, matching circuits are used to match the resonance frequency and the impedance to the power source 102; however, in the single wire structure of the depicted example embodiment, as there is no electrical return path to ground a matching circuit is not used to adjust the resonance frequency of the single-ended resonator 116 to adjust power transfer efficiency. Instead, a standing node at the second end, which is open, of the single-ended resonator 116 is used as a virtual ground and the second capacitor 118b, which is variable and which is connected as shown in FIGS. 21A and 21B, uses the common node of the standing wave as a ground. The operational frequency of the power source 102 can be controlled to keep the efficiency relatively high if the distance between the single-ended resonator 116 and receiving coil 122 changes. Using this technique enables tunability of the planar coil without extra wire or a non-virtual ground. Electromagnetic moment (EM) simulation of the reflection coefficient for the single wire, open-ended tunable single wire power transmitter as represented by the receive side single-ended resonator 116 is shown in FIG. 22.

In addition to the frequency tuning using the second capacitor 118b, which helps to adjust the resonant frequency to increase efficiency while distance between the single-ended resonator 116 and receiving coil 122 increases, the resistance of the load 128 at that tuned resonant frequency can be modified using the receive side matching network 126 to increase efficiency and, consequently, output power. In this embodiment, the matching network 126 again is connected to the open end of the resonator 116. FIG. 23 shows the schematic of the resonator 116 with three capacitors in which C₁ comprises the receive side matching network 126 and is used for matching, C₂ comprises the second capacitor 118b and is used for tuning the resonant frequency of the resonator 116, and C₃ is used for coupling to the power source 102. In this embodiment, the receive side single-ended resonator 116 is divided into two segments (MLINE1, MLINE2), improving S11.

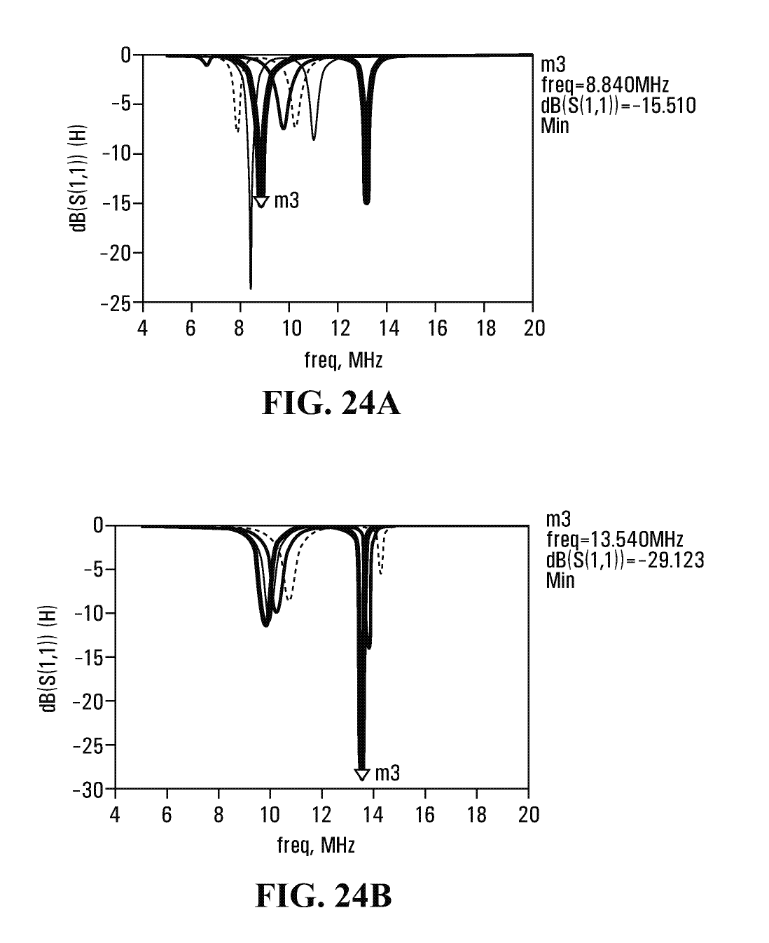

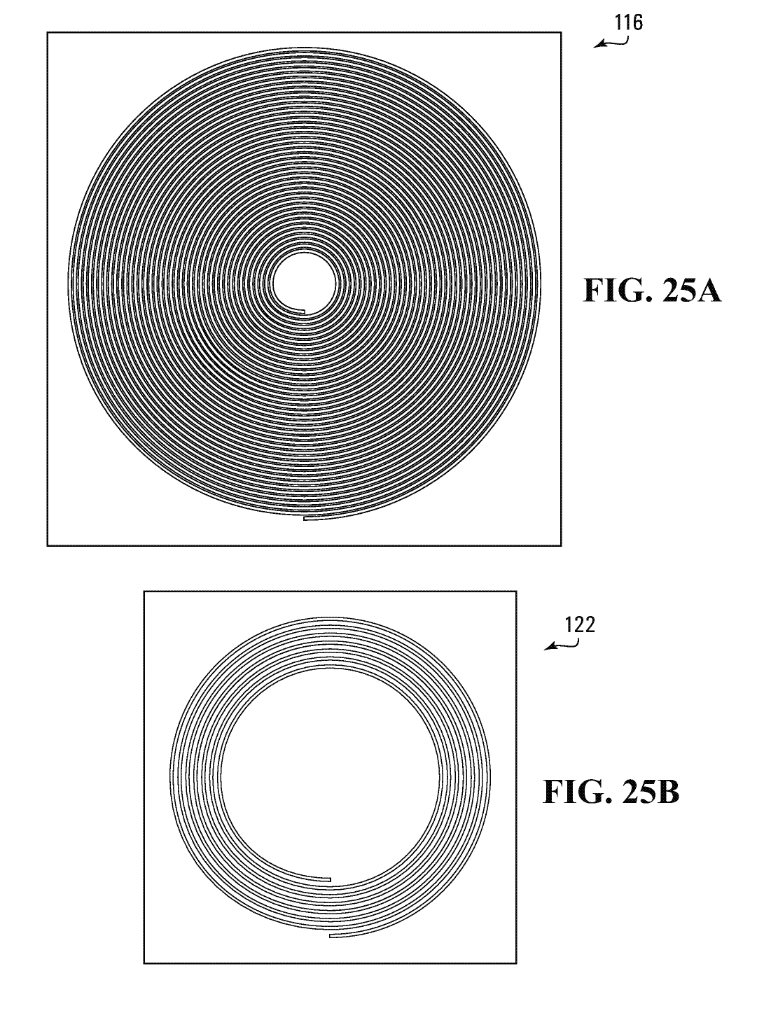

C1, which is a variable capacitor in this example embodiment, is adjusted to keep S11 well below −10 dB at resonance while the distance between the resonator 116 and receiving coil 122 varies. Simulation results for the system 100 with matching and resonance-tuning techniques is presented in FIGS. 24A and 24B, which indicate that by changing the values of C₁ and C₂ the system 100 can match its output impedance to the load 128 and tune the resonant frequency in response to varying distance between the resonator 116 and receiving coil 122, in order to keep the efficiency of the system 100 relatively high.

### Measured Results and Discussion

The proposed open-ended coil structure was implemented on a Rogers™ 5880 Duroid substrate with a thickness of 0.79 mm and permittivity of 2.2+/−0.02. The copper used for the coil itself has a thickness and conductivity of 35 μm and 5.8 MS/m, respectively. The coil geometry is realized with a wet chemical etching process on one side of the substrate. The system 100 has an open-ended tunable coplanar coil for the receive side single-ended resonator 116 and an LC resonator as the receive side receiving coil 122, which is couple to the load 128 of 50Ω. Both the resonator 116 and receiving coil 122 resonators were tuned to 13.5 MHz with a separation of 10 cm. FIG. 25C shows the experimental setup for this example embodiment of the system 100.

Table 1, below lists do (outer diameter), di (inner diameter), and the number of turns for the receive side single-ended resonator 116 and receiving coil 122 shown in FIGS. 25A-25C:

TABLE 1
Specification of the Coils

| Parameter | Tx | Rx |
|---|---|---|
| d₀ (mm) | 153.30 | 91.40 |
| dᵢ (mm) | 20 | 40 |
| n (turns) | 48 | 9 |

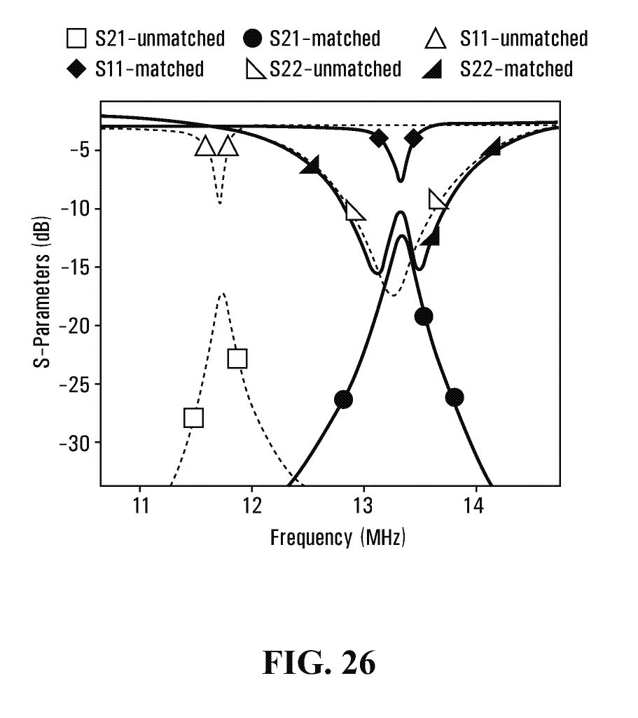

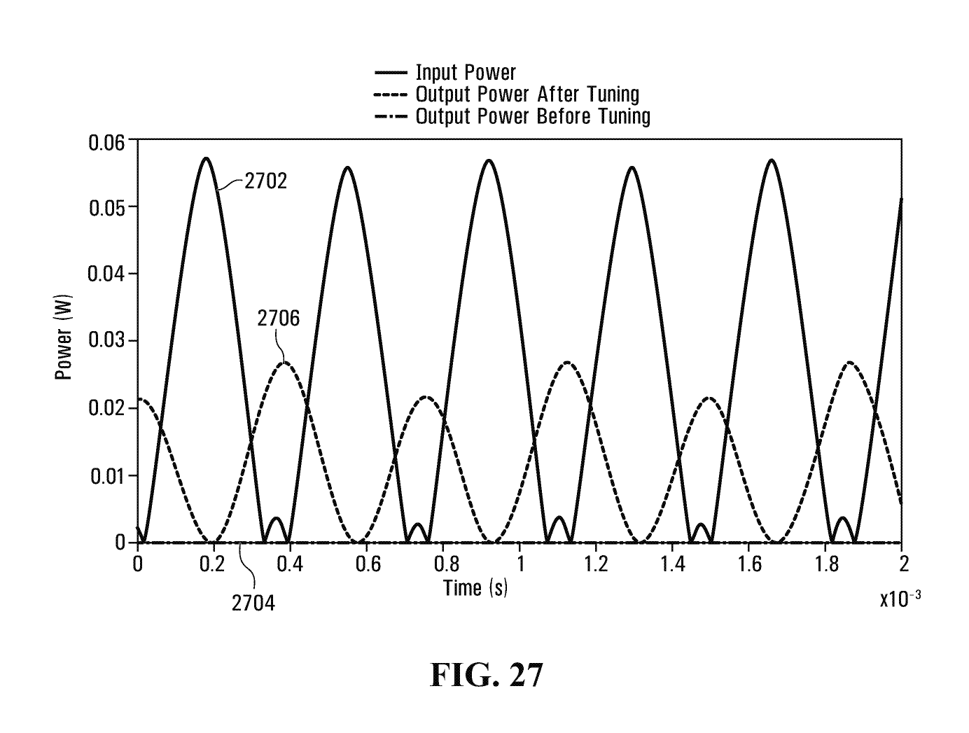

This embodiment of the system 100 is tested by measuring S-parameters with an Agilent™ VNA (Vector Network Analyzer). FIG. 26 shows the measured S-parameters of the tunable receive side single-ended resonator 116 for different values of the second capacitor 118b, which is used for tuning. As shown in FIGS. 24A and 24B, the common resonance frequency of the single-ended resonator 116 and the receiving coil 122, which is set at 13.5 MHz in this example embodiment, is varied by changing the distance between the resonator 116 and the receive coil 122. The whole system has a relatively poor S₂₁ performance when the tuning capacitance is left unchanged despite a change in distance between the single-ended resonator 116 and coil 122. However, by adjusting the resonance frequency of the single-ended resonator 116 maintain a resonance frequency of 13.5 MHz in real-time as the distance between the resonator 116 and coil 122 changes, the system 100 can operate at relatively high efficiency and consequently shows a −5 dB improvement of S₂₁ as a result of this real-time tuning. This is shown in FIG. 27, which includes one curve 2702 of input power, another curve 2704 of output power before real-time tuning, and a third curve 2706 of output power after real-time tuning, with the third curve 2706 clearly showing greater output power than the second curve 2704.

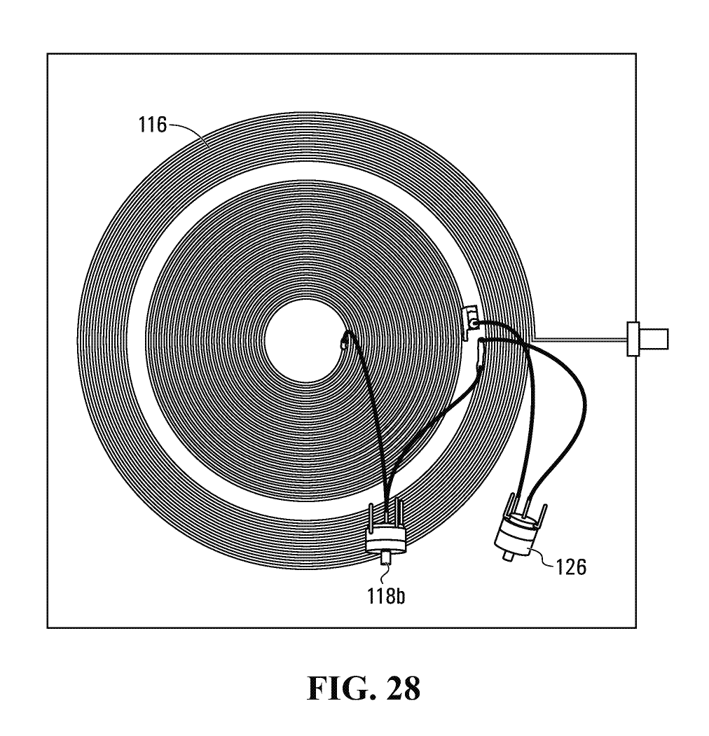

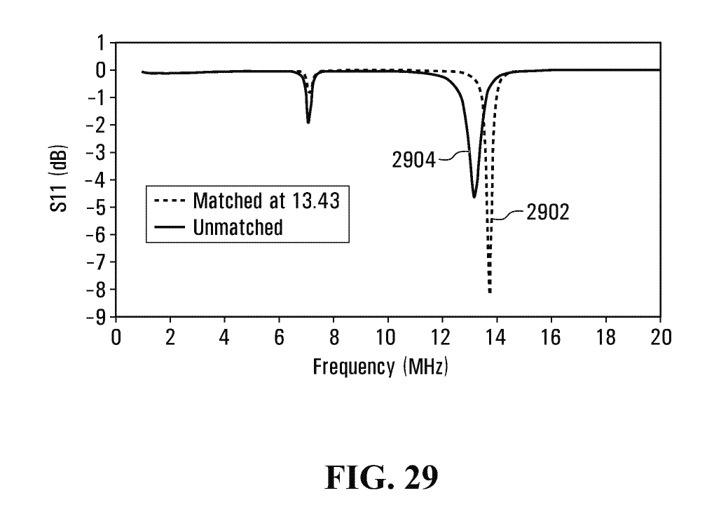

FIG. 28 shows the fabricated receive side single-ended resonator 116 with a matching circuit (the receive side matching network 126) and resonance tuning circuit (the second capacitor 118b). Measurement results showing the effect of the matching network 126 are presented in FIG. 29. One curve 2902 shows S₁₁ when the matching network 126 is selected to permit matching at 13.63 MHz while another curve 2904 shows S₁₁ for an unmatched load.

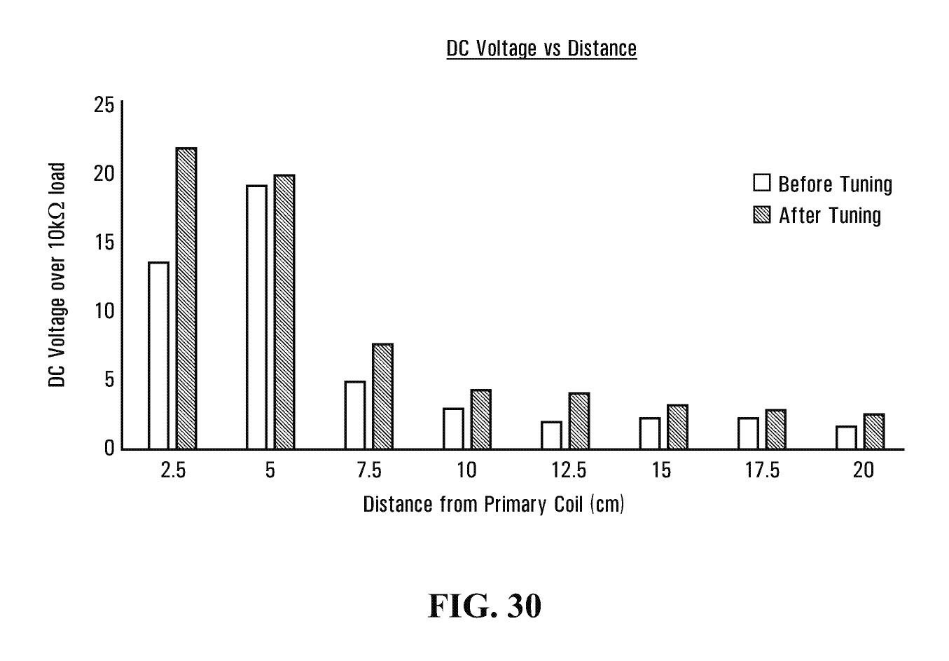

In this example embodiment RF to DC conversion after the receive side receiving coil 122 receives the power is performed with a voltage tripler rectifier at 13.5 MHz with Schottky diodes having low-threshold forward voltages. Output DC voltage is measured every 2.5 cm with spacing between the resonator 116 and coil 122 varying from 2.5 cm to 20 cm, and voltage source of 20 Vₚₚ, with results shown in FIG. 30. According to these results, an improvement of approximately 60 percent was observed after tuning the single-ended resonator 116 for short distances (<5 cm) and about 50 percent for larger distances from the receiving coil 122. Efficiency without rectification was found with 7 cm spacing between the resonator 116 and the receiving coil 122. The time average of the input power (measured from the current and voltage at the input to the resonator 116) was divided by the output power calculated from the measured voltage delivered to a 50Ω load. Measurement was done with the use of a Tektronix™ DPO 710604C oscilloscope, Ct-2 current probe, P6248 differential voltage probe and a RIGOL DG4102 signal generator. With transmitter tuning, the efficiency can be varied from 2%, as a worst case, to as high as 48%.

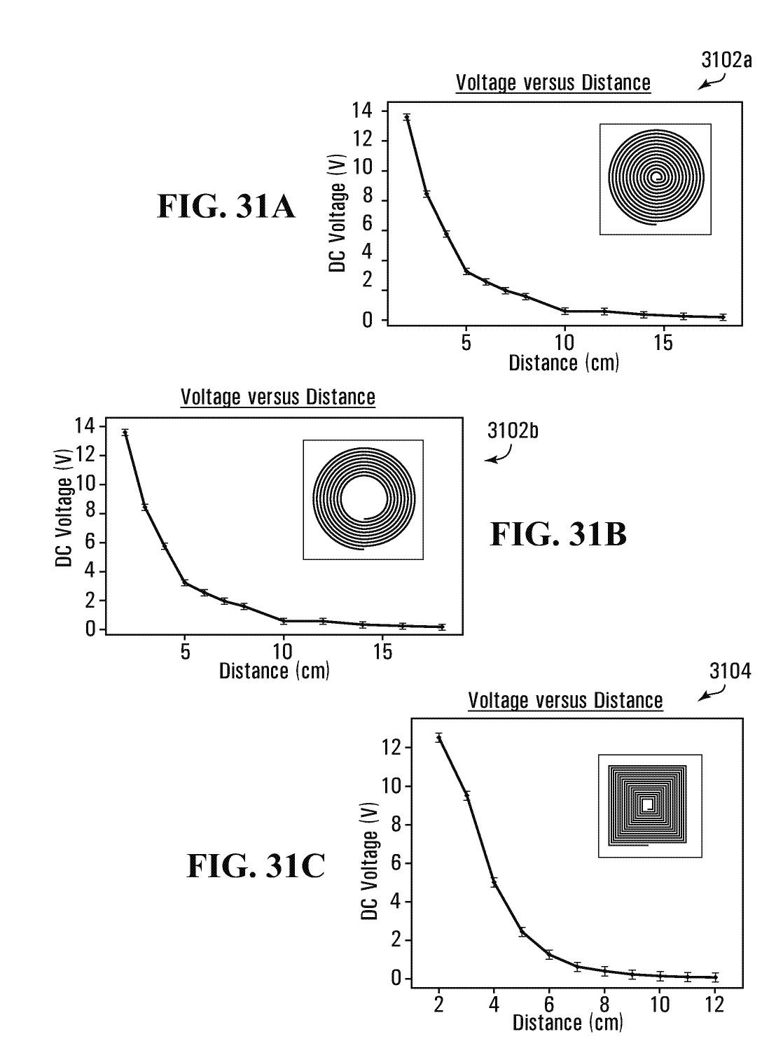

Referring now to FIG. 31A-31C, there are shown alternative planar coil structures that the receive side receiving coil 122 may comprise, with example graphs of DC voltage vs. distance between the resonator 116 and type of receiving coil 122. Two graphs 3102a,b show voltage vs. distance graphs for circular coils, with one graph 3102b generated with a circular coil that has a larger inner diameter than that of the other graph 3102a. A third graph 3104 shows voltage vs. distance for a square coil.

While the embodiments of FIGS. 21A to 31C are discussed in respect of the receive side resonator 116 and receiving coil 122, in different embodiments they can analogously be applied to the transmit side resonator 108 and transmitting coil 106.

### Adaptive Tuning and Matching

As discussed above, in some embodiments one or both of the circuitry primarily used for tuning (e.g., the capacitors 118a,b and 120a,b) and the circuitry primarily used for impedance matching (e.g., the transmit and receive side matching networks 110, 126) may be changed in response to changing conditions that affect operation of the system 100. These conditions may comprise any one or more of changing the distance between, or alignment of, the receive side single-ended resonator 116 and the receive side receiving coil 122; changing the distance between, or alignment of, the transmit side single-ended resonator 108 and transmit side transmitting coil 106; a change in the impedance of the conducting structure 112, such as that which results when a person touches the conducting structure 112 with his or her skin; and a changing load 128. A changing load 128 may refer, for example, to a change in impedance of a single load 128; addition or removal of loads 128, thereby changing the total load 128 powered by the system 100; and a change in the nature of a load 128, such as if a person comes into contact with the load 128, or comes between the receive side resonator 116 and coil 122 or the transmit side resonator 108 and coil 106, while the system 100 is operating, thereby changing the load's 128 capacitance.

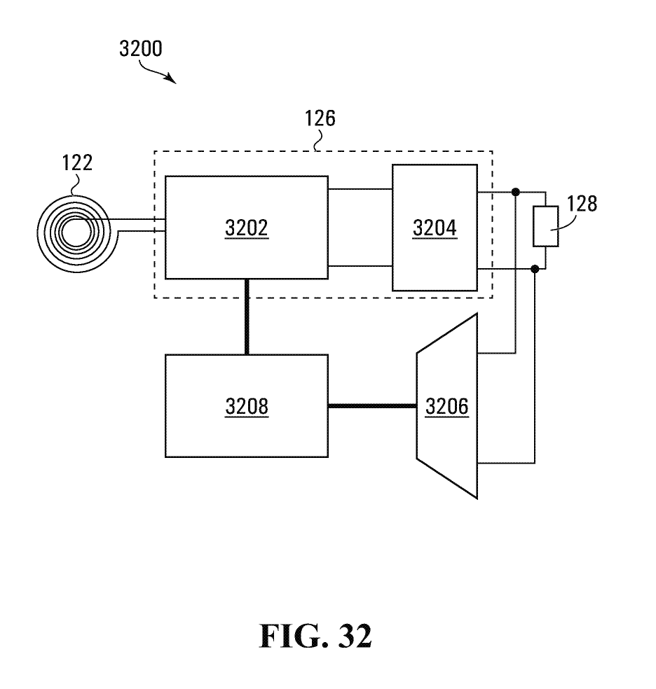

In the embodiments of FIGS. 32 to 37, the impedance of one or more of the tuning networks used to affect the resonant frequency of the transmit side transmitting and receiving coils 106, 108 and the receive side transmitting and receiving coils 116, 122, and the transmit and receive side matching networks 110, 126, are modified to increase one or both of system efficiency and power transfer. This process may be done in real-time while the system 100 is operating and is referred to as “adaptive matching” or “adaptive tuning”. Adaptive matching or tuning may be done on one or both of the transmit and receive sides of the system 100.

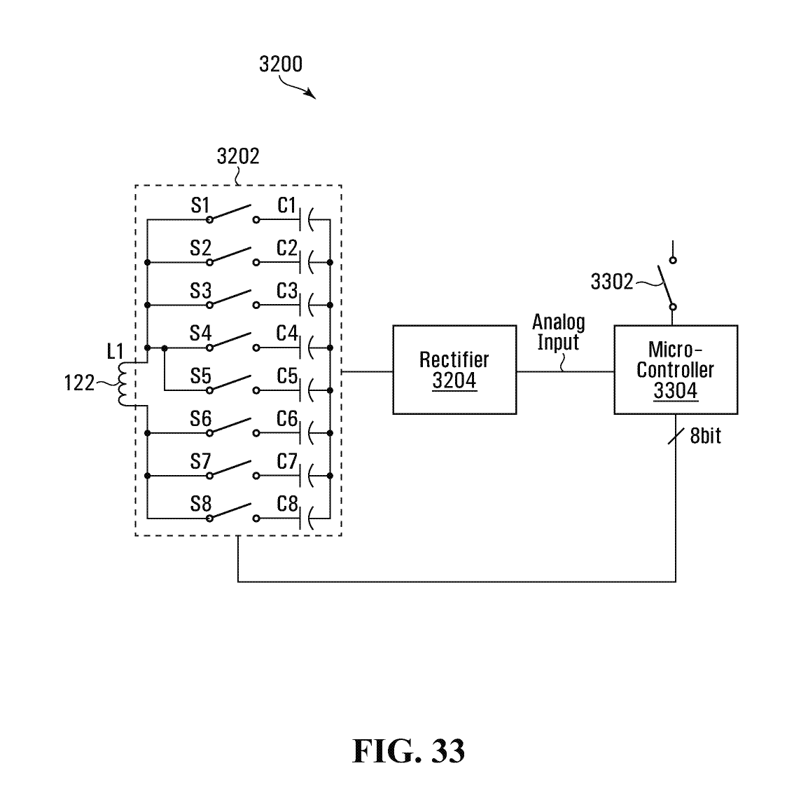

More particularly, in FIGS. 32 and 33, there is shown a system 3200 for modifying impedance in the system 100 for single conductor and wireless power transfer, according to two example embodiments. In FIG. 32, the system 3200 is electrically coupled to the receive side receiving coil 122. The system 3200 comprises a reactive component bank 3202 whose input is connected to the receive side receiving coil 122 and whose output is connected to an AC to DC converter 3204. The load 128 is connected to the output of the AC to DC converter 3204. A voltage measurement taken across the load 128 is fed into an analog-to-digital converter (“ADC”) 3206, whose digital output is sent to a processor 3208. The processor 3208 then controls the reactive component bank 3202 to adjust its reactance in response to the power delivered to the load 128. In FIG. 32, the reactive component bank 3202 and the AC to DC converter 3204 collectively comprise the receive side matching network 126, although in different embodiments (not depicted) the system 3200 may be used to modify the reactance of the circuitry used primarily to tune the resonant frequency of any of the coils 106, 108, 116, 122, the transmit side matching network 110, or any combination thereof.

As shown in FIGS. 32 and 33, the processor 3208 and ADC 3206 may collectively comprise part of a microcontroller 3210. In the embodiment of FIG. 33 in particular, the reactive component bank 3202 is entirely capacitive with capacitors C1 through C8 connected in parallel with the receive side receiving coil 122, modeled as inductor L1. Switches S1 through S8 connect the capacitors C1 through C8 to the receiving coil 122, respectively. The switches may be implemented using any suitable hardware, such as relays or transistors. A rectifier is used as an example AC to DC converter 3204, and a push button 3302 permits a user of the system 3200 to provide an input signal to the microcontroller 3304. In different embodiments (not depicted), the reactive component bank 3202 may additionally or alternatively comprise inductors, and any capacitors and inductors that comprise the reactive component bank 3202 may be connected in series, in parallel, or in a combination thereof. In one non-depicted embodiment, the capacitors of the reactive component bank 3202 have magnitudes that are integer multiples of each other, with each being connected in series with a switch to ground. A method for switching through different combinations of the reactances in the reactive component bank 3202, based on a genetic algorithm, is used to achieve relatively high power transfer efficiency in a relatively short time.

In FIG. 33, each of the capacitors C1 through C8 has a capacitance selected from the range of 0.1 pF to 32 pF. Selecting the capacitors is based on factors including the design of the coil 122. The microcontroller 3304 in the depicted embodiment is an Atmel™ Tiny™ microcontroller with a power consumption of approximately 1 mW; example microcontrollers are the Atmel™ Tiny™ 261/461/861, 44AU, and 43U. In the depicted example embodiment, the microcontroller 3304 comprises eight of the ADCs 3204, of which one is selected to sample the output voltage across the load 128 and convert it to a digital signal having 8-bit precision. While in the depicted embodiment 8-bit precision is used, in different embodiments different levels of precision, for example 4 to 5 bits of precision, may be suitable.

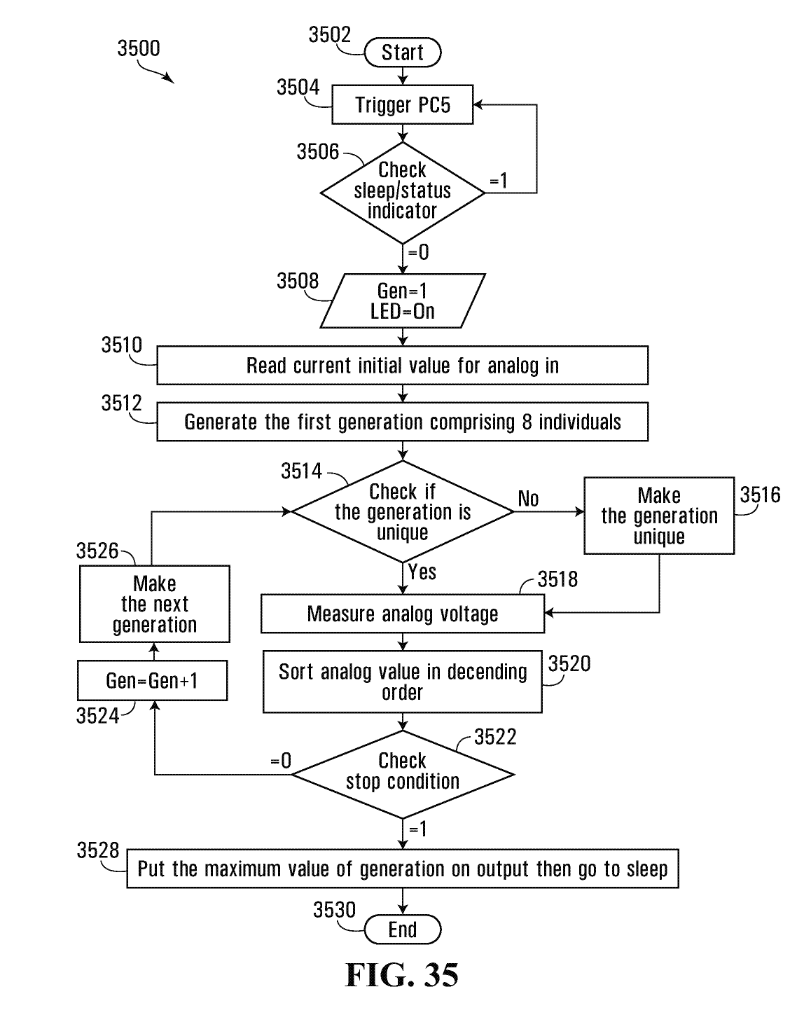

The microcontroller 3304 also comprises a non-transitory computer readable medium (not depicted) on which is encoded program code to cause the microcontroller 3304, and more particularly the processor 3208, to perform a method for adjusting the reactance of the reactive component bank 3202. One example method 3500 is shown in FIG. 35.

The method 3500 begins at block 3502. A user of the system 3200 presses the push button 3302 (in a different, non-depicted embodiment, the method 3500 may be free running); the microcontroller 3304 receives the input from the push button 3302 at block 3504. The microcontroller 3304 proceeds to block 3506 where it determines whether it is currently in an active or an inactive/sleep mode. If the microcontroller 3304 is already in the active mode when the push button 3302 is pressed, the microcontroller 3304 is already performing one of blocks 3508 to 3530 of the method 3500 and accordingly returns to block 3504 from block 3506 to wait for the method 3500 to complete and to receive additional user input. If the microcontroller 3304 is in an inactive/sleep mode, it wakens and proceeds to block 3508 where it continues to perform the method 3500. More particularly, at block 3508 where it sets a “Gen” variable, representing the current generation of solutions produced by implementing the genetic algorithm, to 1, and turns on an LED to indicate to the user that processing is occurring.

After block 3508 the microcontroller 3304 proceeds to block 3510 where it reads the current voltage across the load 128. While in the depicted embodiment the microcontroller 3304 uses the voltage across the load 128 as a feedback parameter that is to be made more optimal, in different embodiments (not depicted) the microcontroller 3304 may apply the method 3500 using a different feedback parameter. For example, in different embodiments the feedback parameter may comprise any one or more of a voltage measured across two different nodes in the system 100; a current being conducted through the load 128 or through a node located elsewhere in the system 100; S-parameters of any component in the system 100, such as the S-parameters of any one or more of the resonators 108, 116, coils 116, 122, and conducting structure 112; power delivered to any component in the system 100, such as at the load 128 or the power source 102; and for embodiments in which the system 100 is used for data transmission, signal-to-noise ratio (“SNR”) and bit error rate. Furthermore, while in the depicted embodiment the method 3500 aims to increase the voltage to a maximum target value, in different embodiments (not depicted) the goal may not be to maximize the feedback parameter. For example, in embodiments in which the feedback parameter is bit error rate or an S-parameter indicative of reflected signal, the goal may be to reduce the feedback parameter towards a minimum target value. As another example, in embodiments in which the system 100 comprises multiple loads 128 and the feedback parameter is power delivered to one of those loads 128, the goal may be to reduce that power in order to permit sufficient power to be delivered to the other loads 128. As another example, in embodiments in which the feedback parameter is power delivered to the load 128, the goal may be to deliver a target value of power to the load 128, with that target value of power being between the minimum and maximum power deliverable to the load 128.

After block 3510 the microcontroller 3508 proceeds to block 3512 where it creates a first generation of eight genomes, with each genome having random states of the switches S1 through S8. The microcontroller 3304 at block 3515 checks to see whether the generation of genomes is unique; that is, whether the generation of eight genomes created at block 3512 has previously been created and tested for this particular running of the method 3500. If the generation is not unique, the microcontroller 3304 proceeds to block 3516 where it makes the generation unique by changing one or more of the genomes.

Once the microcontroller 3304 determines the generation of genomes is unique, it actuates the switches S1 through S8 in accordance with these genomes, and at block 3518 measures and records the output voltage across the load 128 for each of these genomes. In this example embodiment, each genome is an 8 bit binary number, with each bit controlling whether one of the switches S1 through S8 is opened or closed. The microcontroller 3304 at block 3520 then sorts the recorded voltages by and notes which voltage corresponds with which genome.

After sorting, the microcontroller 3304 proceeds to block 3522 where it checks a stop condition to determine whether to generate another generation of genomes in an attempt to determine a better setting for the reactive component bank 3202 that results in a higher voltage across the load 128. In one embodiment, the stop condition is that all the genomes in the current generation correspond to load voltages that vary by less than a stopping threshold, such as 0.1 V, on the basis that this stop condition represents the voltage being sufficiently near the target value, which is the maximum voltage. In another embodiment, the stop condition is that a subset of the genomes (e.g., two of the genomes) correspond to a load voltage that varies less than a certain threshold. If the stop condition is satisfied, the microcontroller 3304 proceeds to block 3528, where it sets the reactive component bank 3202 according to the genome corresponding to the highest load voltage, and then proceeds to block 3530 where the method 3500 ends.

If the stop condition is not satisfied, the microcontroller 3304 increments the Gen variable by 1 at block 3524 and at block 3526 makes a subsequent generation of genomes. To generate the subsequent generation of genomes, the genome corresponding to the switch pattern resulting in the highest load voltage is directly transferred to the next generation; four additional second generation genomes are generated as a result of a crossover between the genomes resulting in the 2^{nd} through 5^{th} highest load voltages from the current generation; and sixth and seventh second generation genomes are randomly created using the microcontroller's 3304 internal random number generator and the genome from the current generation corresponding to the lowest load voltage. The microcontroller 3304 then returns to block 3514 and the method 3500 iteratively continues with the genomes of the n^{th} generation being generated using genomes of the (n−1)^{th} generation until the stop condition is satisfied.

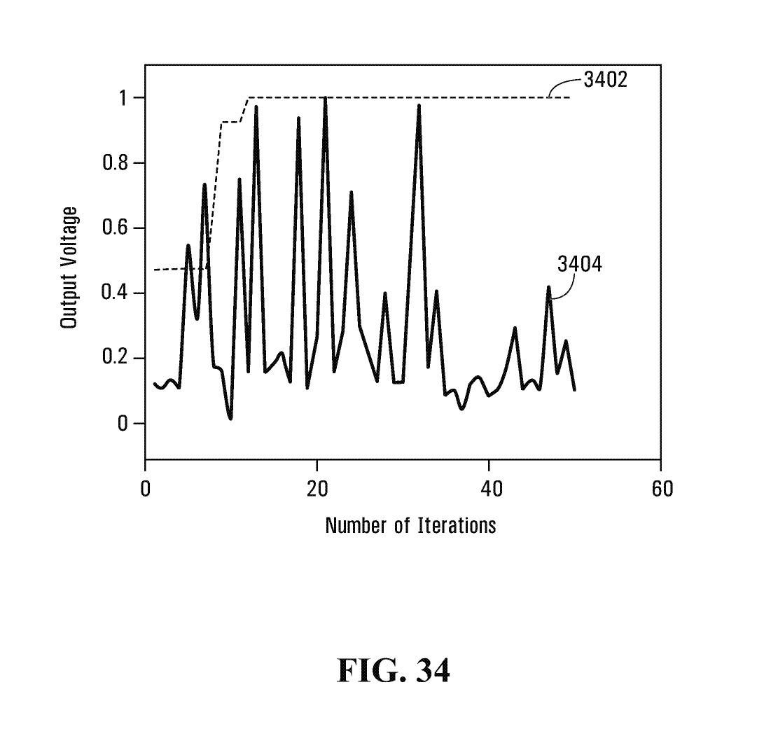

To evaluate the method, a MATLAB™ program was used to implement the method; results of the program's execution are shown in FIG. 34. FIG. 34 compares a curve 3402 showing output voltage vs. number of iterations using the method above vs. an analogous curve 3404 generated using randomly selected on-off patterns for the switches S1 through S8. As is evident from FIG. 34, the method described above converges to the maximum voltage (1 V) of FIG. 34 more quickly than a random method, which does not converge in FIG. 34.

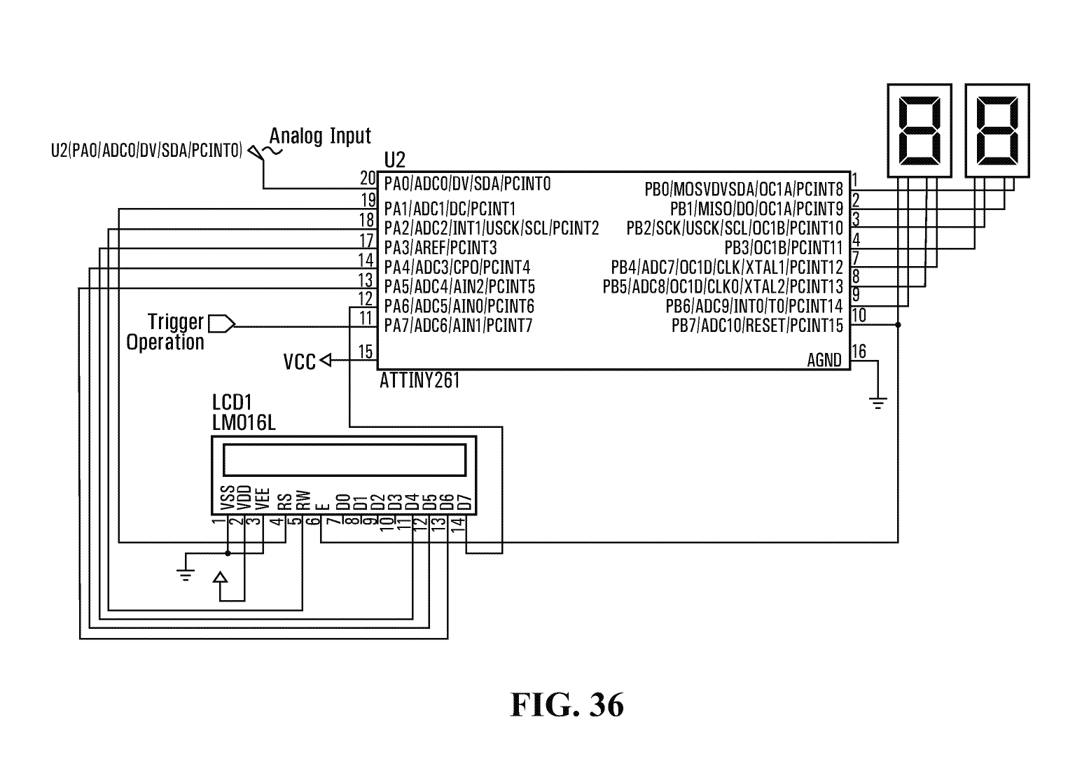

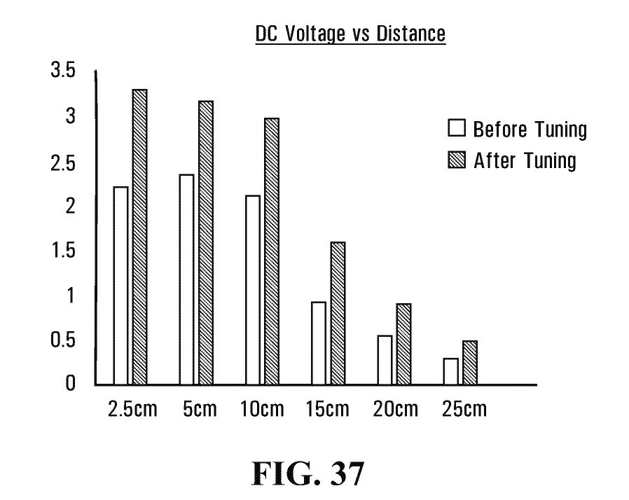

FIG. 36 displays an example implementation of the method using Porteous™ software. The method may be compiled using AVR-Studio 4.18 and executed on an ATmega 168PA. The receiving coil 122 in the example implementation is a conventional parallel RLC circuit comprising a printed, spiral coil. The system 3200 was used to tune the single-ended resonator 116 (i.e., in place of the capacitors 118a,b) in response to varying distances between the resonator 116 and the coil 122. FIG. 37 shows the results of application of the method (“after tuning”) at various distances between the resonator 116 and receiving coil 122 vs. voltage measurements where no tuning is performed (“before tuning”); input voltage to the system was 3 V peak-to-peak and the load 128 had an impedance of 4.7 kΩ.

While the embodiments of FIGS. 32 to 37 depict certain example embodiments, different embodiments (not depicted) are also possible. For example, the depicted digital implementations may analogously be implemented using analog circuitry in lieu of, for example, the microcontroller 3304 of FIG. 33. Additionally or alternatively, in lieu of the method depicted in FIG. 35, any suitable adaptive method may be used for adaptive tuning/matching; suitable example methods comprise those based on steepest descent gradient, genetic algorithms, least mean squares, recursive least squares, multidelay block frequency domain adaptive filter, Wiener filter, random method, and a binary method. Additionally or alternatively, the reactive component bank 3202 may comprise a variable capacitor in lieu of multiple discrete capacitors to permit continuous, as opposed to discrete, changes in capacitance. Analogously, the reactive component bank 3202 may additionally or alternatively comprise multiple discrete inductors, a variable inductor, or both. More generally, the reactive component bank 3202 may comprise one or more inductors, capacitors, and resistors, in any suitable series, parallel, or hybrid series/parallel configuration.

### Data Transmission

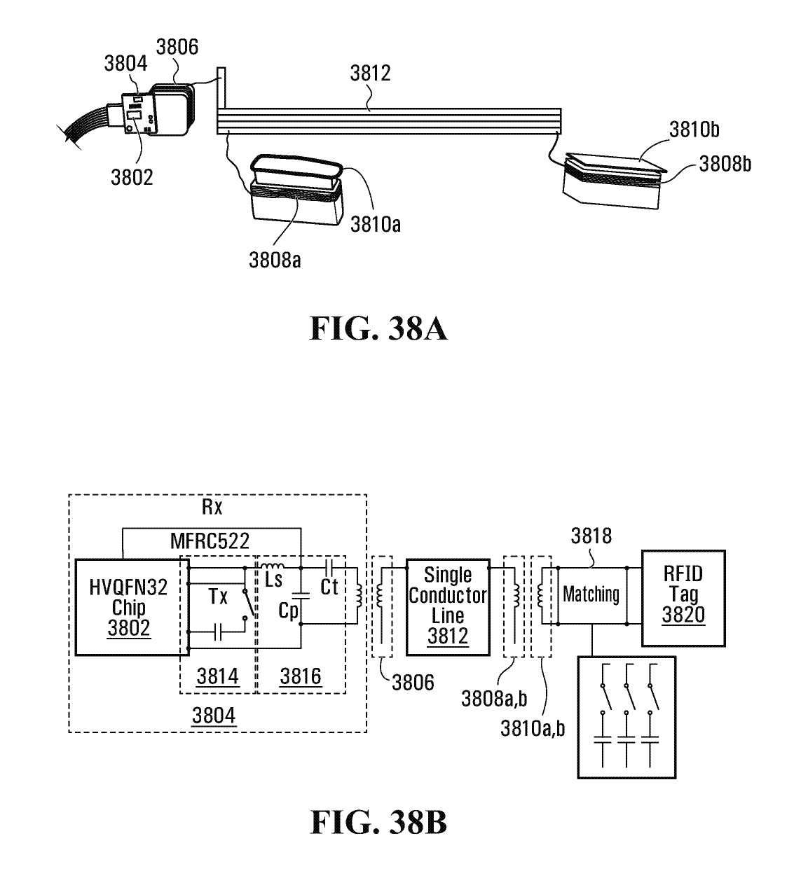

FIG. 38A and FIG. 38B demonstrate the modification of a commercial system for RFID tag measurement using a control chip 3802 HVQFN32 to use the single conductor transmission system 100 for data transmission. An existing RFID reader 3804 is modified and the coil part of the reader 3804 is used as the transmit side transmitting coil 106. The transmitting coil 106 couples to a square 4 cm×4 cm resonator 3806 made using 4 m of 24 AWG wire. One of the tuning capacitors 120a is included for tuning in this particular example embodiment, but the other tuning capacitor 120b is not. The resonator 3806 is connected to strips of copper 3812 used as the single conductor transmission line. Two receiver portion single conductor resonators 3808a,b are shown connected to different parts of the copper single conductor line. The receiver portion resonators are multi-turn with 8.5 cm×4 cm area constructed of 4.5 m long 24 AWG copper wire. A 10 pF capacitor 118a is used for tuning, while capacitor 118b is not included for this implementation. Two examples of coils that have commercial RFID tags 3810a,b are used as the powered loads 128 and send data to be read by the reader 3804 are visible in FIG. 38A. One of the coils 3810a is 8.5 cm×4 cm 12 turn coil tuned with a series capacitor with RFID tag, while the other coil 3810b is a commercially available Mifare RFID keycard.

FIG. 38B shows a circuit model of the system in FIG. 38A. The transmitter modulator 3814 is shown explicitly. The switch leading to a capacitor in parallel with the matching network 3816 is an example of capacitive impedance modulation, but other systems may use resistive modulation or voltage controlled amplification modulation. The matching network 3816 is modified from the original network by using a 1 μH inductor Ls, 1 pF capacitor Cp, and 150 pF tuning capacitor Ct, resulting in a measured input impedance of approximately 80Ω. The balanced nature of the excitation by the HVQFN32, which generates a 5 Vₚₚ power signal, means the effective input impedance seen by the generator is actually approximately 40Ω. Although not included in the depicted example embodiment, parallel capacitors with switches may be used in the receiver matching 3818 for adaptively compensating for changes in tuning as discussed in more detail above. Additionally, capacitor switches are used by the RFID tag 3820 for sending data to the MFRC522 RFID reader through impedance modulation, which is processed with the RX demodulation channel of the HVQFN32 chip. The measurement and logging of data into a computer using an MFRC522 reader with a single conductor system 100 has been shown with multiple receivers simultaneously.

While FIG. 38B shows modulation being done at the transmitter, in different embodiments (not depicted) modulation may additionally or alternatively be done at the receiver and communication may be bidirectional using the system 100. Additionally, the data transmitted using the system 100 may be transmitted at a different frequency than the operating frequency of the power source 102. For example, in FIG. 38B the switch in the transmitter modulator 3814 may modulate the signal at a rate that is slower or faster than the frequency of the power source 102. Additionally or alternatively, the data that is transmitted using the system 100 may be encoded using any suitable encoding scheme, such as amplitude modulation, frequency modulation, phase modulation, and orthogonal frequency division multiplexing. In another embodiment (not depicted), the system 100 further comprises a receive modulator portion, analogous to the transmitter modulator 3814, that is electrically coupled to the receive side receive coil 122 to modulate a signal such that bidirectional communication is performed using the system 100.

While a microcontroller comprising a processor is used in the foregoing embodiments, in alternative embodiments (not depicted) any suitable type of processing unit may be used. For example, the microcontroller may instead be, a system on a chip, programmable logic controller, field programmable gate array, or an application-specific integrated circuit. Examples of computer readable media used to store program code thereon and that may comprise part of or be communicatively coupled to the processing unit are non-transitory and include disc-based media such as CD-ROMs and DVDs, magnetic media such as hard drives and other forms of magnetic disk storage, and semiconductor based media such as flash media, random access memory, and read only memory.

For the sake of convenience, the example embodiments above in some instances described as various interconnected functional blocks. This is not necessary, however, and there may be cases where these functional blocks are equivalently aggregated into a single logic device, program or operation with unclear boundaries. In any event, the functional blocks can be implemented by themselves, or in combination with other pieces of hardware or software.

FIGS. 4 and 35 depict flowcharts of an example embodiment of a method. Some of the blocks illustrated in the flowcharts may be performed in an order other than that which is described. Also, it should be appreciated that not all of the blocks described in the flowchart are required to be performed, that additional blocks may be added, and that some of the illustrated blocks may be substituted with other blocks.

It is contemplated that any part of any aspect or embodiment discussed in this specification can be implemented or combined with any part of any other aspect or embodiment discussed in this specification. As an example, and without limiting the generality of the foregoing, any of the tuning and matching networks of any of the embodiments described herein (e.g., capacitor 125, which acts as a transmit side transmitting coil 106 tuning network; matching networks 110, 126; capacitors 120a,b, which act as transmit side single-ended resonator tuning network; capacitors 118a,b, which act as a receive side single-ended resonator tuning network; and capacitor 124, which acts as a receive side receiving coil 122 tuning network) may be adaptively matched and/or tuned, as appropriate, as described in respect of FIGS. 32-37. Similarly, any of the embodiments described herein may be used for unidirectional or bidirectional data transfer, as described in respect of FIGS. 38A and 38B.

While particular embodiments have been described in the foregoing, it is to be understood that other embodiments are possible and are intended to be included herein. It will be clear to any person skilled in the art that modification of and adjustments to the foregoing embodiments, not shown, are possible.

1. A system for wireless and single conductor power transmission, the system comprising:
(a) a receive side single-ended resonator for receiving power from an alternating current power source via a single conductor, wherein the power source is operable to emit power at an operating frequency;
(b) a receive side resonator tuning network, the tuning network comprising at least one reactive lumped component connected in series with the receive side single-ended resonator or in parallel across two locations along the receive side single-ended resonator; and
(c) a receive side receiving coil for transferring power to a load, wherein the receive side receiving coil inductively is coupled to the receive side single-ended resonator when the power source is operating, the at least one reactive lumped component is selected such that the receive side single-ended resonator is substantially at resonance when inductively coupled to the receive side receiving coil at the operating frequency, and the receive side receiving coil is substantially at resonance when inductively coupled to the receive side single-ended resonator at the operating frequency.

2. The system of claim 1 wherein the receive side single-ended resonator comprises first and second ends and wherein the system further comprises the single conductor, the single conductor comprising a conducting structure electrically coupled to the receive side single-ended resonator via the first end.

3. The system of claim 2 wherein the conducting structure comprises a non-wire conducting structure.

4. The system of claim 2 wherein the conducting structure comprises a non-constant cross-section.

5. The system of any one of claims 2 to 4 wherein the first and second ends are electrically connected in parallel to the conducting structure.

6. The system of claim 5 wherein the at least one reactive lumped component comprises a first and a second capacitor, the first end of the receive side single-ended resonator is electrically coupled to the conducting structure via the first capacitor, and the second end of the receive side single-ended resonator is electrically coupled to the conducting structure via the second capacitor.

7. The system of any one of claims 2 to 4 wherein the second end is floating.

8. The system of any one of claims 2 to 7 further comprising one or more additional receive side single-ended resonators each electrically coupled to the conducting structure.

9. The system of any one of claims 2 to 8 further comprising one or more additional receive side receiving coils inductively coupled to the receive side single-ended resonator.

10. The system of any one of claims 2 to 9 further comprising the power source, wherein the power source comprises a floating ground terminal and a power output terminal electrically and physically coupled to the conducting structure.

11. The system of claim 10 further comprising:
(a) a transmit side single-ended resonator electrically coupled to the conducting structure; and
(b) a transmit side resonator tuning network comprising at least one reactive lumped component connected in series with the transmit side single-ended resonator or in parallel across two locations along the transmit side single-ended resonator, wherein the at least one reactive lumped component of the transmit side resonator tuning network is selected such that the transmit side single-ended resonator is substantially at resonance at the operating frequency,
wherein the power output terminal of the power source is physically coupled to the transmit side single-ended resonator.

12. The system of claim 11 wherein the power output and ground terminals of the power source are physically coupled to two locations on the transmit side single-ended resonator.

13. The system of any one of claims 2 to 10 further comprising:
(a) a transmit side transmitting coil for receiving power from the power source;
(b) a transmit side single-ended resonator electrically coupled to the conducting structure, wherein the transmit side transmitting coil and single-ended resonator are inductively coupled when the power source is operating; and
(c) a transmit side resonator tuning network comprising at least one reactive lumped component connected in series with the transmit side single-ended resonator or in parallel across two locations along the transmit side single-ended resonator, wherein the at least one reactive lumped component of the transmit side resonator tuning network is selected such that the transmit side single-ended resonator is substantially at resonance at the operating frequency, and wherein the transmit side transmitting coil is substantially at resonance when inductively coupled to the transmit side single-ended resonator at the operating frequency.

14. The system of claim 13 further comprising a transmit side transmitting coil tuning network electrically coupled to the transmit side transmitting coil to cause the transmit side transmitting coil to be substantially at resonance at the operating frequency of the power source.

15. The system of any one of claims 11 to 14 further comprising a transmit side matching network electrically coupled between the transmit side transmitting coil and the power source.

16. The system of any one of claims 13 to 15 further comprising a transmitter modulator electrically coupled to the transmit side transmitting coil, the transmitter modulator comprising a switch operable to modulate the power conducted to the transmit side transmitting coil from the power source.

17. The system of any one of claims 13 to 16 further comprising a receiver modulator electrically coupled to the receive side receiving coil, the receive modulation portion comprising a switch operable to modulate a signal transmitted to the transmit side transmitting coil via the receive side receiving coil.

18. The system of any one of claims 1 to 15 wherein the receive side single-ended resonator comprises a helix with a resonant length approximately a quarter wavelength of the power source plus an integer multiple of a half wavelength.

19. The system of any one of claims 1 to 18 wherein the receive side single-ended resonator has a diameter significantly less than one tenth of the wavelength of the power source.

20. The system of any one of claims 1 to 19 wherein the receive side single-ended resonator comprises a helix wrapped around a core.

21. The system of claim 20 wherein the core comprises an air core.

22. The system of claim 20 or 21 wherein the receive side transmitting coil comprises a toroid.

23. The system of claim 20 wherein the core comprises a ferrite core.

24. The system of any one of claims 1 to 23 further comprising a receive side receiving coil tuning network electrically coupled to the receive side receiving coil to cause the receive side receiving coil to be substantially at resonance at the operating frequency of the power source.

25. The system of any one of claims 1 to 24 further comprising a receive side matching network electrically coupled between the receive side receiving coil and the load.

26. The system of claim 1 wherein the receive side resonator tuning network comprises a reactive component bank and wherein the system further comprises control circuitry configured to:
(a) read a feedback parameter of the system; and
(b) in response to the feedback parameter, adjust the reactance of the reactive component bank such that the feedback parameter approaches a target value.

27. The system of claim 11 or 13 wherein the transmit side resonator tuning network comprises a reactive component bank and wherein the system further comprises control circuitry configured to:
(a) read a feedback parameter of the system; and
(b) in response to the feedback parameter, adjust the reactance of the reactive component bank such that the feedback parameter approaches a target value.

28. The system of claim 14 wherein the transmit side transmitting coil tuning network comprises a reactive component bank and wherein the system further comprises control circuitry configured to:
(a) read a feedback parameter of the system; and
(b) in response to the feedback parameter, adjust the reactance of the reactive component bank such that the feedback parameter approaches a target value.

29. The system of claim 15 wherein the transmit side matching network comprises a reactive component bank and wherein the system further comprises control circuitry configured to:
(a) read a feedback parameter of the system; and
(b) in response to the feedback parameter, adjust the reactance of the reactive component bank such that the feedback parameter approaches a target value.

30. The system of claim 24 wherein the receive side receiving coil tuning network comprises a reactive component bank and wherein the system further comprises control circuitry configured to:
(a) read a feedback parameter of the system; and
(b) in response to the feedback parameter, adjust the reactance of the reactive component bank such that the feedback parameter approaches a target value.

31. The system of claim 25 wherein the receive side matching network comprises a reactive component bank and wherein the system further comprises control circuitry configured to:
(a) read a feedback parameter of the system; and
(b) in response to the feedback parameter, adjust the reactance of the reactive component bank such that the feedback parameter approaches a target value.

32. The system of any one of claims 26 to 31 wherein the control circuitry comprises a processor and a computer readable medium communicatively coupled to the processor, wherein the computer readable medium has stored thereon computer program code that is executable by the processor and that, when executed by the processor, causes the processor to:
(a) read the feedback parameter of the system; and
(b) in response to the feedback parameter, iteratively adjust the reactance of the reactive component bank such that the feedback parameter approaches a target value and until a stop condition is satisfied.

33. The system of claim 32 wherein iteratively adjusting the reactance of the reactive component bank comprises, for each iteration:
(a) creating a generation of genomes, wherein each of the genomes corresponds to a different reactance of the reactive component bank; and
(b) for each of the genomes:
(i) adjusting the reactance of the reactive component bank to the reactance corresponding to the genome; and
(ii) reading the feedback parameter corresponding to the reactance of the genome.

34. The system of claim 33 wherein the feedback parameter is selected from the group consisting of voltage measured across two nodes in the system, current measured through a node in the system, S-parameters of any component in the system, power delivered to any component in the system, signal-to-noise ratio, and bit error rate.

35. The system of any one of claims 31 to 34 wherein the reactive component bank comprises multiple switches each of which is connected in series to a capacitor, and wherein adjusting the reactance of the reactive component bank comprises actuating the switches to different states.

36. The system of any one of claims 1 to 35 further comprising the load, wherein the load comprises an RFID tag.

37. A method for wireless and single conductor power transmission, the method comprising:
(a) receiving alternating current power via a single conductor at a receive side single-ended resonator, wherein the power oscillates at an operating frequency;
(b) inductively transferring the power from the receive side single-ended resonator to a receive side receiving coil, wherein inductive transfer of the power occurs when the receive side single-ended resonator and the receive side receiving coil are both substantially at resonance; and
(c) powering a load using the power transferred from the receive side single-ended resonator to the receive side receiving coil,
wherein a receive side resonator tuning network comprising at least one reactive lumped component is connected in series with the receive side single-ended resonator or in parallel across two locations along the receive side single-ended resonator.

38. The method of claim 37 wherein the receive side single-ended resonator comprises first and second ends and wherein the single conductor comprises a conducting structure electrically coupled to the receive side single-ended resonator via the first end.

39. The method of claim 38 wherein the conducting structure comprises a non-wire conducting structure.

40. The method of claim 38 wherein the conducting structure comprises a non-constant cross-section.

41. The method of any one of claims 38 to 40 wherein the first and second ends are electrically connected in parallel to the conducting structure.

42. The method of claim 41 wherein the at least one reactive lumped component comprises a first and a second capacitor, the first end of the receive side single-ended resonator is electrically coupled to the conducting structure via the first capacitor, and the second end of the receive side single-ended resonator is electrically coupled to the conducting structure via the second capacitor.

43. The method of any one of claims 38 to 42 wherein the second end is floating.

44. The method of any one of claims 38 to 43 wherein power is received at one or more additional receive side single-ended resonators each electrically coupled to the conducting structure.

45. The method of any one of claims 37 to 44 wherein power is inductively transferred to one or more additional receive side receiving coils inductively coupled to the receive side single-ended resonator.

46. The method of any one of claims 37 to 45 wherein the power is output by a power source that comprises a floating ground terminal and a power output terminal electrically and physically coupled to the conducting structure.

47. The method of claim 46 further comprising transmitting the power to the conducting structure via a transmit side single-ended resonator electrically coupled to the conducting structure prior to the power being received by the receive side single-ended resonator,
wherein a transmit side resonator tuning network comprising at least one reactive lumped component is connected in series with the transmit side single-ended resonator or in parallel across two locations along the transmit side single-ended resonator,
wherein the at least one reactive lumped component of the transmit side resonator tuning network is selected such that the transmit side single-ended resonator is substantially at resonance at the operating frequency, and
wherein the power output terminal of the power source is physically coupled to the transmit side single-ended resonator.

48. The method of claim 47 wherein the power output and ground terminals of the power source are physically coupled to two locations on the transmit side single-ended resonator.

49. The method of any one of claims 38 to 46 further comprising:
(a) receiving the power at a transmit side transmitting coil; and
(b) inductively transferring the power from the transmit side transmitting coil to a transmit side single-ended resonator electrically coupled to the conducting structure, wherein the transmit side transmitting coil and single-ended resonator are both substantially at resonance,
wherein a transmit side resonator tuning network comprising at least one reactive lumped component is connected in series with the transmit side single-ended resonator or in parallel across two locations along the transmit side single-ended resonator.

50. The method of claim 49 wherein a transmit side transmitting coil tuning network is electrically coupled to the transmit side transmitting coil to cause the transmit side transmitting coil to be substantially at resonance at the operating frequency.

51. The method of claim 49 or 50 wherein a transmit side matching network is electrically coupled between the transmit side transmitting coil and a power source that outputs the power.

52. The method of any one of claims 49 to 51 further comprising transmitting data between the transmit side transmitting coil and the receive side receiving coil by modulating a signal at the transmit side transmitting coil and the receive side receiving coil.

53. The method of any one of claims 37 to 51 wherein the receive side single-ended resonator comprises a helix with a resonant length approximately a quarter wavelength of the power source plus an integer multiple of a half wavelength.

54. The method of any one of claims 37 to 53 wherein the receive side single-ended resonator has a diameter significantly less than one tenth of the wavelength of the power source.

55. The method of any one of claims 37 to 54 wherein the receive side single-ended resonator comprises a helix wrapped around a core.

56. The method of claim 55 wherein the core comprises an air core.

57. The method of claim 55 or 56 wherein the receive side transmitting coil comprises a toroid.

58. The method of claim 55 wherein the core comprises a ferrite core.

59. The method of any one of claims 37 to 58 wherein a receive side receiving coil tuning network is electrically coupled to the receive side receiving coil to cause the receive side receiving coil to be substantially at resonance at the operating frequency of the power source.

60. The method of any one of claims 37 to 59 wherein a receive side matching network is electrically coupled between the receive side receiving coil and the load.

61. The method of claim 37 wherein the receive side resonator tuning network comprises a reactive component bank and wherein the method further comprises:
(a) reading a feedback parameter; and
(b) in response to the feedback parameter, adjusting the reactance of the reactive component bank such that the feedback parameter approaches a target value.

62. The method of claim 47 or 49 wherein the transmit side resonator tuning network comprises a reactive component bank and wherein the method further comprises:
(a) reading a feedback parameter; and
(b) in response to the feedback parameter, adjusting the reactance of the reactive component bank such that the feedback parameter approaches a target value.

63. The method of claim 50 wherein the transmit side transmitting coil tuning network comprises a reactive component bank and wherein the method further comprises:
(a) reading a feedback parameter; and
(b) in response to the feedback parameter, adjusting the reactance of the reactive component bank such that the feedback parameter approaches a target value.

64. The method of claim 51 wherein the transmit side matching network comprises a reactive component bank and wherein the method further comprises:
(a) reading a feedback parameter; and
(b) in response to the feedback parameter, adjusting the reactance of the reactive component bank such that the feedback parameter approaches a target value.

65. The method of claim 59 wherein the receive side receiving coil tuning network comprises a reactive component bank and wherein the method further comprises:
(a) reading a feedback parameter; and
(b) in response to the feedback parameter, adjusting the reactance of the reactive component bank such that the feedback parameter approaches a target value.

66. The method of claim 60 wherein the receive side matching network comprises a reactive component bank and wherein the method further comprises:
(a) reading a feedback parameter; and
(b) in response to the feedback parameter, adjusting the reactance of the reactive component bank such that the feedback parameter approaches a target value.

67. The method of any one of claims 61 to 66 wherein the reactance of the reactive component bank is iteratively adjusted such that the feedback parameter approaches the target value and until a stop condition is satisfied.

68. The method of claim 67 wherein iteratively adjusting the reactance of the reactive component bank comprises, for each iteration:
(a) creating a generation of genomes, wherein each of the genomes corresponds to a different reactance of the reactive component bank; and
(b) for each of the genomes:
(i) adjusting the reactance of the reactive component bank to the reactance corresponding to the genome; and
(ii) reading the feedback parameter corresponding to the reactance of the genome.

69. The method of claim 68 wherein the feedback parameter is selected from the group consisting of voltage measured across two nodes in the system, current measured through a node in the system, S-parameters of any component in the system, power delivered to any component in the system, signal-to-noise ratio, and bit error rate.

70. The method of any one of claims 66 to 69 wherein the reactive component bank comprises multiple switches each of which is connected in series to a capacitor, and wherein adjusting the reactance of the reactive component bank comprises actuating the switches to different states.

71. The method of any one of claims 37 to 70 wherein the load comprises an RFID tag.

72. The method of claim 37 further comprising adaptively matching the receive side receiving coil to the load in response to changes in operating conditions.

73. The method of claim 72 wherein the changes in operating conditions comprise at least one of a change in distance between the receive side single-ended resonator and the receive side receiving coil, a change in inductance of the load, a change in inductance of the load, and a change in alignment between the receive side single-ended resonator and the receive side receiving coil.

74. A system for wireless and single conductor power transmission, the system comprising:
(a) a receive side single-ended resonator for receiving power from an alternating current power source, wherein the power source is operable to emit power at an operating frequency and wherein the receive side single-ended resonator comprises first and second ends;
(b) a receive side receiving coil for transferring power to a load, wherein the receive side receiving coil inductively is coupled to the receive side single-ended resonator when the power source is operating, the receive side single-ended resonator and the receive side receiving coil being substantially at resonance when inductively coupled to each other; and
(c) a single conductor comprising a conducting structure having a non-constant cross-section, the single conductor being the only conductor transferring power from the power source to the receive side single-ended resonator and electrically coupled to the receive side single-ended resonator to transfer power to the resonator via the first end.

75. The system of claim 74 further comprising a receive side receiving coil matching network electrically coupled between the receive side receiving coil and the load when the receive side receiving coil is transferring power to the load.

76. The system of claim 74 or 75 wherein the second end of the receive side single-ended resonator is floating.

77. The system of claim 74 or 75 wherein the second end of the receive side single-ended resonator is also connected to the single conductor such that the receive side single-ended resonator is electrically coupled to the single conductor via the first and second ends of the receive side single-ended resonator.

78. The system of claim 75 further comprising:
(a) a transmit side transmitting coil electrically coupled to the power source;
(b) a transmit side transmitting coil matching network electrically coupled between the power source and the transmit side transmitting coil; and
(c) a transmit side single-ended resonator inductively coupled to the transmit side transmitting coil, wherein the transmit side single-ended resonator comprises a first end and a second end and is electrically coupled to the single conductor to transfer power to the single conductor via the first end of the transmit side single-ended resonator,
wherein the transmit side single-ended resonator and transmit receive side transmitting coil are substantially at resonance when inductively coupled to each other.

79. The system of claim 78 wherein the second end of the transmit side single-ended resonator is floating.

80. The system of claim 78 wherein the second end of the transmit side single-ended resonator is also connected to the single conductor such that the transmit side single-ended resonator is electrically connected to the single conductor via the first and second ends of the transmit side single-ended resonator.

81. The system of claim 78 further comprising a receive side resonator tuning network electrically coupled between the single conductor and the receive side single-ended resonator.

82. The system of claim 81 further comprising a transmit side resonator tuning network electrically coupled between the single conductor and the transmit side single-ended resonator.

83. The system of claim 82 further comprising a receive side receiving coil tuning network electrically coupled between the receive side receiving coil and the receive side matching network.

84. The system of claim 83 further comprising a transmit side transmitting coil tuning network electrically coupled between the transmit side transmitting coil and the transmit side matching network.

85. The system of claim 84 wherein at least one of the transmit side transmitting coil matching network, the receive side receiving coil tuning network, the transmit side resonator tuning network, the receive side resonator tuning network, the transmit side transmitting coil matching network, and the receive side receiving coil matching network comprises a reactive component bank, and wherein the system further comprises control circuitry configured to:
(a) read a feedback parameter of the system; and
(b) in response to the feedback parameter, adjust the reactance of the reactive component bank such that the feedback parameter approaches a target value.

86. The system of claim 85 wherein the control circuitry comprises a processor and a computer readable medium communicatively coupled to the processor, wherein the computer readable medium has stored thereon computer program code that is executable by the processor and that, when executed by the processor, causes the processor to:
(a) read the feedback parameter of the system; and
(b) in response to the feedback parameter, iteratively adjust the reactance of the reactive component bank such that the feedback parameter approaches a target value and until a stop condition is satisfied.

87. The system of claim 86 wherein iteratively adjusting the reactance of the reactive component bank comprises, for each iteration:
(a) creating a generation of genomes, wherein each of the genomes corresponds to a different reactance of the reactive component bank; and
(b) for each of the genomes:
(i) adjusting the reactance of the reactive component bank to the reactance corresponding to the genome; and
(ii) reading the feedback parameter corresponding to the reactance of the genome.

88. The system of claim 87 wherein the feedback parameter is selected from the group consisting of voltage measured across two nodes in the system, current measured through a node in the system, S-parameters of any component in the system, power delivered to any component in the system, signal-to-noise ratio, and bit error rate.

89. The system of any one of claims 86 to 88 wherein the reactive component bank comprises multiple switches each of which is connected in series to a capacitor, and wherein adjusting the reactance of the reactive component bank comprises actuating the switches to different states.

90. The system of any one of claims 78 to 89 further comprising a transmitter modulator electrically coupled to the transmit side transmitting coil, the transmitter modulator comprising a switch operable to modulate a signal transmitted to the receive side receiving coil.

91. The system of any one of claims 78 to 90 further comprising a receiver modulator electrically coupled to the receive side receiving coil, the receiver modulator comprising a switch operable to modulate a signal transmitted to the transmit side transmitting coil via the receive side receiving coil.

92. A method for wireless and single conductor power transmission, the method comprising:
(a) receiving alternating current power via a single conductor at a receive side single-ended resonator, wherein the power oscillates at an operating frequency;
(b) inductively transferring the power from the receive side single-ended resonator to a receive side receiving coil, wherein inductive transfer of the power occurs when the receive side single-ended resonator and the receive side receiving coil are both substantially at resonance; and
(c) powering a load using the power transferred from the receive side single-ended resonator to the receive side receiving coil,
wherein the single conductor comprises a conducting structure having a non-constant cross-section.

93. The method of claim 92 wherein a receive side receiving coil matching network is electrically coupled between the receive side receiving coil and the load.

94. The method of claim 92 or 93 wherein the receive side single-ended resonator comprises a first end via which the receive side single-ended resonator receives power from the single conductor and a second end that is floating.

95. The system of claim 92 or 93 wherein the receive side single-ended resonator comprises a first end and a second end through which the receive side single-ended resonator receives power from the single conductor.

96. The method of claim 93 further comprising:
(a) transmitting power from a power source that outputs the power to a transmit side transmitting coil;
(b) inductively transferring the power from the transmit side transmitting coil to a transmit side single-ended resonator, wherein inductive transfer of the power occurs when the transmit side single-ended resonator and the transmit side transmitting coil are both substantially at resonance; and
(c) transferring power to the single conductor from the transmit side single-ended resonator.

97. The method of claim 96 wherein the transmit side single-ended resonator comprises a first end via which the single conductor receives power from the transmit side single-ended resonator and a second end that is floating.

98. The method of claim 96 wherein the transmit side single-ended resonator comprises a first end and a second end and wherein the single conductor receives power from both the first and second ends.

99. The method of claim 96 further comprising tuning the resonance frequency of the receive side single-ended resonator using a receive side resonator tuning network electrically coupled between the single conductor and the receive side single-ended resonator.

100. The method of claim 99 further comprising tuning the resonance frequency of the transmit side single-ended resonator using a transmit side resonator tuning network electrically coupled between the single conductor and the transmit side single-ended resonator.

101. The method of claim 100 further comprising tuning the resonance frequency of the receive side receiving coil using a receive side receiving coil tuning network electrically coupled between the receive side receiving coil and the receive side matching network.

102. The method of claim 101 further comprising tuning the resonance frequency of the transmit side transmitting coil using a transmit side transmitting coil tuning network electrically coupled between the transmit side transmitting coil and the transmit side matching network.

103. The method of claim 102 wherein at least one of the transmit side transmitting coil matching network, the receive side receiving coil tuning network, the transmit side resonator tuning network, the receive side resonator tuning network, the transmit side transmitting coil matching network, and the receive side receiving coil matching network comprises a reactive component bank, and wherein the method further comprises:
(a) reading a feedback parameter; and
(b) in response to the feedback parameter, adjusting the reactance of the reactive component bank such that the feedback parameter approaches a target value.

104. The method of claim 103 further comprising in response to the feedback parameter, iteratively adjusting the reactance of the reactive component bank such that the feedback parameter approaches a target value and until a stop condition is satisfied.

105. The method of claim 104 wherein iteratively adjusting the reactance of the reactive component bank comprises, for each iteration:
(a) creating a generation of genomes, wherein each of the genomes corresponds to a different reactance of the reactive component bank; and
(b) for each of the genomes:
(i) adjusting the reactance of the reactive component bank to the reactance corresponding to the genome; and
(ii) reading the feedback parameter corresponding to the reactance of the genome.

106. The method of claim 105 wherein the feedback parameter is selected from the group consisting of voltage measured across two nodes in the system, current measured through a node in the system, S-parameters of any component in the system, power delivered to any component in the system, signal-to-noise ratio, and bit error rate.

107. The method of any one of claims 104 to 106 wherein the reactive component bank comprises multiple switches each of which is connected in series to a capacitor, and wherein adjusting the reactance of the reactive component bank comprises actuating the switches to different states.

108. The method of any one of claims 92 to 107 further comprising transmitting data between the transmit side transmitting coil and the receive side receiving coil.

109. The method of claim 92 further comprising adaptively matching the receive side receiving coil to the load in response to changes in operating conditions.

110. The method of claim 93 wherein the changes in operating conditions comprise at least one of a change in distance between the receive side single-ended resonator and the receive side receiving coil, a change in inductance of the load, a change in inductance of the load, and a change in alignment between the receive side single-ended resonator and the receive side receiving coil.

111. A system for wireless and single conductor power transmission, the system comprising:
(a) a transmit side transmitting coil electrically coupled to a power source;
(b) a transmit side matching network electrically coupled between the power source and the transmit side transmitting coil;
(c) a transmit side single-ended resonator inductively coupled to the transmit side transmitting coil, wherein the transmit side single-ended resonator comprises a first end and a second end;
(d) a conducting structure connected to the transmit side single-ended resonator via the first end of the transmit side single-ended resonator;
(e) a receive side single-ended resonator comprising a first end and a second end, wherein the receive side single-ended resonator is connected to the conducting structure at the first end of the receive side single-ended resonator;
(f) a receive side receiving coil for transferring power to a load, wherein the receive side receiving coil is inductively coupled to the receive side single-ended resonator when the power source is operating; and
(g) a receive side matching network electrically coupled between the receive side receiving coil and the load when the receive side receiving coil is transferring power to the load,
wherein each of coils and resonators is substantially at resonance power is transferred from the power source to the load.

112. The system of claim 111 wherein the second end of the transmit side single-ended resonator is floating.

113. The system of claim 111 wherein the second end of the transmit side single-ended resonator is also connected to the conducting structure such that the transmit side single-ended resonator is electrically connected to the conducting structure via the first and second ends of the transmit side single-ended resonator.

114. The system of any one of claims 111 to 113 wherein the second end of the receive side single-ended resonator is floating.

115. The system of any one of claims 111 to 113 wherein the second end of the receive side single-ended resonator is also connected to the conducting structure such that the receive side single-ended resonator is electrically coupled to the conducting structure via the first and second ends of the receive side single-ended resonator.

116. The system of any one of claims 111 to 115 further comprising a receive side resonator tuning network electrically coupled between the conducting structure and the receive side single-ended resonator.

117. The system of any one of claims 111 to 116 further comprising a transmit side resonator tuning network electrically coupled between the conducting structure and the transmit side single-ended resonator.

118. The system of any one of claims 111 to 117 further comprising a receive side receiving coil tuning network electrically coupled between the receive side receiving coil and the receive side matching network.

119. The system of any one of claims 111 to 118 further comprising a transmit side transmitting coil tuning network electrically coupled between the transmit side transmitting coil and the transmit side matching network.

120. The system of any one of claims 111 to 119 wherein at least one of the transmit side matching network and the receive side matching network comprises a reactive component bank and wherein the system further comprises control circuitry configured to:
(a) read a feedback parameter of the system; and
(b) in response to the feedback parameter, adjust the reactance of the reactive component bank such that the feedback parameter approaches a target value.

121. The system of claim 120 wherein the control circuitry comprises a processor and a computer readable medium communicatively coupled to the processor, wherein the computer readable medium has stored thereon computer program code that is executable by the processor and that, when executed by the processor, causes the processor to:
(a) read the feedback parameter of the system; and
(b) in response to the feedback parameter, iteratively adjust the reactance of the reactive component bank such that the feedback parameter approaches a target value and until a stop condition is satisfied.

122. The system of claim 121 wherein iteratively adjusting the reactance of the reactive component bank comprises, for each iteration:
(a) creating a generation of genomes, wherein each of the genomes corresponds to a different reactance of the reactive component bank; and
(b) for each of the genomes:
(i) adjusting the reactance of the reactive component bank to the reactance corresponding to the genome; and
(ii) reading the feedback parameter corresponding to the reactance of the genome.

123. The system of claim 122 wherein the feedback parameter is selected from the group consisting of voltage measured across two nodes in the system, current measured through a node in the system, S-parameters of any component in the system, power delivered to any component in the system, signal-to-noise ratio, and bit error rate.

124. The system of any one of claims 120 to 122 wherein the reactive component bank comprises multiple switches each of which is connected in series to a capacitor, and wherein adjusting the reactance of the reactive component bank comprises actuating the switches to different states.

125. The system of any one of claims 111 to 124 further comprising a transmitter modulator electrically coupled to the transmit side transmitting coil, the transmitter modulator comprising a switch operable to modulate a signal transmitted to the receive side receiving coil.

126. The system of any one of claims 111 to 125 further comprising a receiver modulator electrically coupled to the receive side receiving coil, the receiver modulator comprising a switch operable to modulate a signal transmitted to the transmit side transmitting coil via the receive side receiving coil.

127. Use of the system of any one of claims 1 to 36, 74 to 95, and 111 to 126 for data transmission.
